(19) United States
(12) Patent Application Publication
(10) Pub. No.: US 2005/0206704 A1
(43) Pub. Date: Sep. 22, 2005

(54) Recording method using ink containing an aqueous dispersion of microparticles containing an oil-soluble compound

(75) Inventor: Kenji Ikeda, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/084,098

(22) Filed: Mar. 21, 2005

(30) Foreign Application Priority Data
Mar. 19, 2004 (JP) 2004-81402
Sep. 6, 2004 (JP) 2004-259048

(51) Int. Cl. C09D 11/00

(52) U.S. Cl. 347/100

(57) ABSTRACT

The invention provides a recording method comprising recording an image on a recording medium having formed thereon an ink-receiving layer containing a polymer microparticle and heating the recording medium, wherein an ink composition having a microparticle dispersion which contains an oil-soluble compound is used. The microparticle dispersion preferably contains a hydrophobic polymer, and the ink-receiving layer preferably has a porous structure. Further, the oil-soluble compound is preferably an oil-soluble dye, which may specifically be an azo dye having at least one heterocyclic ring or a phthalocyanine dye having at least one connecting group of —SO— or —SO₂— in the molecule. Furthermore, the oxidation potential of the oil-soluble compound is preferably larger than 1.0 V (vs. SCE).

This application claims priority under 35USC119 from Japanese Patent Applications Nos. 2004-81402 and 2004-259048, the disclosures of which are incorporated by reference herein.

### BACKGROUND OF THE INVENTION

1. Field of Invention

The invention relates to a recording method using an ink containing an aqueous dispersion of microparticles containing an oil-soluble compound.

2. Description of the Related Art

Various recording methods for recording images on recording media such as paper are known For example, an ink-jet recording method of forming a visible image by ejecting a liquid containing a solvent mainly of water with a coloring agent, dye or pigment, dissolved or dispersed therein onto a paper according to electrical signals is known. In addition, recording methods utilizing an electrophotographic process are known, specifically, dry and wet electrophotographic recording methods of visualizing an electrostatic latent image formed on a photoconductive photosensitive body by dry or wet development and transferring and fixing the visible image onto paper by electrostatic force, pressure, or heat.

With the increasingly widespread use of computers in recent years, ink-jet printers are widely used for printing on paper, film and cloth not only in offices but also in homes. As inks used for ink-jet recording, oil-based inks, aqueous inks and solid inks are known. Among these, aqueous inks are particularly advantageous in view of ease of production, handling, odor and safety, and hence are mainly used.

However, while the aqueous inks above, which employ a water-soluble dye soluble in the molecular state, are advantageous in high transparency and color density, they are problematic in that printed images are: less resistant to water because the dye therein is water-soluble and easily generate ink bleeding, deteriorating the printing quality, especially when printed on plain paper, inferior in light fastness; and, when printed on a recording paper having an ink-receiving layer containing porous inorganic microparticles formed on the surface (hereinafter, referred to as “photographic quality paper”), vulnerable to oxidative gases (SOₓ, NOₓ, ozone, and the like), and thus the stability of stored images is extremely poor.

In order to solve the above problems, aqueous inks containing a pigment and a dispersion dye have been proposed (e.g., Japanese Patent Application Laid-Open (JP-A) No. 56-157468). However, for these aqueous inks, water resistance is improved to some extent but remains from satisfactory. They are also problematic in terms of easier clogging of ink ejection nozzles and the like, due to the poor storage stability of the pigment or the dispersion of the dispersion dye in the aqueous ink. In addition, inks employing the above pigment or dye are less penetrative into photographic quality papers, and are thus disadvantageous in terms of easier exfoliation of the pigment or dye from the paper surface by abrasion by hand.

Alternatively, a method of encapsulating an oil-soluble dye or pigment in a polymer has been proposed (e.g., JP-A No. 5845272). However, such inks are inadequate in color tone, color reproducibility, and image durability against oxidative gases and, further, in abrasion resistance of an image formed on a photographic quality paper. Further, an ink superior in color distinctness and abrasion resistance has been proposed (e.g., JP-A No. 62-241901), wherein a salt-forming group and a polyalkylene oxide group are introduced into the polymer. However, although the ink showed a significantly high resistance against abrasion by a finger, was not resistant to a higher level of abrasion such as eraser abrasion. Further, while a method of improving the color tone and abrasion resistance by employing a high-boiling point organic solvent and a dye has also been proposed, the method is unsatisfactory for use in printing when a high level of abrasion resistance is demanded.

Alternatively, a method of fixing an inkjet image that provides images superior in glossiness and more resistant to bronzing has been proposed (e.g., JP-A No. 2003-48366). However, the fixing method has a problem that the properties of printed images varied according to fluctuations in the fixing period and the amount of remaining solvent. Still further, an ink-jet recording medium having an ink-receiving layer containing a water-soluble binder and containing a thermoplastic microparticle in the surface layer has been proposed for improvement of both glossiness and absorption speed (e.g., JP-A No. 2003-48371). Here, however, inks containing a pigment are insufficient in abrasion resistance and also in glossiness.

As described above, there is currently no ink-jet recording method available that is superior in handling, odorlessness, and safety; contains dispersed particles having a smaller particle diameter, is superior in the dispersion stability and storage stability of a dispersion; provides images excellent in color and color tone (hue) even when a dye ink is used, which is superior in ejection stability causing no clogging at the tip of nozzles; superior in ink penetration even when the photographic quality paper described above is used; provides images superior in water resistance after printing, in particular superior in the stability and the abrasion resistance of stored images; and allows recording of high-density high-quality images.

Further, while use of a pigment ink may eliminate the problem of light fastness or the like, it still carries the problem of low transparency due to the light scattering associated therewith, even when the pigment is pulverized into smaller particles and is used together with a polymer.

### SUMMARY OF THE INVENTION

The present invention has been accomplished in consideration of the above conventional problems. Accordingly, the invention provides a recording method comprising recording an image on a recording medium having formed thereon an ink-receiving layer containing a polymer microparticle and subjecting the recording medium to a heating treatment, wherein an ink composition having a microparticle dispersion which contains an oil-soluble compound is used recording method enabling recording of an image with reduced ink bleeding and superior in water resistance, abrasion resistance, light fastness, and ozone resistance.

### BRIEF DESCRIPTION OF THE DRAWINGS

Preferable embodiments of the invention will be described in detail based on the following figures.

FIG. 1 is a graph showing the micropore distribution curve of an ink-jet recording sheet

FIG. 2 is a graph showing micropore distribution curve of a different ink-jet recording sheet

### DETAILED DESCRIPTION OF THE INVENTION

Hereinafter, the recording method according to the invention will be described in detail.

The recording method according to the invention comprises recording an image on a recording medium having an ink-receiving layer containing at least a polymer microparticle by using an ink composition having a dispersion of microparticles containing at least one oil-soluble compound, and then heating the recording medium. In the following, the ink composition and the recording medium will be described fist, after which the recording method according to the invention will be described.

Ink Composition

The ink composition contains a dispersion of microparticles containing at least one oil-soluble compound. Hereinafter, respective components of the ink composition will be described.

Microparticle Dispersion

The microparticle dispersion is a dispersion prepared by dispersing microparticles containing at least one oil-soluble compound in an aqueous medium, and the microparticle dispersion may additionally contain a hydrophobic high-boiling point organic solvent having a boiling point of 150° C. or more.

More specifically, the microparticle dispersion is an emulsified dispersion wherein an oil-soluble compound, which is the essential component, and a hydrophobic polymer, a hydrophobic high-boiling point organic solvent, and other coloring agents as needed are dispersed in an aqueous medium as microparticular oil droplets.

The “aqueous medium” in the invention means water or a mixture of water and a small amount of a water-miscible organic solvent, which may contain an additive as needed.

Oil-Soluble Compound

Among the above-described oil-soluble compounds, oil-soluble dyes are described.

The oil-soluble dyes mean compounds such as essentially water-insoluble dyes. More specifically, the oil-soluble dye is a dye having a solubility in water at 25° C. (amount of dye soluble in 100 g of water) of 1 g or less, preferably 0.5 g or less, and more preferably 0.1 g or less.

Among oil-soluble dyes usable in the invention, any yellow dye is used in the invention as the yellow dye. Examples of the yellow dye include aryl or heteryl azo dyes containing phenols, naphthols, amines, pyrazolones, pyridones or open-chain active methylene compounds as a coupling component; azomethine dyes containing open-chain active methylene compounds as a coupling component; methine dyes such as benzylidene dyes or monomethineoxonol dyes; and quinone dyes such as naphthoquinone dyes and anthraquinone dyes. Examples of dyes other than the above may include quinophthalone dyes, nitro nitroso dyes, acridine dyes and acridinone dyes.

Among oil-soluble dyes usable in the invention, any magenta dye is used in the invention as the magenta dye. Examples of the magenta dye may include aryl or heteryl azo dyes containing phenols, naphthols or anilines as a coupling component; azomethine dyes containing pyrazolones or pyrazolotriazoles as a coupling component; methine dyes such as aryldene dyes, styryl dyes, merocyanine dyes or oxonol dyes; carbonium dyes such as diphenylmethane dyes, triphenylmethane dyes or xanthene dyes, quinone dyes such as naphthoquinone, anthraquinone or anthrapyridone and fused polycyclic dyes such as dioxazine dyes.

Among oil-soluble dyes usable in the invention, any cyan dye is used in the invention as the cyan dye. Examples of the cyan dye may include indoaniline dyes, indophenol dyes, azomethine dyes containing pyrrolotriazoles as a coupling component; polymethine dyes such as cyanine dyes, oxonol dyes or merocyanine dyes; carbonium dyes such as diphenylmethane dyes, triphenylmethane dyes or xanthene dyes; phthalocyanine dyes; anthraquinone dyes; aryl or heterylazo dyes containing phenols, naphthols or anilines as a coupling component and indigo-thioindigo dyes.

Each of the above dyes may be those exhibiting each yellow, magenta or cyan color only after a chromophore part thereof is dissociated. The counter cation in this case may be an inorganic cation such as an alkali metal or ammonium, an organic cation such as pyridinium or a quaternary ammonium salt, or a polymer cation having these cations in its partial structure.

Preferable and specific examples of the oil-soluble dye among the oil-soluble dyes include the following compounds, which, however, are not intended to be limiting of the invention.

Preferable examples thereof include C.I. Solvent Black 3, 7, 27, 29 and 34; C.I. Solvent Yellow 14, 16, 19, 29, 30, 56, 82, 93 and 162; C.I. Solvent Red 1, 3, 8, 18, 24, 27, 43, 49, 51, 72, 73, 109, 122, 132 and 218; C.I. Solvent Violet 3; C.I. Solvent Blue 2, 11, 25, 35, and 70; C.I. Solvent Green 3 and 7; and C.I. Solvent Orange 2.

Among these dyes, NUBIAN BLACK PC-0850, OWL BLACK HBB, OIL YELLOW 129, OWL YELLOW 105, OIL PINK 312, OIL RED 5B, OIL SCARLET 308, VALI FAST BLUE 2606, OIL BLUE BOS (all trade names, manufactured by Orient Chemical Industries, Ltd.), NEOPEN YELLOW 075, NEOPEN MAZENTA SE 1378, NEOPEN BLUE 808, NEOPEN BLUE FF4012, NEOPEN CYAN FF4238 (all trade names, manufactured by BASF Japan Ltd.) and the like are more preferable.

Also, in the invention, a dispersion dye may be used to the extent that it is dissolved in a water-non-miscible organic solvent. Preferable and specific examples of the dispersion dye include the following compounds, which, however, are not intended to be limiting of the invention.

Examples thereof include C.I. Disperse Yellow 5, 42, 54, 64, 79, 82, 83, 93, 99, 100, 119, 122, 124, 126, 160, 184:1, 186, 198, 199, 201, 204, 224 and 237; C.I. Disperse Orange 13, 29, 31:1, 33, 49, 54, 55, 66, 73, 118, 119 and 163; C.I. Disperse Red 54, 60, 72, 73, 86, 88, 91, 92, 93, 111, 126, 127, 134, 135, 143, 145, 152, 153, 154, 159, 164, 167, 177, 181, 204, 206, 207, 221, 239, 240, 258, 277, 278, 283, 311, 323, 343, 348, 356 and 362; C.I. Disperse Violet 33; C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; and C.I. Disperse Green 6:1 and 9.

Among the oil-soluble dyes (oil-soluble compounds), azo dyes having at least one heterocycle or phthalocyanine dyes having at least one connecting group selected from —SO— and —SO₂— in a molecule thereof are preferable. Specifically, the compounds represented by Formula (I) described below, the compounds represented by Formula (Y-I), the compounds represented by Formula (M-I), and the compounds represented by Formula (C-I) are preferable. Regarding azo and phthalocyanine dyes, the compounds represented by Formula (M-I) and the compounds represented by Formula (C-D are particularly preferable among the above-described compounds.

Hereinafter, the compounds represented by Formula (I) will be described. Among the following groups represented by Formula (I), compounds having at least one group, a composition of which is in the preferable scope described below, are preferable; compounds having more groups, compositions of which are in the preferable scopes described below, are more preferable; and compounds having all of the groups, compositions of which are in the preferable scopes described below, are particularly preferable.

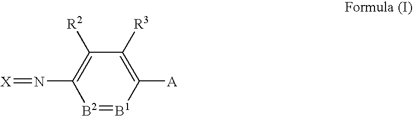

In Formula (I), X represents a color photographic moiety group. A represents —NR⁴R⁵ or a hydroxy group. Each of R⁴ and R⁵ independently represents a hydrogen atom, an aliphatic group, an aromatic group, or a heterocyclic group.

Preferable examples of A include —NR⁴R⁵. Preferable examples of R⁴ and R⁵ respectively include a hydrogen atom and an aliphatic group, and among them, a hydrogen atom, an alkyl group and a substituted alkyl group are more preferable. Particularly preferable examples of R⁴ and R⁵ respectively include an hydrogen atom, an alkyl group having 1 to 18 carbon atoms, and a substituted alkyl group having 1 to 18 carbon atoms.

In Formula (I), B¹ represents ═C(R⁶)— or ═N—. B² represents ═C(R⁶)— or ═N—. It is preferable that B¹ and B² are not ═N— simultaneously. It is more preferable that B¹ represents ═C(W) and B² represents ═C(R⁷).

In Formula (I), R², R³, R⁶ and R⁷ each independently represents a hydrogen atom, a halogen atom, an aliphatic group, an aromatic group, a heterocyclic group, a cyano group, —OR⁵¹, —SR⁵², —CO₂R⁵³, —OCOR⁵⁴, —NR⁵⁵R⁵, —CONR⁵⁷R, —SO₂R⁵⁹, —SO₂NR⁶⁰R⁶¹, —NR⁶²CONR⁶³R⁶⁴, —NR⁶⁵CO₂R⁶⁶, —COR⁶⁷, —NR⁶⁸COR⁶⁹, or —NR⁷⁰SR⁷¹ each independently represents a hydrogen atom, an aliphatic group, or an aromatic group.

Among the above, R² and R⁷ each independently preferably represents a hydrogen atom, a halogen atom, an aliphatic group, —OR⁵¹, —NR⁶²CONR⁶³R⁶⁴, —NR⁶⁵CO₂, —NR⁶⁸COR⁶⁹, or —NR⁷⁰SR⁷¹ are preferable, more preferably represents a hydrogen atom, a fluorine atom, a chlorine atom, an alkyl group, a substituted alkyl group, —NR⁶²CONR⁶³R⁶⁴, or —NR⁶⁸COR⁶⁹, specifically preferably represents a hydrogen atom, a chlorine atom, an alkyl group having 1 to 10 carbon atoms, or a substituted alkyl group having 1 to 10 carbon atoms, and most preferably represents a hydrogen atom, an alkyl group having 1 to 4 carbon atoms, or a substituted alkyl group having 1 to 4 carbon atoms.

Further, R³ and R⁵ each independently preferably represents a hydrogen atom, a halogen atom, or an aliphatic group, more preferably represents a hydrogen atom, a fluorine atom, a chlorine atom, an alkyl group, a substituted alkyl group, specifically preferably represents a hydrogen atom, a chlorine atom, an alkyl group having 1 to 10 carbon atoms, or a substituted alkyl group having 1 to 10 carbon atoms, and most preferably represents a hydrogen atom, an alkyl group having 1 to 4 carbon atoms, or a substituted alkyl group having 1 to 4 carbon atoms.

In Formula (I), R², R² and R³, R³ and R⁴, R⁴ and R⁵, R⁵ and R⁶, and R⁶ and R⁷ may respectively be combined with each other to form a ring or a heterocyclic ring. Preferable examples of the combination to form the ring include R³ and R⁴, R⁴ and R⁵, and R⁵ and R⁶.

The ring which is formed by the combination of R² and R³ or R⁶ and R⁷ is preferably a 5-membered ring or a 6-membered ring. Preferable examples thereof include an aromatic ring (such as a benzen ring) and an unsaturated heterocyclic ring (such as a piridine ring, an imidazole ring, a thiazole ring, a pyrimidine ring, a pyrrole ring, or a fran ring).

The ring which is formed by the combination of R³ and R⁴ or R⁵ and R⁶ is preferably a 5-membered ring or a membered ring. Preferable examples thereof include a tetrahydroquinoline ring and a dihydroindole ring.

The ring which is formed by the combination of R⁴ and R⁵ is preferably a 5-membered ring or a 6-membered ring. Preferable examples thereof include a pyrolidine ring, a piperidine ring and a morpholine ring.

An “aliphatic group” in the specification of the invention means an alkyl group, a substituted alkyl group, an alkenyl group, a substituted alkenyl group, an alkynyl group, a substituted alkynyl group, an aralkyl group and a substituted aralkyl group.

The alkyl group may be branched or cyclic. The number of carbon atoms in the alkyl group is preferably 1 to 20, more preferably 1 to 18.

The alkyl moiety in the substituted alkyl group is the same as the above-described alkyl group.

The alkenyl group may be branched or cyclic. The number of carbon atoms in the alkenyl group is preferably 2 to 20, more preferably 2 to 18.

The alkenyl moiety in the substituted alkenyl group is the same as the above-described alkenyl group.

The alkynyl group may be branched or cyclic. The number of carbon atoms in the alkyl group is preferably 2 to 20, more preferably 2 to 18.

The alkynyl moiety in the substituted alkynyl group is the same as the above-described alkyl group.

The alkyl moiety in the aralkyl group and the substituted aralkyl group is the same as the above-described alkyl group.

The aryl moiety in the aralkyl group and the substituted aralkyl group is the same as the above-described aryl group.

Examples of substituent groups on the alkyl moieties in the substituted alkyl group, the substituted alkenyl group, the substituted alkynyl group and the substituted aralkyl group include a halogen atom, a cyano group, a nitro group, a heterocyclic group, —OR¹¹¹, —SR¹¹², —CO₂R¹¹³, —NR¹¹⁴R¹¹⁵, —OCNR¹¹⁶R¹¹⁷, SO₂R¹¹⁸ and —SO₂NR¹¹⁹R¹²⁰.

R¹¹¹, R¹¹², R¹¹³, R¹¹⁴, R¹¹⁵, R¹¹⁶, R¹¹⁷, R¹¹⁸, R¹¹⁹ and R¹²⁰ each independently represents a hydrogen atom, an aliphatic group or an aromatic group.

Substituent groups on the aryl moiety in the substituted aralkyl group are the same as substituent groups on the substituted aryl group described below.

In this specification, an aromatic group means an aryl group or a substituted aryl group.

The aryl group is preferably a phenyl group or a naphthyl group, more preferably a phenyl group.

The aryl moiety in the substituted aryl group is the same as the above-described aryl group.

Substituent groups on the substituted aryl group include a halogen atom, a cyano group, a nitro group, an aliphatic group, a heterocyclic group, —OR¹²¹, —SR¹²², —CO₂R¹²³, —NR¹²⁴R¹²⁵, —CONR¹²⁶R¹²⁷, —SO₂R¹²⁸ and —SO₂NR¹²⁹R¹³⁰.

R¹²¹, R¹²², R¹²³, R¹²⁴, R¹²⁵, R¹²⁶, R¹²⁷, R¹²⁸, R¹²⁹, and R¹³⁰ each independently represents a hydrogen atom, an aliphatic group or an aromatic group.

In this specification, heterocyclic groups include groups having either a saturated heterocyclic ring or an unsaturated heterocyclic group. The heterocyclic ring is preferably a 5- or 6-membered ring. Further, the heterocyclic ring may have an aliphatic ring, an aromatic ring or another heterocyclic ring fused therewith.

The hetero-atom in the heterocyclic ring includes e.g. a boron atom, a nitrogen atom, an oxygen atom, a sulfur atom, a selenium atom, a tellurium atom, etc. Among these atoms, a nitrogen atom, an oxygen atom and a sulfur atom are preferable.

The heterocyclic ring is preferably a ring wherein of the atoms constituting the heterocyclic ring, a carbon atom has a free valence (monovalence) (the heterocyclic ring is bound via the carbon atom).

The saturated heterocyclic ring includes e.g. a pyrolidine ring, a morpholine ring, a 2-bora-1,3-dioxolane ring and a 1,3-thiazolidine ring.

The unsaturated heterocyclic ring includes an imidazole ring, a thiazole ring, a benzothiazole ring, a benzoxazole ring, a benzotriazole ring, a benzoselenazole ring, a pyridine ring, a pyrimidine ring and a quinoline ring.

The heterocyclic ring may have a substituent group. The substituent group includes a halogen atom, a cyano group, a nitro group, an aliphatic group, an aromatic group, a heterocyclic group, —OR¹³¹, —SR¹³², —CO₂R¹³³, —NR¹³⁴R¹³⁵, —CONR¹³⁶R¹³⁷, —SO₂R¹³⁸ and —SO₂NR¹³⁹R¹⁴⁰.

R¹³¹, R¹³², R¹³³, R¹³⁴, R¹³⁵, R¹³⁶, R¹³⁷, R¹³⁸, R¹³⁹ and R¹⁴⁰ each independently represents a hydrogen atom, an aliphatic group or an aromatic group.

The couplers described above are preferably the following couplers.

Examples of the yellow couplers include the couplers shown in U.S. Pat. Nos. 3,933,501, 4,022,620, 4,326,024, 4,401,752 and 4,248,961, JP-B 58-10739, British Patent Nos. 1,425,020 and 1,476,760, U.S. Pat. Nos. 3,973,968, 4,314,023 and 4,511,649, European Patent Nos. 249,473A and the couplers represented by Formulae (I) and (II) in European Patent No. 502,424A, the couplers represented by Formulae (1) and (2) (particularly Y-28 on page 18) in European Patent No. 513,496A, the couplers represented by Formula (I) in claim 1 in European Patent No. 568,037A, the couplers represented by Formula (I) in lines 45 to 55 in column 1 in U.S. Pat. No. 5,066,576, the couplers represented by Formula (1) in column 0008 in JP-A4-274,425, the couplers described in claim 1 on page 40 (particularly D-35 on page 18) in European Patent No. 498,381A1, the couplers represented by Formula (Y) on page 4 (particularly Y-1 (page 17) and Y-54 (page 41)) in European Patent No. 447,969A1, the couplers represented by Formulae (II) to (IV) in lines 36 to 58 in column 7 (particularly II-17, II-19 (column 17), and II-24 (column 19)) in U.S. Pat. No. 4,476,219.

Examples of the magenta couplers include those in U.S. Pat. Nos. 4,310,619, 4,351,897, European Patent No. 73,636, U.S. Pat. Nos. 3,061,432 and 3,725,067, Research Disclosure No. 24220 (June, 1984), Research Disclosure No. 24230 (June, 1984), JP-A60-33552, JP-A6043659, JP-A61-72238, JP-A6035730, JP-A 55-118034, JP-A 60-185951, U.S. Pat. Nos. 4,500,630, 4,540,654 and 4,556,630, International Publication WO88/04795, JP-A 3-39737 (L-57 (lower right column on page 11), L-68 (lower right column on page 12), L-77 (lower right column on page 13)), [A4]-63 (page 134) and [A4]-73, and [A4]-75 (page 139) in European Patent No. 456,257, M-4, M-6 (page 26) and M-7 (page 27) in European Patent No. 486,965, M-45 (page 19) in European Patent No. 571,959A, (M−1) (page 6) in JP-A 5-204106, and M-22 in paragraph 0237 of JP-A 4-362631.

The cyan couplers include the couplers in U.S. Pat. Nos. 4,052,212, 4,146,396, 4,228,233 and 4,296,200, European Patent No. 73,636, CX-1, -3, -4, -5, -11, -12, -14 and -15 (pages 14 to 16) in JP-A4-204843; C-7, 10 (page 35), 34, and 35 (page 37), (1-1) and (1-17) (pages 42 to 43) in JP-A443345; and the couplers represented by Formula (Ia) or (Ib) in claim 1 in JP-A 6-67385.

In addition, the couplers described in JP-A62-215272 (page 91), JP-A2-33144 (pages 3 and 30), EP355,660A (pages, 4, 5, 45 and 47) are also useful.

Among the compounds represented by Formula (1) above, the magenta dyes are more preferably compounds represented by Formula (II):

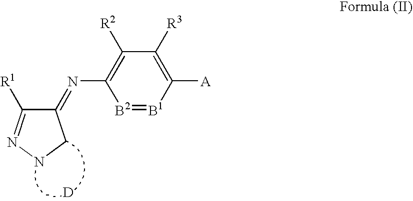

In Formula (II) above, R¹ represents a hydrogen atom, an aliphatic group, an aromatic group, a heterocyclic group, a cyano group, —OR¹¹, —SR¹², —CO₂R¹³, —OCOR¹⁴, —NR¹⁵R¹⁶, —CONR¹⁷R¹⁸, —SO₂R¹⁹, —SO₂NR²⁰R²¹, —NR²²CONR²³R²⁴, —NR²⁵CO₂R²⁶, —COR²⁷, —NR²⁸COR²⁹ or —NR³⁰SO₂R³¹; R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰ and R³¹ each independently represents a hydrogen atom, an aliphatic group or an aromatic group; and R², R³, A, B¹ and B² have the same meanings as defined in Formula (I) above and their preferable scope is the same as defined above.

In Formula (II) above, D represents an atomic group forming a 5- or 6-membered nitrogen-containing heterocyclic ring which may be substituted with at least one substituent group. Further, said heterocyclic ring may further form a fused ring with another ring.

At least one substituent group on the atomic group forming a 5- or 6-membered nitrogen-containing heterocyclic ring, represented by D, is an aliphatic group, an aromatic group, a heterocyclic group, a cyano group, —OR⁸¹, —SR⁸², —CO₂R⁸³, —OCOR⁸⁴, —NR⁸⁵R⁸⁶, —CONR⁸⁷R⁸⁸, —SO₂R⁸⁹, —SO₂NR⁹⁰R⁹¹, —NR⁹²CONR⁹³R⁹⁴, NR⁹⁵CO₂R⁹⁶, —COR⁹⁷, —NR⁹⁸COR⁹⁹ or —NR¹⁰⁰SO₂R¹⁰¹.

R⁸¹, R⁸², R⁸³, R⁸⁴, R⁸⁵, R⁸⁶, R⁸⁷, R⁸⁸, R⁸⁹, R⁹⁰, R⁹¹, R⁹², R⁹³, R⁹⁴, R⁹⁵, R⁹⁶, R⁹⁸, R⁹⁹, R¹⁰⁰ and R¹⁰¹ each independently represents a hydrogen atom, an aliphatic group or an aromatic group.

In Formula (II) above, R¹ preferably represents a hydrogen atom, an aliphatic group, an aromatic group, —OR¹¹, —SR¹², —NR¹⁵R¹⁶, —SO₂R¹⁹, —NR²²CONR²³R²⁴, —NR²⁵CO₂R²⁶, —NR²⁸COR²⁹ or —NR³⁰SO₂R³¹, more preferably represents a hydrogen atom, an aliphatic group, an aromatic group, —OR¹¹ or NR¹⁵R¹⁶, further preferably represents a hydrogen atom, an alkyl group, a substituted alkyl group, an aryl group, a substituted aryl group, an alkoxy group, a substituted alkoxy group, a phenoxy group, a substituted phenoxy group, a dialkylamino group or a substituted dialkylamino group, particularly preferably represents a hydrogen atom, an alkyl group having 1 to 10 carbon atoms, a substituted alkyl group having 1 to 10 carbon atoms, an aryl group having 6 to 10 carbon atoms or a substituted aryl group having 6 to 10 carbon atoms and most preferably represents a hydrogen atom, an alkyl group having 1 to 6 carbon atoms or a substituted alkyl group having 1 to 6 carbon atoms.

In Formula (II) above, A is preferably —NR⁴R⁵. D is preferably a group forming a 5-membered nitrogen-containing heterocyclic ring, and the 5-membered nitrogen-containing heterocyclic ring is more preferably an imidazole ring, a triazole ring or a tetrazole ring.

Among the compounds represented by Formula (II) above, particularly preferable are oil-soluble pyrazolotriazole azomethine compounds represented by Formula (III):

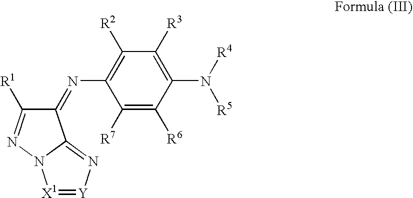

In Formula (III) above, R¹, R², R³, R⁴, R⁵, R⁶ and R⁷ have the same meanings as defined in Formula (II) above. Each of X¹ and Y independently represents C(R⁸)═ or represents —N═. R⁸ represents a hydrogen atom, an aliphatic group or an aromatic group. At least one of X¹ and Y represents —N═.X¹ and Y do not simaltaneously represent —N═.

In Formula (III) above, R⁸ is preferably a hydrogen atom, an alkyl group, a substituted alkyl group, an aryl group or a substituted aryl group, more preferably a hydrogen atom, a substituted alkyl group having 1 to 150 carbon atoms, or a substituted aryl group having 6 to 150 carbon atoms, and most preferably a substituted alkyl group having 1 to 100 carbon atoms or a substituted aryl group having 6 to 100 carbon atoms.

Among the compounds represented by Formula (III) above, pyrazolotriazole azomethine compounds in which X¹ is —N═ and Y is —C(R⁸)═ are preferable.

The pyrazolotriazole azomethine compounds represented by Formula (II) above are shown as the following exemplified compounds (M-1 to M-16) which are not intended to limit the invention.

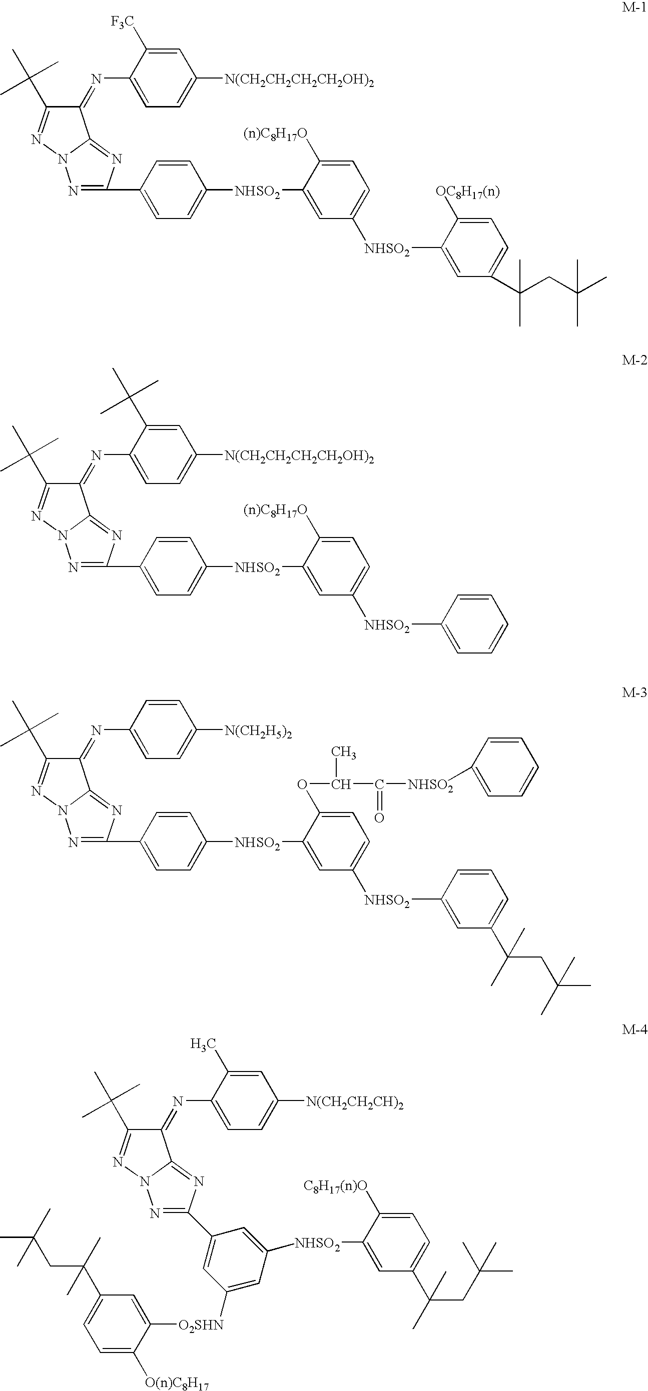

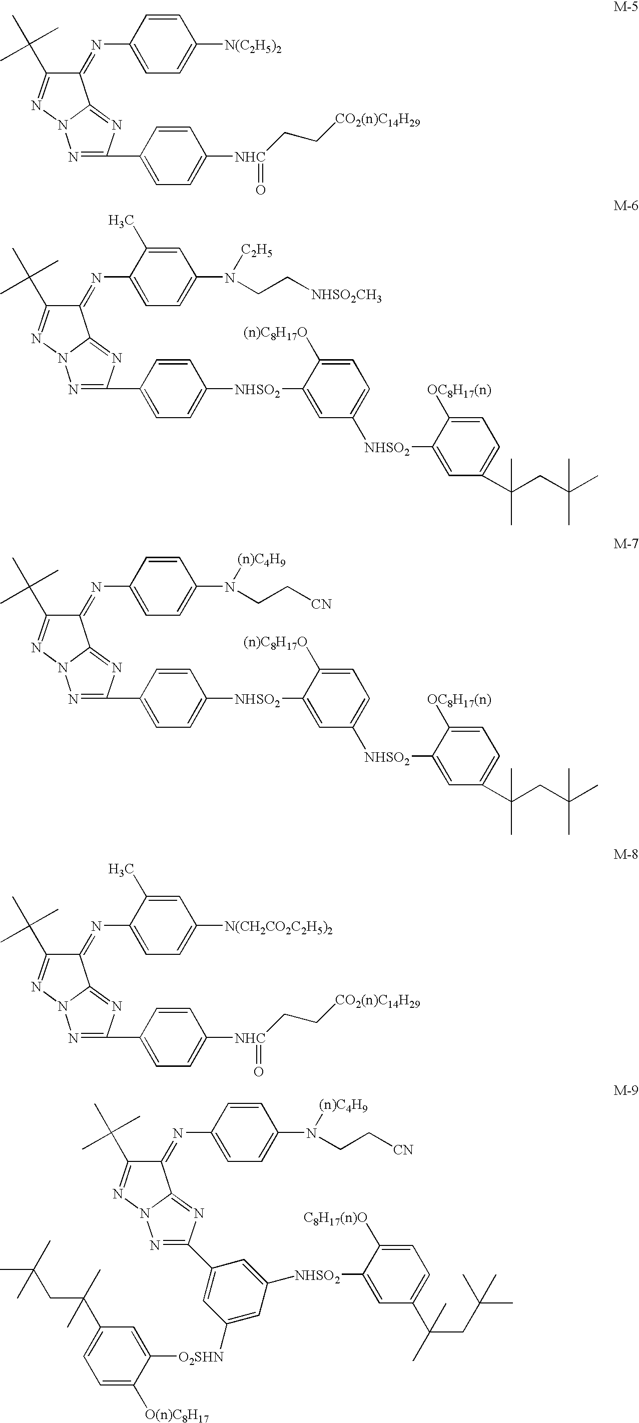

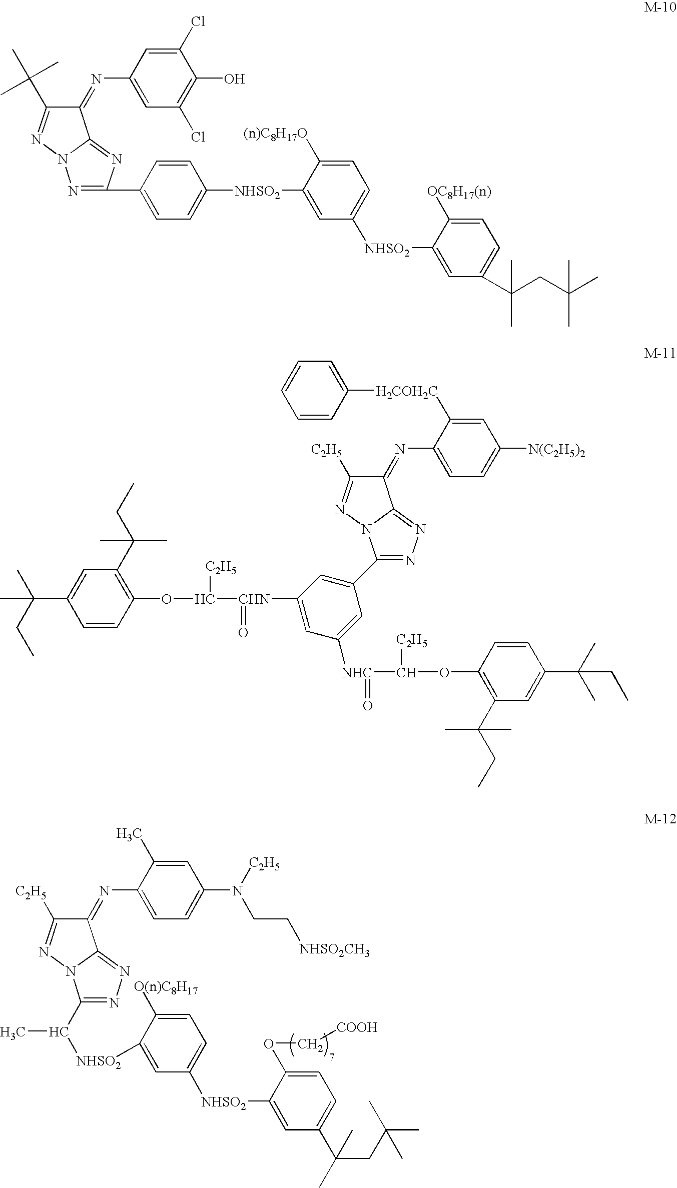

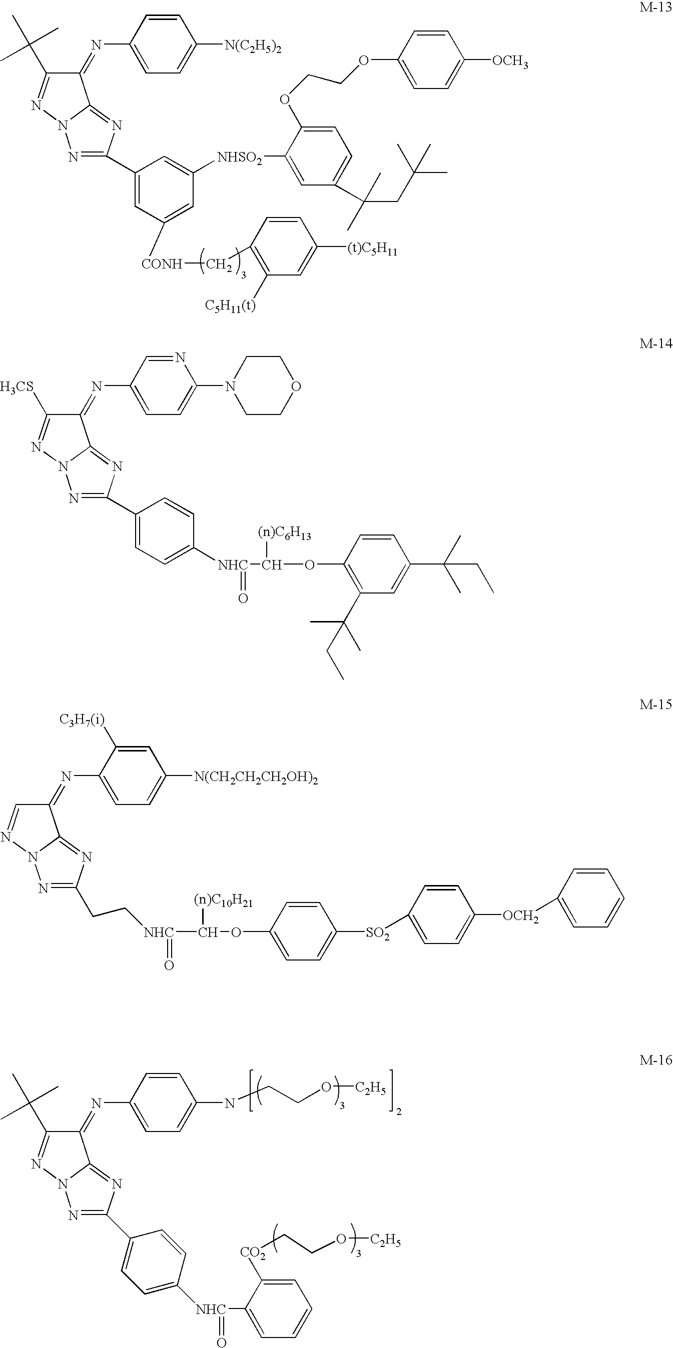

The compounds usable in the invention include, but are not limited to, the exemplified compounds described in Japanese Patent Application No. 2000-78491.

The compounds represented by Formula (II) above can be synthesized by reference to a method described in e.g. JP-A4-126772, JP-B 7-94180 and Japanese Patent Application No. 2000-78491.

As the cyan dyes, the pyrrolotriazole azomethine compounds represented by Formulae (IV-1) to (IV-4) below are particularly preferably used.

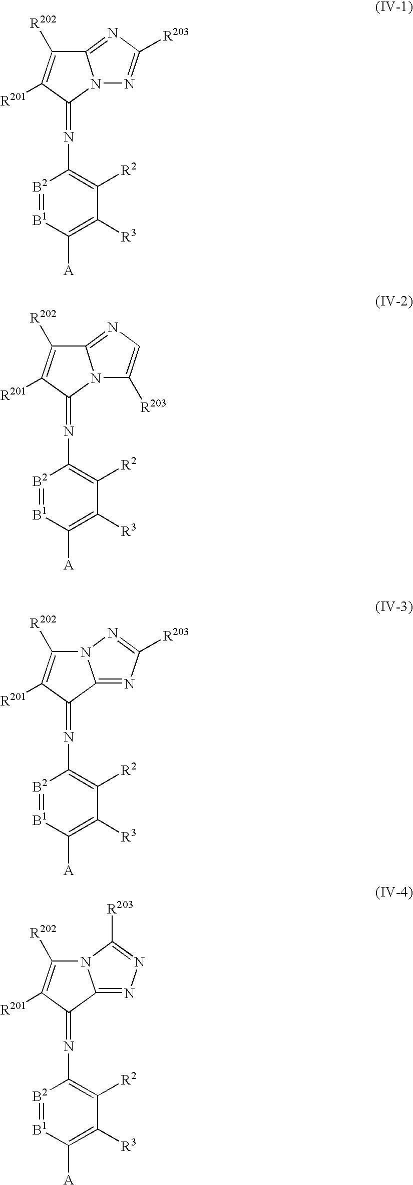

In Formulae (IV-1) to (IV-4) above, A, R², R³, B¹ and B² have the same meanings as defined in Formula (I) above and their preferable scopes are also the same as defined above. R²⁰¹, R²⁰² and R²⁰³ independently have the same meanings as those of R¹ defined in Formula (II) above. R²⁰¹ and R²⁰² may be bound to each other to form a ring.

Further, pyrrolotriazole azomethine compounds represented by Formulae (IV-1) to (IV-4) wherein R²⁰¹ is an electron attractive group having a Hammett's substituent constant σₚ value of 0.30 or more are more preferable owing to their sharp absorption.

The pyrrolotriazole azomethine compounds wherein the sum of the Hammett's substituent constant σₚ values of R²⁰¹ and R²⁰² is 0.70 or more are particularly preferable owing to their excellent hue as cyan color.

Hereinafter, the hues of the pyrrolotriazole azomethine compounds represented by Formulae (IV-1) to (IV-4) above are described.

The pyrrolotriazole azomethine compounds represented by Formulae (IV-1) to (IV-4) above may have a wide variety of hues depending on the combination of R²⁰¹, R²⁰², R²⁰², R²⁰³, A, B¹ and B².

The pyrrolotriazole azomethine compounds represented by Formulae (IV-1) to (IV-4) above wherein R²⁰¹ is an electron attractive substituent group are more preferable owing to their sharper absorption waveform. As the electron attraction of the group is increased, the absorption waveform becomes sharper. In this respect, R²⁰¹ is preferably an electron attractive group having a Hammett's substituent constant σₚ value of 0.30 or more, more preferably 0.45 or more and most preferably 0.60 or more, rather than an alkyl or aryl group.

The pyrrolotriazole azomethine compounds can be used not only as magenta dyes but also as cyan dyes, and they are used more preferably as cyan dyes. The pyrrolotriazole azomethine compounds represented by Formulae (IV-1) to (IV-4) above can also be used as magenta dyes.

When the pyrrolotriazole azomethine compounds represented by Formulae (IV-1) to (IV-4) above are used as cyan compounds, the sum of the Hammett's substituent constant σₚ values of R²⁰¹ and R²⁰² is preferably 0.70 or more. A sum of σₚ values of less than 0.70 is not preferable because the absorption maximum wavelength is too short a wavelength for the cyan dye and the dye seems blue to human eyes. In particular, the compounds wherein the Hammett's substituent constant σₚ value of R²⁰² is 0.30 or more are more preferable. In addition, the compounds wherein the sum of the Hammett's substituent constant σₚ values of R²⁰¹ and R²⁰² is 2.0 or less are preferable.

Examples of the electron attractive groups having a Hammett's substituent constant σₚ value of 0.30 or more include an acyl group, acyloxy group, carbamoyl group, alkoxycarbonyl group, aryloxycarbonyl group, cyano group, nitro group, alkyl sulfonyl group, aryl sulfinyl group, alkyl sulfonyl group, aryl sulfonyl group, sulfamoyl group, halogenated alkyl group, halogenated alkoxy group, halogenated aryloxy group, halogenated alkylthio group, aryl or heterocyclic group substituted with two or more electron attractive groups having a σₚ value of 0.15 or more.

More specifically, examples thereof include an acyl group (e.g., acetyl, 3-phenylpropanoyl, etc.), acyloxy group (e.g., acetoxy, etc.), carbamoyl group [e.g., N-ethylcarbamoyl, N,N-butylcarbamoyl, N-(2-dodecyloxyethyl) carbamoyl, N-methyl-N-dodecylcarbamoyl, etc.], alkoxycarbonyl group (e.g., methoxycarbonyl, butyloxycarbonyl, dodecyloxycarbonyl, octadecyloxycarbonyl, etc.), aryloxycarbonyl group (e.g., phenoxycarbonyl, etc.), cyano group, nitro group, alkyl sulfinyl group (e.g., 3-phenoxypropyl sulfinyl, etc.), aryl sulfinyl group (e.g., 3-pentadecyl phenyl sulfinyl, etc.), alkyl sulfonyl group (e.g., methane sulfonyl, octane sulfonyl, etc.), aryl sulfonyl group (e.g., benzene sulfonyl, etc.), sulfamoyl group (e.g., N-ethyl sulfamoyl, N,N-dipropyl sulfamoyl, etc.), halogenated alkyl group (e.g., trifluoromethyl, heptafluoropropyl, etc.), halogenated alkoxy group (e.g., trifluoromethyloxy, etc.), halogenated aryloxy group (e.g., pentafluorophenyloxy, etc.), halogenated alkylthio group (e.g., difluoromethylthio, etc.), aryl group substituted with two or more electron-attracting group having a σₚ value of 0.15 or more (e.g., 2,4-dinitrophenyl, 2,4,6-trichlorophenyl, pentachlorophenyl, etc.), heterocyclic group (e.g., 2-benzoxazolyl, 2-benzothiazolyl, 1-phenyl-2-benzimidazolyl, 5-chloro-tetrazolyl, 1-pyrrolyl, etc.).

Examples of the electron attractive group having a Hammett's substituent constant σₚ value of 0.45 or more includes an acyl group (e.g., acetyl, 3-phenylpropanoyl, etc.), alkoxycarbonyl group (e.g., methoxycarbonyl, etc.), aryloxy carbonyl group (e.g., m-chlorophenoxycarbonyl, etc.), cyano group, nitro group, alkyl sulfinyl group (e.g., n-propyl sulfinyl, etc.), aryl sulfinyl group (e.g. phenyl sulfinyl, etc.), alkyl sulfonyl group (e.g., methane sulfonyl, n octane sulfonyl, etc.), aryl sulfonyl group (e.g., benzene sulfonyl, etc.), sulfamoyl group (e.g., N-ethylsulfamoyl, N,N-dimethylsulfamoyl, etc.), halogenated alkyl group (e.g., trifluoromethyl, etc.), etc.

The electron attractive group having a Hammett's substituent constant σₚ value of 0.60 or more includes a cyano group (0.66), nitro group (0.78), methane sulfonyl group (0.72), etc.

Preferable example of the combination of R²⁰¹ and R²⁰² having a Hammett's substituent constant σₚ value of 0.70 or more in total include combinations in which R²⁰¹ is selected from the group consisting of a cyano group, alkoxy carbonyl group, alkyl sulfonyl group, aryl sulfonyl group and halogenated alkyl group, and R²⁰² is selected from the group consisting of an acyl group, acyloxy group, carbamoyl group, alkoxycarbonyl group, aryloxy carbonyl group, cyano group, allyl sulfonyl group, aryl sulfonyl group, sulfamoyl group and halogeneted alkyl group.

Preferable examples of structures of the pyrrolotriazole azomethine compounds in the invention include those compounds represented by Formula (IV-1a) below in which R² represents a hydrogen atom, an alkyl group having 1 to 4 carbon atoms, a substituted alkyl group having 1 to 4 carbon atoms, a halogen atom (fluorine, chlorine, or bromine), an acylamino group having 1 to 5 carbon atoms, an aminocarbonyl amino group having 1 to 5 carbon atoms or an alkoxycarbonyl amino group having 2 to 5 carbon atoms, R⁴ and R⁵ each independently represents a hydrogen atom, an alkyl group having 1 to 18 carbon atoms or a substituted alkyl group having 1 to 18 carbon atoms, R²⁰¹ and R²⁰² each independently represents an electron attractive group having a Hammett's substituent constant σₚ value of 0.30 or more in total, and R²⁰³ represents an alkyl group having 1 to 18 carbon atoms, a substituted alkyl group having 1 to 18 carbon atoms or a substituted or unsubstituted aryl group having 6 to 20 carbon atoms.

When the pyrrolotriazole azomethine compounds are used as cyan dyes, the preferable structures described above are more preferably those wherein the sum of the Hammett's substituent constant σₚ values of R²⁰¹ and R²⁰² is 0.70 or more, and particularly preferably are 1.00 or more.

The pyrrolotriazole azomethine compounds in the invention are most preferably those compounds represented by Formula (IV-1a) below in which R² represents a hydrogen atom or a methyl group, R⁴ and R⁵ each independently represents a alkyl group having 1 to 5 carbon atoms, R²⁰¹ represents a cyano group, R²⁰¹ represents an alkoxycarbonyl group and R²⁰³ represents an aryl group.

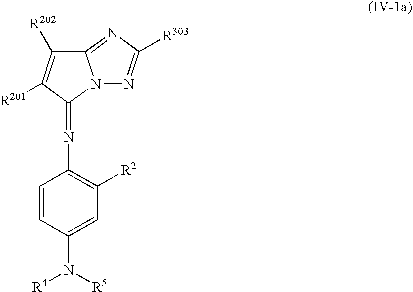

The Hammett's substituent constant used in this specification is described in Japanese Patent Application No. 11-365188, and the σₚ value in the invention has the same meanings as defined therein.

The pyrrolotriazole azomethine compounds in the invention are shown as the following exemplified compounds (C-1 to C-9) which are not intended to limit the invention

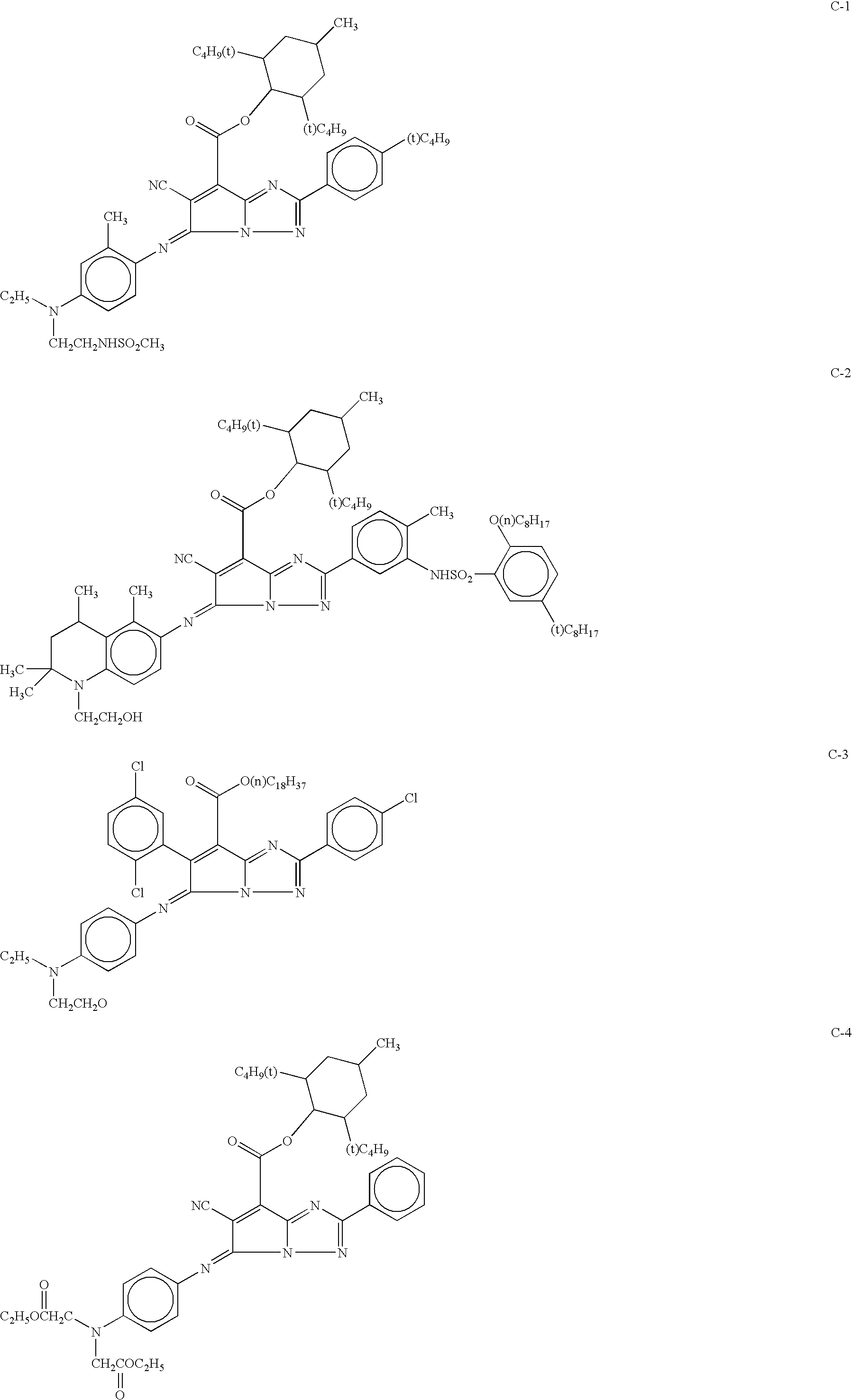

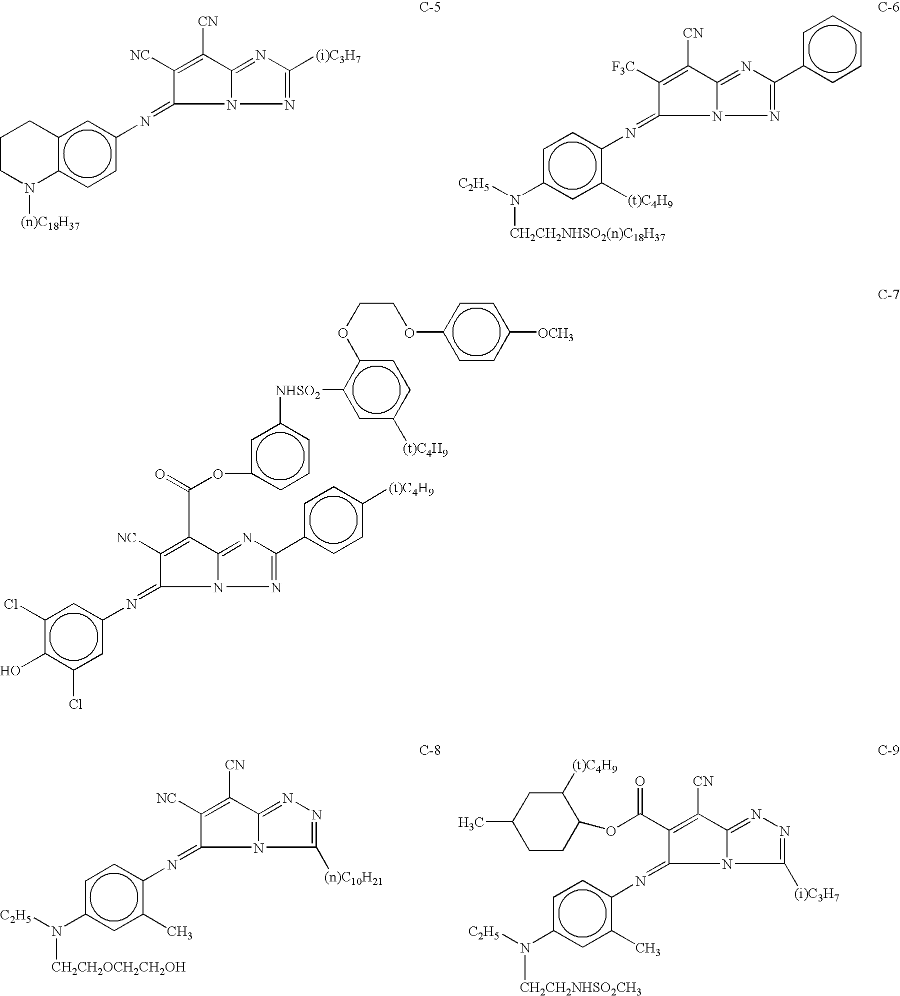

The compounds usable in the invention include, but are not limited to, those compounds exemplified in Japanese Patent Application No. 11-365188.

The pyrrolotriazole azomethine compounds represented by Formulae (IV-1) to (IV-4) above can be synthesized by reference to the methods described in JP-A Nos. 5-177959, 9-292679 and 1062926 and Japanese Patent Application (JP-B) No. 11-365188.

Preferable example of the structures of the yellow dyes include compounds (oil-soluble compounds) represented by Formula (Y-1). The oil-soluble dyes represented by Formula (Y-1) may be used in inks of any color, such as black green, or red, as well as in yellow inks.
A-N═N—B Formula (Y-I)

In Formula (Y-I), A and B each independently represent a heterocyclic group which may be substituted. The heterocyclic group is preferably a heterocyclic group composed of a 5- or 6-membered ring. It may be a monocyclic structure or a polycyclic structure having two or more rings fused therein, and may be an aromatic or non-aromatic heterocyclic ring. A heteroatom which constitutes the heterocyclic ring is preferably a nitrogen atom, oxygen atom or sulfur atom.

In Formula (Y-I) above, the heterocyclic ring represented by A is preferably 5-pyrazolone, pyrazole, oxazolone, isoxazolone, barbituric acid, pyridone, rhodanine, pyrazolidinedione, pyrazolopyridone, meldrum's acid or a fused heterocyclic ring having a hydrocarbon aromatic ring or a heterocyclic ring fused therewith. The heterocyclic ring is preferably 5-pyrazolone, 5-aminopyrazole, pyridone or pyrazoloazole, and more preferably 5-aminopyrazole, 2-hydroxy-6-pyridone or pyrazolotriazole.

The heterocyclic ring represented by B in Formula (Y-I) above is preferably pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, isoxazole, benzoxazole, thiazole, benzothiazole, isothiazole, benzisothiazole, thiadiazole, benzisoxazole, pyrrolidine, piperidine, piperazine, imidazolidine and thiazoline. The heterocyclic ring is more preferably pyridine, quinoline, thiophene, benzothiophene, pyrazole, imidazole, benzimidazole, triazole, oxazole, isoxazole, benzoxazole, thiazole, benzothiazole, isothiazole, benzisothiazole, thiadiazole or benzisoxazole, still more preferably quinoline, thiophene, pyrazole, thiazole, benzoxazole, benzisoxazole, isothiazole, imidazole, benzothiazole or thiadiazole, and further still more preferably pyrazole, benzothiazole, benzoxazole, imidazole, 1,2,4-thiadiazole or 1,3,4-thiadiazole.

Examples of substituents on the above A and B include a halogen atom, alkyl group, cycloalkyl group, aralkyl group, alkenyl group, alkynyl group, aryl group, heterocyclic group, cyano group, hydroxyl group, nitro group, alkoxy group, aryloxy group, silyloxy group, heterocyclic oxy group, acyloxy group, carbamoyloxy group, alkoxycarbonyloxy group, aryloxycarbonyloxy, amino group, acylamino group, aminocarbonylamino group, alkoxycarbonylamino group, aryloxycarbonylamino group, sulfamoylamino group, alkyl and arylsulfonylamino group, mercapto group, alkylthio group, arylthio group, heterocyclic thio group, sulfamoyl group, alkyl and arylsulfinyl group, alkyl and arylsulfonyl group, acyl group, aryloxycarbonyl group, alkoxycarbonyl group, carbamoyl group, imide group, phosphino group, phosphinyl group, phosphinyloxy group, phosphinylamino group, and silyl group.

The dyes represented by Formula (Y-I) are more preferably the dyes represented by Formulae (Y-II), (Y-III) and (Y-IV), shown below.

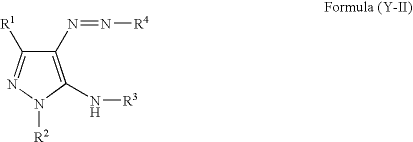

In Formula (Y-II), R¹ and R³ each represent a hydrogen atom, cyano group, alkyl group, cycloalkyl group, aralkyl group, alkoxy group, alkylthio group, arylthio group, aryl group or ionic hydrophilic group. R² represents a hydrogen atom, alkyl group, cycloalkyl group, aralkyl group, carbamoyl group, acyl group, aryl group or heterocyclic group. R⁴ represents a heterocyclic group.

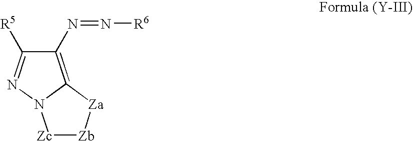

In Formula (Y-III), R⁵ represents a hydrogen atom, cyano group, alkyl group, cycloalkyl group, aralkyl group, alkoxy group, alkylthio group, arylthio group, aryl group or ionic hydrophilic group. Za represents —N═, —NH—, or C(R¹¹)═, and Zb and Zc each independently represent —N═ or C(R¹¹)═, and R¹¹ represents a hydrogen atom or a non-metal substituent group. R⁶ represents a heterocyclic group.

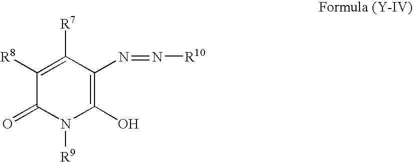

In Formula (Y-IV), R⁷ and R⁹ each independently represent a hydrogen atom, cyano group, alkyl group, cycloalkyl group, aralkyl group, aryl group, alkylthio group, arylthio group, alkoxycarbonyl group, carbamoyl group or ionic hydrophilic group. R⁸ represents a hydrogen atom, halogen atom, alkyl group, alkoxy group, aryl group, aryloxy group, cyano group, acylamino group, sulfonylamino group, alkoxycarbonylamino group, ureido group, alkylthio group, arylthio group, alkoxycarbonyl group, carbamoyl group, sulfamoyl group, sulfonyl group, acyl group, alkylamino group, arylamino group, hydroxy group or ionic hydrophilic group. R¹⁰ represents a heterocyclic group.

Hereinafter, the substituents represented by R¹, R², R³, R⁵, R⁷, R⁸ and R⁹ in Formulae (Y-II), (Y-III) and (Y-IV) are described in more detail.

The allyl group represented by R¹, R², R³, R⁵, R⁷, R⁸ and R⁹ includes an alkyl group having a substituent and an unsubstituted alkyl group.

The alkyl group is preferably an alkyl group having 1 to 20 carbon atoms, and examples of the substituent include a hydroxyl group, alkoxy group, cyano group, halogen atom and ionic hydrophilic group.

Preferable examples of the alkyl group include methyl, ethyl, butyl, isopropyl, t-butyl, hydroxyethyl, methoxyethyl, cyanoethyl, trifluoromethyl, 3-sulfopropyl and 4-sulfobutyl.

The cycloalkyl group represented by R¹, R², R³, R⁵, R⁷, R⁸ and R⁹ includes a cycloalkyl group having a substituent and an unsubstituted cycloalkyl group.

The cycloalkyl group is preferably a cycloalkyl group having 5 to 12 carbon atoms, and examples of the substituent group include an ionic hydrophilic group.

Preferable examples of the cycloalkyl group include a cyclohexyl group.

The aralkyl group represented by R¹, R², R³, R⁵, R⁷, R⁸ and R⁹ includes an aralkyl group having a substituent and an unsubstituted aralkyl group.

The aralkyl group is preferably an aralkyl group having 7 to 20 carbon atoms, and examples of the substituent include an ionic hydrophilic group.

Preferable examples of the aralkyl group include a benzyl group and 2-phenethyl group.

The aryl group represented by R¹, R², R³, R⁵, R⁷ and R⁹ includes an aryl group having a substituent and an unsubstituted aryl group.

The aryl group is preferably an aryl group having 6 to 20 carbon atoms, and examples of the substituent include an alkyl group, alkoxy group, halogen atom, alkylamino group and ionic hydrophilic group.

Preferable examples of the aryl group include a phenyl group, p-tolyl group, p-methoxyphenyl group, o-chlorophenyl group, and m-(3-sulfopropylamino)phenyl group.

The alkylthio group represented by R¹, R², R³, R⁵, R⁷, R⁸ and R⁹ includes an alkylthio group having a substituent and an unsubstituted alkylthio group.

The alkylthio group is preferably an alkylthio group having 1 to 20 carbon atoms, and examples of the substituent include an ionic hydrophilic group.

Preferable examples of the alkylthio group include a methylthio group and ethylthio group.

The arylthio group represented by R¹, R², R³, R⁵, R⁷, R⁸ and R⁹ includes an arylthio group having a substituent and an unsubstituted arylthio group.

The arylthio group is preferably an arylthio group having 6 to 20 carbon atoms, and examples of the substituent include an alkyl group and ionic hydrophilic group.

Preferable examples of the arylthio group include a phenylthio group and p-tolylthio group.

The heterocyclic group represented by R² is preferably a 5- or 6-membered heterocyclic ring which may further be fused. The heteroatom constituting the heterocyclic ring is preferably a nitrogen atom, sulfur atom or oxygen atom. The heterocyclic group may be an aromatic or non-aromatic heterocyclic ring. The heterocyclic ring may be further substituted, and examples of the substituent include the same substituent as on the aryl group to be described later. The heterocyclic ring is preferably a 6-membered nitrogen-containing aromatic heterocyclic ring, particularly preferably triazine, pyrimidine or phthalazine.

Preferable examples of the halogen atom represented by R⁸ include a fluorine atom, chlorine atom and bromine atom.

The alkoxy group represented by R¹, R³, R⁵ and R⁸ includes an alkoxy group having a substituent and an unsubstituted alkoxy group.

The alkoxy group is preferably an alkoxy group having 1 to 20 carbon atoms, and examples of the substituent include a hydroxyl group and ionic hydrophilic group.

Preferable examples of the alkoxy group include a methoxy group, ethoxy group, isopropoxy group, methoxyethoxy group, hydroxyethoxy group, and 3-carboxypropoxy group.

The aryloxy group represented by R⁸ includes an aryloxy group having a substituent and an unsubstituted aryloxy group.

The aryloxy group is preferably an aryloxy group having 6 to 20 carbon atoms, and examples of the substituent include an alkoxy group and ionic hydrophilic group.

Preferable examples of the aryloxy group include a phenoxy group, p-methoxyphenoxy group and o-methoxyphenoxy group.

The acylamino group represented by R⁸ includes an acylamino group having a substituent and an unsubstituted acylamino group.

The acylamino group is preferably an acylamino group having 2 to 20 carbon atoms, and examples of the substituent include an ionic hydrophilic group.

Preferable examples of the acylamino group include an acetamide group, propionamide group, benzamide group and 3,5-disulfobenzamide group.

The sulfonylamino group represented by R⁸ includes a sulfonylamino group having a substituent and an unsubstituted sulfonylamino group.

The sulfonylamino group is preferably a sulfonylamino group having 1 to 20 carbon atoms.

Preferable examples of the sulfonylamino group include a methylsulfonylamino group and ethylsulfonylamino group.

The alkoxycarbonylamino group represented by R⁸ includes an alkoxycarbonylamino group having a substituent and an unsubstituted alkoxycarbonylamino group.

The alkoxycarbonylamino group is preferably an alkoxycarbonylamino group having 2 to 20 carbon atoms, and examples of the substituent include an ionic hydrophilic group.

Preferable examples of the alkoxycarbonylamino group include an ethoxycarbonylamino group.

The ureido group represented by R⁸ includes an ureido group having a substituent and an unsubstituted ureido group.

The ureido group is preferably an ureido group having 1 to 20 carbon atoms, and examples of the substituent include an alkyl group and aryl group.

Preferable examples of the ureido group include a 3-methylureido group, 3,3-dimethylureido group and 3-phenylureido group.

The alkoxycarbonyl group represented by R⁷, R⁸ and R⁹ includes an alkoxycarbonyl group having a substituent and an unsubstituted alkoxycarbonyl group.

The alkoxycarbonyl group is preferably an alkoxycarbonyl group having 2 to 20 carbon atoms, and examples of the substituent include an ionic hydrophilic group.

Preferable examples of the alkoxycarbonyl group include a methoxycarbonyl group and ethoxycarbonyl group.

The carbamoyl group represented by R², R⁷, R⁸ and R⁹ includes a carbamoyl group having a substituent and an unsubstituted carbamoyl group. Examples of the substituent include an alkyl group.

Preferable examples of the carbamoyl group include a methylcarbamoyl group and dimethylcarbamoyl group.

The sulfamoyl group represented by R⁵ includes a sulfamoyl group having a substituent and an unsubstituted sulfamoyl group. Examples of the substituent include an alkyl group.

Preferable examples of the sulfamoyl group include a dimethylsulfamoyl and di-(2-hydroxyethyl)sulfamoyl group.

Preferable examples of the sulfonyl group represented by R⁸ include a methanesulfonyl group and phenylsulfonyl group.

The acyl group represented by R² and R⁸ includes an acyl group having a substituent and an unsubstituted acyl group. The acyl group is preferably an acyl group having 1 to 20 carbon atoms, and examples of the substituent include an ionic hydrophilic group.

The acyl group is preferably an acetyl group or benzoyl group.

The amino group represented by R⁸ includes an amino group having a substituent and an unsubstituted amino group. Examples of the substituent include an alkyl group, aryl group and heterocyclic group.

Preferable examples of the amino group include a methylamino group, diethylamino group, anilino group and 2-chloroanilino group.

The heterocyclic group represented by R⁴, R⁶ and R¹⁰ is the same as the optionally substituted heterocyclic group represented by B in Formula (Y-I) above, and preferable examples, more preferable examples and still more preferable examples thereof are the same as those exemplified above.

Examples of the substituent include an ionic hydrophilic group, alkyl group having 1 to 12 carbon atoms, aryl group, alkyl or arylthio group, halogen atom, cyano group, sulfamoyl group, sulfonamino group, carbamoyl group, acylamino group and the like, and the alkyl group and aryl group may further have a substituent.

In Formula (Y-III) above, Za represents —N═, —NH—, or C(R¹¹)═. Zb and Zc each independently represent —N═ or C(R¹¹)═. R¹¹ represents a hydrogen atom or a non-metal substituent. The non-metal substituent represented by R¹¹ is preferably a cyano group, cycloalkyl group, aralkyl group, aryl group, alkylthio group, arylthio group or ionic hydrophilic group. The respective substituents have the same meanings as those of the respective substituents represented by R¹, and preferable examples thereof are the same as those exemplified above. Examples of the skeleton of the heterocyclic ring composed of two 5-membered rings contained in Formula (Y-III) above are shown below.

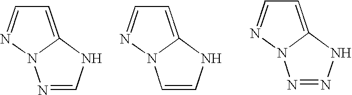

When the respective substituents described above may further have substituents, examples thereof include the substituents which may substitute the heterocyclic rings A and B in Formula (Y-I).

Specific examples of the dyes represented by Formula (Y-I) include the compounds (Y-101 to Y-155) described in Japanese Patent Application 2002-10361, but the invention is not limited thereto. These compounds can be prepared according to the methods described in JP-A Nos. 2-24191 and 2001-279145.

Examples of the preferable structure of the magenta dyes include those compounds represented by the following Formula (M-I) (hereinafter, refereed to as “azo dyes”). The compounds according to the invention represented by Formula (M-I) will be described below

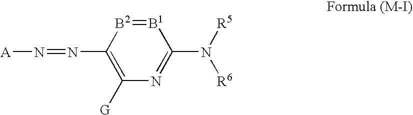

In Formula (M-1), A represents a moiety of a diazo component A-NH₂ in the 5-membered heterocyclic ring.

With respect to B¹ and B², B¹ represents ═CR¹— and B² represents —CR²═, or alternatively, either one represents a nitrogen atom and the other represents ═CR¹— or —CR²═.

R⁵ and R⁶ each independently represent a hydrogen atom, aliphatic group, aromatic group, heterocyclic group, acyl group, alkoxycarbonyl group, aryloxycarbonyl group, carbamoyl group, alkylsulfonyl group, arylsulfonyl group or sulfamoyl group. Each group may further have a substituent.

G, R¹ and R² each independently represent a hydrogen atom, halogen atom, aliphatic group, aromatic group, heterocyclic group, cyano group, carboxyl group, carbamoyl group, alkoxycarbonyl group, aryloxycarbonyl group, acyl group, hydroxy group, alkoxy group, aryloxy group, silyloxy group, acyloxy group, carbamoyloxy group, heterocyclic oxy group, alkoxycarbonyloxy group, aryloxycarbonyloxy group, amino group substituted with an alkyl, aryl or heterocyclic group, acylamino group, ureido group, sulfamoylamino group, alkoxycarbonylamino group, aryloxycarbonylamino group, alkylarylsulfonylamino group, arylsulfonylamino group, aryloxycarbonylamino group, nitro group, alkylthio group, arylthio group, alkylsulfonyl group, arylsulfonyl group, alkylsulfinyl group, arylsulfinyl group, sulfamoyl group, sulfo group or heterocyclic thio group. Each group may further have a substituent.

Furthermore, R¹ and R⁵, or R⁵ and R⁶ may be connected to each other to form a 5- or 6-membered ring.

Hereinafter, the compound represented by Formula (M-D) in the invention is described in more detail.

In Formula (M-I), A represents a moiety of a diazo component A-NH₂ in the 5-membered heterocyclic ring. Examples of the heteroatom in the 5-membered heterocyclic ring include N, O and S. The ring is preferably a nitrogen-containing 5-membered heterocyclic ring with which an aliphatic ring, aromatic rig or another heterocyclic ring may be fused therewith.

Preferable examples of the heterocyclic group of A include a pyrazole ring, imidazole ring, thiazole ring, isothiazole ring, thiadiazole ring, benzothiazole ring, benzoxazole ring and benzisothiazole ring. Each heterocyclic group may further have a substituent Particularly, the pyrazol ring, imidazole ring, isothiazole ring, thiadiazole ring and benzothiazole ring represented by Formulae (M-a) to (M-f) shown blow are preferable.

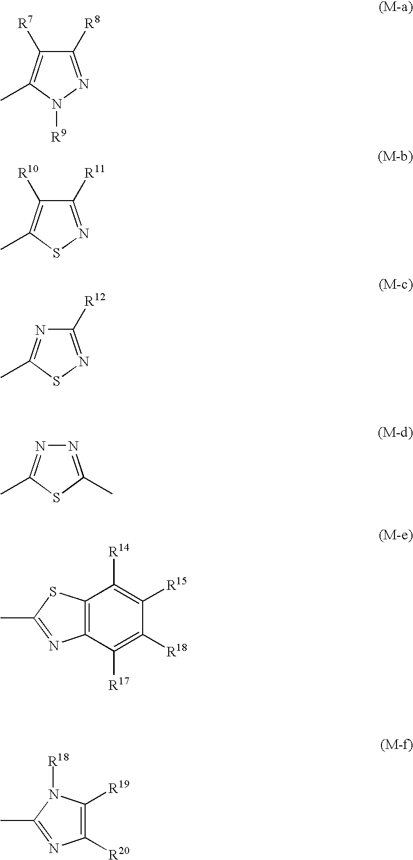

R⁷ to R²⁰ in Formulae (M-a) to (M-f), shown above, represent the same substituent as the substituents G. R¹ and R² to be described later.

The heterocyclic groups represented by Formulae (M-a) to (M-f) are preferably a pyrazol ring and isothiazole ring represented by Formulae (M-a) and (M-b), most preferably is a pyrazol ring represented by Formula (M-a).

With respect to B¹ and B², B¹ represents ═CR¹— while B² represents —CR²═, or alternatively, either one represents a nitrogen atom while the other represents ═CR¹— or —CR²—, and more preferably B¹ represents ═CR¹— while B² represents —CR²═.

R⁵ and R⁶ each independently represent a hydrogen atom, aliphatic group, aromatic group, heterocyclic group, acyl group, alkoxycarbonyl group, aryloxycarbonyl group, carbamoyl group, alkylsulfonyl group, arylsulfonyl group, or sulfamoyl group, and each group may further have a substituent. Preferable examples of the substituent represented by R⁵ and R⁶ include a hydrogen atom, aliphatic group, aromatic group, heterocyclic group, acyl group, alkylsulfonyl group, and arylsulfonyl group. The substituent is more preferably a hydrogen atom, aromatic group, heterocyclic group, acyl group, alkylsulfonyl group or arylsulfonyl group. The substituent is most preferably a hydrogen atom, aryl group or heterocyclic group. Each group may further have a substituent. However, R⁵ and R⁶ are not simultaneously hydrogen atoms.

G, R¹ and R² each independently represent a hydrogen atom, halogen atom, aliphatic group, aromatic group, heterocyclic group, cyano group, carboxyl group, carbamoyl group, alkoxycarbonyl group, aryloxycarbonyl group, acyl group, hydroxy group, alkoxy group, aryloxy group, silyloxy group, acyloxy group, carbamoyloxy group, heterocyclic oxy group, alkoxycarbonyloxy group, aryloxycarbonyloxy group, amino group substituted with an alkyl, aryl or heterocyclic group, acylamino group, ureido group, sulfamoylamino group, alkoxycarbonylamino group, aryloxycarbonylamino group, alkylsulfonylamino group, arylsulfonylamino group, nitro group, alkylthio group, arylthio group, heterocyclic thio group, alkylsulfonyl group, arylsulfonyl group, alkylsulfinyl group, arylsulfinyl group, sulfamoyl group or sulfo group, and each group may further have a substituent.

The substituent represented by G is preferably a hydrogen atom, halogen atom, aliphatic group, aromatic group, hydroxy group, alkoxy group, aryloxy group, acyloxy group, heterocyclic oxy group, amino group substituted with an alkyl, aryl or heterocyclic group, acylamino group, ureido group, sulfamoylamino group, alkoxycarbonylamino group, aryloxycarbonylamino group, alkylthio group, arylthio group and heterocyclic thio group, more preferably a hydrogen atom, halogen atom, alkyl group, hydroxy group, alkoxy group, aryloxy group, acyloxy group, amino group substituted with an alkyl, aryl or heterocyclic group, or acylamino group, and most preferably a hydrogen atom, arylamino group or amide group. Each group may further have a substituent.

Preferable examples of the substituent represented by R¹ and R² include a hydrogen atom, alkyl group, alkoxycarbonyl group, carboxyl group, carbamoyl group and cyano group. Each group may further have a substituent.

R¹ and R⁵, or R⁵ and R⁶ may be connected to each other to form a 5- or 6-membered ring.

When the respective substituents represented by A, R¹, R², R⁵, R⁶ and G further have substituents, the additional substituents include the substituents exemplified for G, R¹, and R² above.

Hereinafter, the substituents represented by G, R¹ and R² are described in more detail.

The halogen atom includes a fluorine atom, chlorine atom and bromine atom.

The scope of the aliphatic group includes an alkyl group, substituted alkyl group, alkenyl group, substituted alkenyl group, alkynyl group, substituted alkynyl group, aralkyl group and substituted aralkyl group. The aliphatic group may be branched or it may form a ring. The number of carbon atoms in the aliphatic group is preferably 1 to 20, and more preferably 1 to 16. The aryl moiety of the aralkyl group and substituted aralkyl group is preferably phenyl or naphthyl, and more preferably phenyl. Examples of the aliphatic group include a methyl group, ethyl group, butyl group, isopropyl group, t-butyl group, hydroxyethyl group, methoxyethyl group, cyanoethyl group, trifluoromethyl group, 3-sulfopropyl group, 4-sulfobutyl group, cyclohexyl group, benzyl group, 2-phenethyl group, vinyl group and allyl group.

As used herein, the aromatic group refers to an aryl group and a substituted aryl group. The aryl group is preferably a phenyl or naphthyl group, and more preferably a phenyl group. The number of carbon atoms in the aromatic group is preferably 6 to 20, and more preferably 6 to 16.

Preferable examples of the aromatic group include a phenyl group, p-tolyl group, p-methoxyphenyl group, o-chlorophenyl group and m-(3-sulfopropylamino)phenyl group.

The heterocyclic group includes a heterocyclic group having a substituent and an unsubstituted heterocyclic group. An aliphatic group, aromatic ring or another heterocyclic ring may be fused with the heterocyclic ring. The heterocyclic group is preferably a 5- or 6-membered heterocyclic group. Examples of the substituent include an aliphatic group, halogen atom, alkylsulfonyl group, arylsulfonyl group, acyl group, acylamino group, sulfamoyl group, carbamoyl group and ionic hydrophilic group. Examples of the heterocyclic group include a 2-pyridyl group, 2-thienyl group, 2-thiazolyl group, 2-benzothiazolyl group, 2-benzoxazolyl group and 2-furyl group.

Examples of the alkylsulfonyl group and arylsulfonyl group include a methanesulfonyl group and phenylsulfonyl group, respectively.

Examples of the alkylsulfinyl group and arylsulfinyl group include a methanesulfinyl group and phenylsulfinyl group, respectively.

The acyl group includes an acyl group having a substituent and an unsubstituted acryl group. The acyl group is preferably an acyl group having 1 to 12 carbon atoms. Examples of the substituent include an ionic hydrophilic group. Examples of the acyl group include an acetyl group and benzoyl group.

The scope of the amino group includes an amino group substituted with an alkyl, aryl and heterocyclic group, and the alkyl, aryl and heterocyclic group may further have a substituent. The amino group does not include an unsubstituted amino group. The alkylamino group is preferably an alkylamino group having 1 to 6 carbon atoms. Examples of the substituent include an ionic hydrophilic group. Examples of the alkylamino group include a methylamino group and diethylamino group.

The arylamino group includes an arylamino group having a substituent and an unsubstituted arylamino group. The arylamino group is preferably an arylamino group having 6 to 12 carbon atoms. Examples of the substituent include a halogen atom and ionic hydrophilic group. Examples of the arylamino group include an anilino group and 2-chloroanilino group.

The alkoxy group includes an alkoxy group having a substituent group and an unsubstituted alkoxy group. The alkoxy group is preferably an alkoxy group having 1 to 12 carbon atoms. Examples of the substituent include an alkoxy group, hydroxyl group and ionic hydrophilic group. Examples of the alkoxy group include a methoxy group, ethoxy group, isopropoxy group, methoxyethoxy group, hydroxyethoxy group and 3-carboxypropoxy group.

The aryloxy group includes an aryloxy group having a substituent and an unsubstituted aryloxy group. The aryloxy group is preferably an aryloxy group having 6 to 12 carbon atoms. Examples of the substituent include an alkoxy group and ionic hydrophilic group. Examples of the aryloxy group include a phenoxy group, p-methoxyphenoxy group and o-methoxyphenoxy group.

The acylamino group includes an acylamino group having a substituent. The acylamino group is preferably an acylamino group having 2 to 12 carbon atoms. Examples of the substituent include an ionic hydrophilic group. Examples of the acylamino group include an acetylamino group, propionylamino group, benzoylamino group, N-phenylacetylamino and 3,5-disulfobenzoylamino group.

The ureido group includes an ureido group having a substituent and an unsubstituted ureido group. The ureido group is preferably an ureido group having 1 to 12 carbon atoms Examples of the substituent include an alkyl group and aryl group. Examples of the ureido group include a 3-methylureido group, 3,3-dimethylureido group and 3-phenylureido group.

The sulfamoylamino group includes a sulfamoylamino group having a substituent and an unsubstituted sulfamoylamino group. Examples of the substituent include an alkyl group. Examples of the sulfamoylamino group include an N,N-dipropylsulfamoylamino group.

The alkoxycarbonylamino group includes an alkoxycarbonylamino group having a substituent and an unsubstituted alkoxycarbonylamino group. The alkoxycarbonylamino group is preferably an alkoxycarbonylamino group having 2 to 12 carbon atoms. Examples of the substituent include an ionic hydrophilic group. Examples of the alkoxycarbonylamino group include an ethoxycarbonylamino group.

The alkylsulfonylamino group and arylsulfonylamino group include alkyl and arylsulfonylamino groups having a substituent and unsubstituted alkyl and arylsulfonylamino groups. The alkyl and arylsulfonylamino groups are preferably alkyl and arylsulfonylamino groups having 1 to 12 carbon atoms. Examples of the substituent include an ionic hydrophilic group. Examples of the alkyl and arylsulfonylamino groups include a methanesulfonylamino group, N-phenylmethanesulfonylamino group, benzenesulfonylamino group, and 3-carboxybenzenesulfonylamino group.

The carbamoyl group includes a carbamoyl group having a substituent and an unsubstituted carbamoyl group. Examples of the substituent include an alkyl group. Examples of the carbamoyl group include a methylcarbamoyl group and dimethylcarbamoyl group.

The sulfamoyl group includes a sulfamoyl group having a substituent and an unsubstituted sulfamoyl group. Examples of the substituent include an alkyl group. Examples of the sulfamoyl group include a dimethylsulfamoyl group and di-(2-hydroxyethyl)sulfamoyl group.

The alkoxycarbonyl group includes an alkoxycarbonyl group having a substituent and an unsubstituted alkoxycarbonyl group. The alkoxycarbonyl group is preferably an alkoxycarbonyl group having 2 to 12 carbon atoms. Examples of the substituent include an ionic hydrophilic group. Examples of the alkoxycarbonyl group include a methoxycarbonyl group and ethoxycarbonyl group.

The acyloxy group includes an acyloxy group having a substituent and an unsubstituted acyloxy group. The acyloxy group is preferably an acyloxy group having 1 to 12 carbon atoms. Examples of the substituent include an ionic hydrophilic group. Examples of the acyloxy group include an acetoxy group and benzoyloxy group.

The carbamoyloxy group includes a carbamoyloxy group having a substituent and an unsubstituted carbamoyloxy group. Examples of the substituent include an alkyl group. Examples of the carbamoyloxy group include an N-methylcarbamoyloxy group.

The aryloxycarbonyl group includes an aryloxycarbonyl group having a substituent and an unsubstituted aryloxycarbonyl group. The aryloxycarbonyl group is preferably an aryloxycarbonyl group having 7 to 12 carbon atoms. Examples of the substituent include an ionic hydrophilic group. Examples of the aryloxycarbonyl group include a phenoxycarbonyl group.

The aryloxycarbonylamino group includes an aryloxycarbonylamino group having a substituent and an unsubstituted aryloxycarbonylamino group. The aryloxycarbonylamino group is preferably an aryloxycarbonylamino group having 7 to 12 carbon atoms. Examples of the substituent include an ionic hydrophilic group. Examples of the aryloxycarbonylamino group include a phenoxycarbonylamino group.

The alky, aryl and heterocyclic thio groups include an alkyl, aryl and heterocyclic thio groups having a substituent and unsubstituted alkyl, aryl and heterocyclic thio groups. The alkyl, aryl and heterocyclic thio groups are preferably those each having 1 to 12 carbon atoms. Examples of the substituent include an ionic hydrophilic group. Examples of the alkyl, aryl and heterocyclic thio groups include a methylthio group, phenylthio group and 2-pyridylthio group.

The azo dye preferably for use in the invention is the compound represented by Formula (M-II):

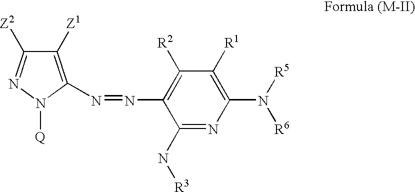

In Formula (M-II), Z¹ represents an electron-withdrawing group having a Hammett's substituent constant σₚ value of 0.20 or more. Z¹ is preferably an electron-withdrawing group having the up value of 0.30 to 1.0. Preferable examples of the substituent include electron-withdrawing substituents to be described later. In particular, Z¹ is preferably an acyl group having 2 to 12 carbon atoms, alkyloxycarbonyl group having 2 to 12 carbon atoms, nitro group, cyano group, alkylsulfonyl group having 1 to 12 carbon atoms, arylsulfonyl group having 6 to 18 carbon atoms, carbamoyl group having 1 to 12 carbon atoms or halogenated alkyl group having 1 to 12 carbon atoms, more preferably a cyano group, alkylsulfonyl group having 1 to 12 carbon atoms or arylsulfonyl group having 6 to 18 carbon atoms, and most preferably a cyano group.

R¹, R², R⁵ and R⁶ have the same meanings as defined in Formula (M-I) above.

R³ and R⁴ each independently represent a hydrogen atom, aliphatic group, aromatic group, heterocyclic group, acyl group, alkoxycarbonyl group, aryloxycarbonyl group, carbamoyl group, alkylsulfonyl group, arylsulfonyl group or sulfamoyl group. R³ and R⁴ each are more preferably a hydrogen atom, aromatic group, heterocyclic group, acyl group, alkylsulfonyl group or arylsulfonyl group, and specifically preferably are a hydrogen atom, aromatic group or heterocyclic group, respectively.

Z² represents a hydrogen atom, aliphatic group, aromatic group or heterocyclic group.

Q represents a hydrogen atom, aliphatic group, aromatic group or heterocyclic group. In particular, Q is preferably a group consisting of non-metal atoms necessary for forming a 5- to 8-membered ring. The 5- to 8-membered ring may have a substituent, may be a saturated ring or may have an unsaturated bond. In particular, the 5- to 8-membered ring is preferably an aromatic group or heterocyclic group. The non-metal atom is preferably a nitrogen atom, oxygen atom, sulfur atom or carbon atom. Preferable examples of the 5- to 8-membered ring include a benzene ring, cyclopentane ring, cyclohexane ring, cycloheptane ring, cyclooctane ring, cyclohexene ring, pyridine ring, pyrimidine ring, pyrazine ring, pyridazine ring, triazine ring, imidazole ring, benzimidazole ring, oxazole ring, benzoxazole ring, thiazole ring, benzothiazole ring, oxane ring, sulfolane ring and thiane ring.

The respective groups described in the description regarding Formula (M-II) may further have a substituent When these groups further have a substituent, examples thereof include the groups described in Formula (M-D) above and the groups and ionic hydrophilic groups exemplified for G, R¹ and R² above.

In connection with the substituent Z¹, the Hammett's substituent constant σₚ value as used herein will be explained below.

The Hammett's rule is an empirical rule proposed by L. P. Hammett in 1935 to quantitatively discuss the influence of a substituent on the reaction or equilibrium of benzene derivatives, and at present this rule is generally recognized valid. The substituent constant of the Hammett's rule includes σₚ value and σₘ value, and these values are found in many books and detailed, for example, in Lange's Handbook of Chemistry, 12th Ed (1979), edited by J. A. Dean McGraw-Hill, and Region of Chemistry (in Japanese), Extra Issue, No. 122, pp. 9&103 (1979), Nankodo. In the invention, the respective substituents are limited as described by the Hammett's constant σₚ, but this does not mean that the substituents are limited to those having known values found in the above books, but means that the substituent groups encompass those having Hammett's constant σₚ value which when measured according to the Hammett's rule, are within a range specified in the invention even if their values are not known. The compound represented by Formulae (M-I) to (M-V) in the invention cover the compounds which are not benzene compounds, however, the σ_{g} value is used regardless of the substituent position as a criterion indicative of the electron effect of the substituent. As used herein, the σₚ value has such a meaning.

Examples of the electron-withdrawing group having a Hammett's substituent constant σₚ value of 0.60 or more include a cyano group, nitro group, alkylsulfonyl group (e.g., a methanesulfonyl group), an arylsulfonyl group (e.g., a benzenesulfonyl group), and the like.

Examples of the electron-withdrawing group having a Hammett's substituent constant σₚ value of 0.45 or more include those described above, and additionally, an acyl group (e.g., an acetyl group), an alkoxycarbonyl group (e.g., a dodecyloxycarbonyl group), an aryloxycarbonyl group (e.g., an m-chlorophenoxycarbonyl group), an alkylsulfinyl group (e.g., an n-propylsulfinyl group), an arylsulfinyl group (e.g., a phenylsulfinyl group), a sulfamoyl group (e.g., an N-ethylsulfamoyl group, N,N-dimethylsulfamoyl group), a halogenated alkyl group (e.g., a trifluoromethyl group), and the like.

Examples of the electron-withdrawing group having a Hammett's substituent constant vσₚ value of 0.30 or more include those described above, and additionally, an acyloxy group (e.g., an acetoxy group), a carbamoyl group (e.g., an N-ethylcarbamoyl group, N,N-dibutylcarbamoyl group), a halogenated alkoxy group (e.g., a trifluoromethyloxy group), a halogenated aryloxy group (e.g., a pentafluorophenyloxy group), a sulfonyloxy group (e.g., a methylsulfonyloxy group), a halogenated alkylthio group (e.g., a difluoromethylthio group), an aryl group substituted with two or more electron-withdrawing groups each having a Hammett's substituent constant σₚ value of 0.15 or more (e.g., a 2,4-dinitrophenyl group, pentachlorophenyl group), and a heterocyclic ring (e.g., a 2-benzoxazolyl group, 2-benzothiazolyl group, and 1-phenyl-2-benzimidazolyl group).

Examples of the electron-withdrawing group having a Hammett's substituent constant σₚ value of 0.20 or more include those described above and halogen atoms.

Preferable combinations of substituents on the compound represented by Formula (M-I) are described below:
(i) R⁵ and R⁶ are each preferably a hydrogen atom, alkyl group, aryl group, heterocyclic group, sulfonyl group or acyl group, more preferably a hydrogen atom, aryl group, heterocyclic group or sulfonyl group, and most preferably a hydrogen atom, aryl group or heterocyclic group. However, R⁵ and R⁶ are not simultaneously hydrogen atoms.
(ii) G is preferably a hydrogen atom, halogen atom, alkyl group, hydroxyl group, amino group or amide group, more preferably a hydrogen atom, halogen atom, amino group or amide group, and most preferably a hydrogen atom, amino group or amide group.
(iii) A is preferably a pyrazole ring, imidazole ring, isothiazole ring, thiadiazole ring or benzothiazole ring, more preferably a pyrazole ring or isothiazole ring, and most preferably a pyrazole ring.
(iv) Each of B¹ and B² is ═CR¹— or —CR²═, and each of R¹ and R² is preferably a hydrogen atom, halogen atom, cyano group, carbamoyl group, carboxyl group, alkyl group, hydroxyl group or alkoxy group, and more preferably a hydrogen atom, cyano group, carbamoyl group or alkoxy group.

The compounds represented by Formula (M-I) are preferably those in which at least one of substituents, preferably two or more substituents, and more preferably all substituents are the substituents exemplified above.

Examples of the compounds represented by Formula (M-I) (a-1 to a-27, b-1 to b-6, c-1 to c-3, d-1 to d-4, and e-1 to e-4) are listed below, but the invention is not limited to the examples below.

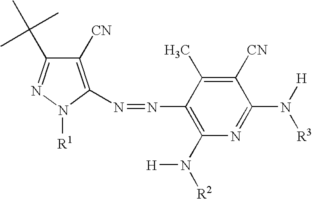

| | R¹ | R² | R³ |
|---|---|---|---|
| a-1 | 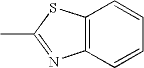 | 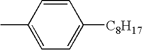 | 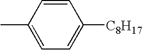 |
| a-2 | 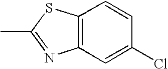 | 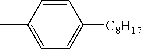 | 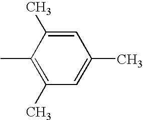 |
| a-3 | 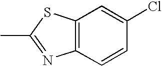 | 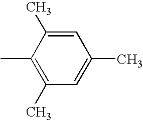 | 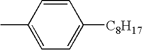 |
| a-4 | 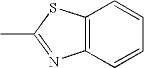 | 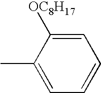 | 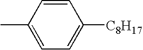 |
| a-5 | 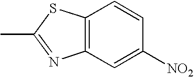 | 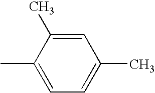 | 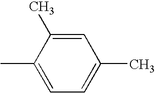 |
| a-6 | 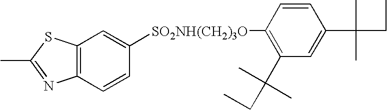 | 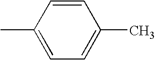 | 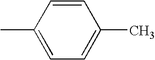 |
| a-7 | 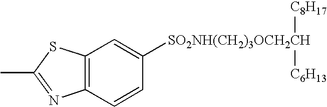 | 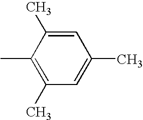 | 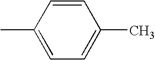 |
| a-8 | 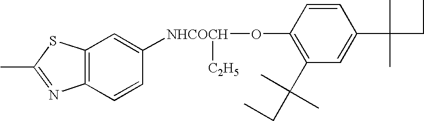 | 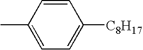 | 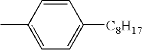 |
| a-9 | 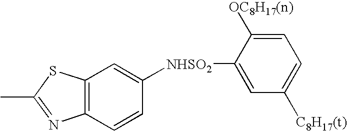 | 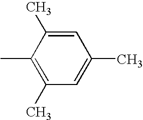 | C₈H₁₇(t) |
| a-10 | 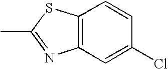 | 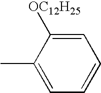 | 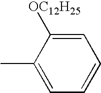 |

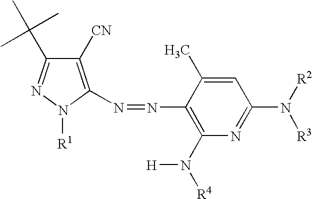

| | R¹ | R² | R³ | R⁴ |
|---|---|---|---|---|
| a-11 | 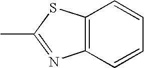 | 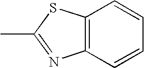 | 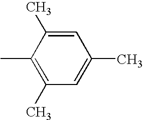 | 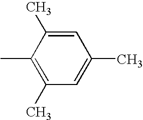 |
| a-12 | 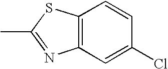 | SO₂CH₃ | 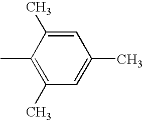 | 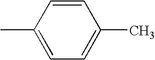 |
| a-13 | 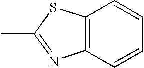 | COCH₃ | C₈H₁₇(t) | C₈H₁₇(t) |
| a-14 | 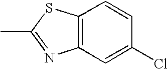 | 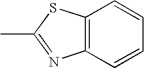 | 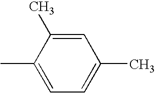 | 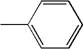 |
| a-15 | 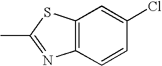 | SO₂CH₃ | 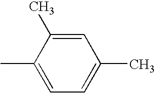 | C₈H₁₇(t) |

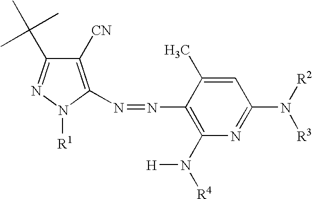

| | R¹ | R² |
|---|---|---|
| a-16 | 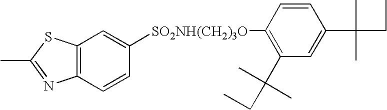 | 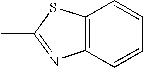 |
| a-17 | 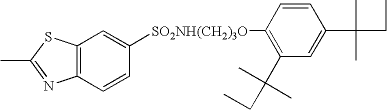 | 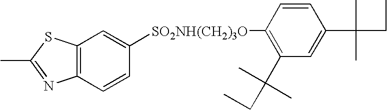 |
| a-18 | 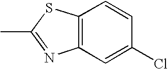 | 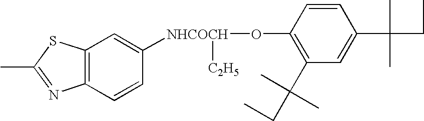 |
| a-19 | 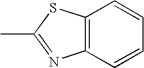 | 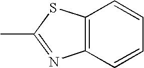 |
| a-20 | 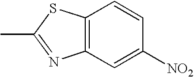 | 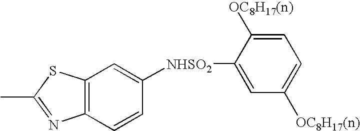 |

| | R³ | R⁴ |
|---|---|---|
| a-16 | 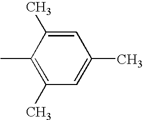 | 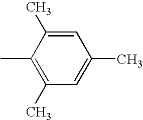 |
| a-17 | 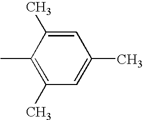 | 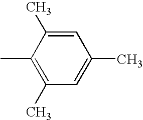 |
| a-18 | 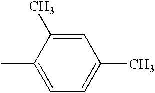 | 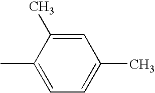 |
| a-19 | 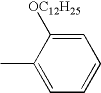 | 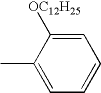 |
| a-20 | 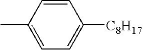 | C₈H₁₇(t) |

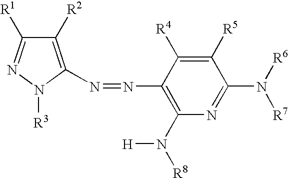

| | R¹ | R² | R³ | R⁴ | R⁵ | R⁶ | R⁷ | R⁸ |
|---|---|---|---|---|---|---|---|---|
| a- 21 | 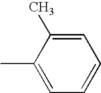 | CN | 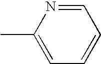 | H | CONH₂ | SO₂CH₃ | 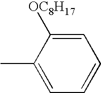 | 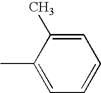 |
| a- 22 | 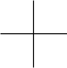 | Br | 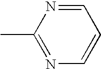 | COOC₂H₅ | H | 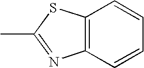 | C₈H₁₇(t) | COCH₃ |
| a- 23 | 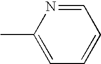 | SO₂CH₃ | 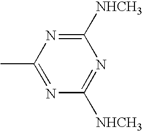 | CONH₂ | H | 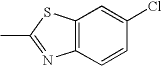 | 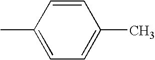 | 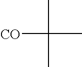 |
| a- 24 | 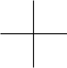 | CN | 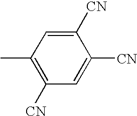 | H | H | 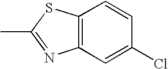 | 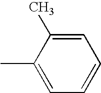 | SO₂CH₃ |

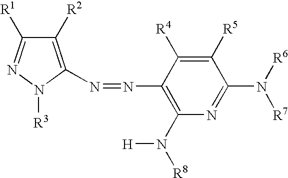

| | R¹ | R² | R³ | R⁴ | R⁵ | R⁶ | R⁷ | R⁸ |
|---|---|---|---|---|---|---|---|---|
| a-25 | 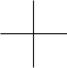 | Br | 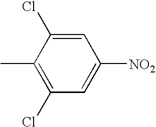 | H | CONH₂ | COCH₃ | 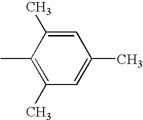 | 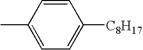 |
| a-26 | 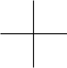 | CN | 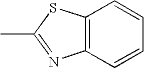 | CH₃ | H | 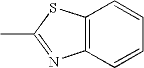 | 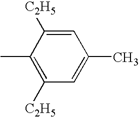 | 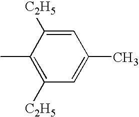 |
| a-27 | 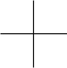 | CN | 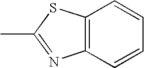 | CH₃ | CN | H | 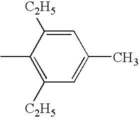 | 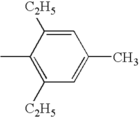 |

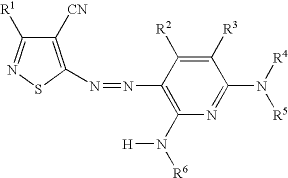

| | R¹ | R² | R³ | R⁴ | R⁵ | R⁶ |
|---|---|---|---|---|---|---|
| b-1 | CH₃ | CH₃ | CN | H | 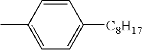 | 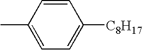 |
| b-2 | CH₃ | CH₃ | CN | H | 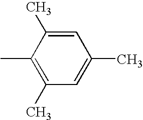 | 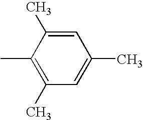 |
| b-3 | CH₃ | CH₃ | CONH₂ | H | 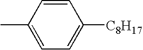 | 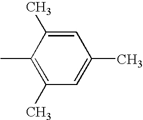 |
| b-4 | CH₃ | CH₃ | H | H | 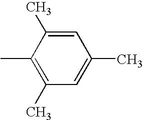 | 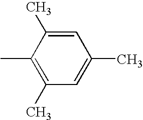 |
| b-5 | CH₃ | CH₃ | H | 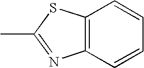 | 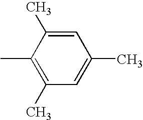 | 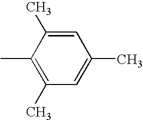 |
| b-6 | CH₃ | CH₃ | H | 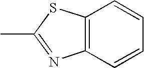 | 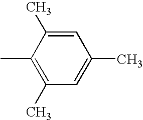 | 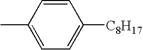 |

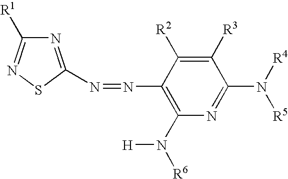

| | R¹ | R² | R³ | R⁴ | R⁵ | R⁶ |
|---|---|---|---|---|---|---|
| c-1 | SCH₃ | CH₃ | CN | H | C₈H₁₇(t) | 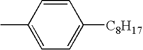 |
| c-2 | CH₃ | CH₃ | H | 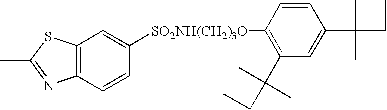 | 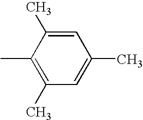 | 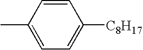 |
| c-3 | 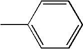 | H | H | 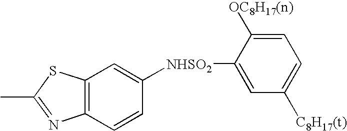 | 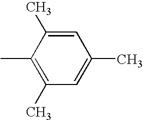 | C₈H₁₇(t) |

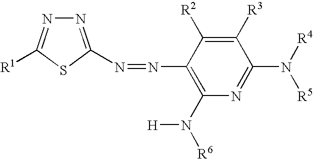

| | R¹ | R² | R³ | R⁴ | R⁵ | R⁶ |
|---|---|---|---|---|---|---|
| d-1 | CH₃ | CH₃ | CN | H | 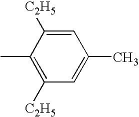 | 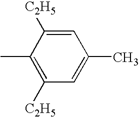 |
| d-2 | CH₃ | H | H | 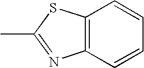 | 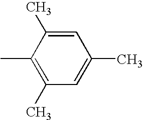 | 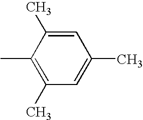 |
| d-3 | 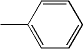 | CH₃ | CONH₂ | H | 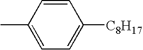 | 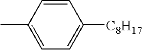 |
| d-4 | 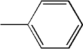 | CH₃ | H | 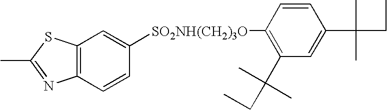 | 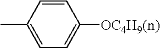 | 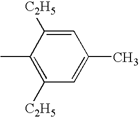 |

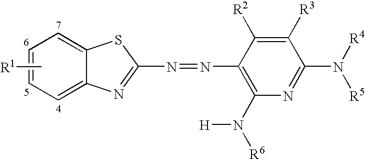

| | R¹ | R² | R³ | R⁴ | R⁵ | R⁶ |
|---|---|---|---|---|---|---|
| e-1 | 5-Cl | CH₃ | CONH₂ | H | C₈H₁₇(t) | C₈H₁₇(t) |
| e-2 | 5,6-diCl | H | H | 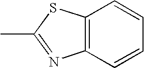 | 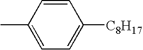 | 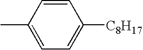 |
| e-3 | 5,6-diCl | CH₃ | H | 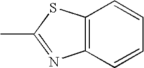 | 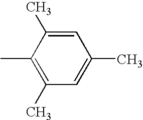 | COCH₃ |
| e-4 | 5-NO₂ | CH₃ | H | SO₂CH₃ | 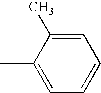 | 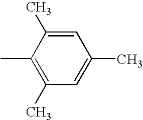 |

As described above, examples of the preferable structure of cyan dyes include the following compounds represented by Formula (C-I) (hereinafter, referred to as “phthalocyanine dyes”). The compounds represented by Formula (C-I) will be described below.

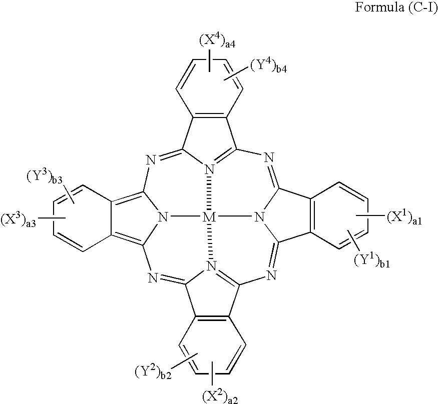

In Formula (C-I), X¹, X², X³ and X⁴ each independently represent —SO-Z¹, SO₂-Z¹ or SO₂NR²¹R²².

Z¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, and preferably represents a substituted or unsubstituted alkyl group, a substituted or unsubstituted aryl group, or a substituted or unsubstituted heterocyclic group, and specifically preferably represents a substituted alkyl group, a substituted aryl group or a substituted heterocyclic group.

R² and R²² each independently represent a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, preferably represent a hydrogen atom, a substituted or unsubstituted alkyl group, a substituted or unsubstituted aryl group, or a substituted or unsubstituted heterocyclic group, and specifically preferably represent a hydrogen atom, a substituted alkyl group, a substituted aryl group and a substituted heterocyclic group. However, R²¹ and R²² are not simultaneously hydrogen atoms.

Each of the substituted or unsubstituted alkyl group represented by R²¹, R²² and Z¹ is preferably an alkyl group. Examples of the substituent include those that are same as the substituent groups that can substitute Z¹, R²¹, R²², Y¹, Y², Y³ and Y⁴ described below. Among these, a hydroxyl group, alkoxy group, cyano group and halogen atom are preferable.

The substituted or unsubstituted cycloalkyl group represented by R²¹, R²² and Z¹ is preferably a cycloalkyl group having 5 to 30 carbon atoms. Examples of the substituent include those that are same as the substituent groups that can substitute Z¹, R²¹, R²², Y¹, Y², Y³ and Y⁴ described below. Among these, a hydroxyl group, alkoxy group, cyano group and a halogen atom are preferable.

The substituted or unsubstituted alkenyl group represented by R²¹, R²² and Z¹ is preferably an alkenyl group having 7 to 30 carbon atoms. Examples of the substituent include those that are same as the substituent groups that can substitute Z¹, R²¹, R²², Y¹, Y², Y³ and Y⁴ described below. Among these, a hydroxyl group, alkoxy group, cyano group and a halogen atom are preferable.

The substituted or unsubstituted aralkyl group represented by R²¹, R²² and Z¹ is preferably an aralkyl group having 7 to 30 carbon atoms. Examples of the substituent include those that are same as the substituent groups data can substitute Z¹, R²¹, R²², Y¹, Y², Y³ and Y⁴ described below. Among these, a hydroxyl group, alkoxy group, cyano group and a halogen atom are preferable.

Examples of the substituents that are on the aryl group and represented by R²¹, R²² and Z¹ include those that are same as the substituent groups that can substitute Z¹, R², R²², Y¹, Y², Y³ and Y⁴ described below. Examples of the preferable substituent include a halogen atom, heterocyclic group, cyano group, hydroxyl group, nitro group, carboxyl group, acylamino group, ureido group, sulfamoylamino group, alkyloxycarbonyl group, alkyloxycarbonylamino group, sulfonamide group, sulfamoyl group, carbamoyl group, sulfonyl group, acyloxy group, carbamoyloxy group, imide group, heterocyclic thio group, acyl group, sulfo group and quaternary ammonium group. Examples of the more preferable substituent include a heterocyclic group, cyano group, carboxyl group, acylamino group, sulfonamide group, sulfamoyl group, carbamoyl group, sulfonyl group, imide group and acyl group. Examples of the specifically preferable substituent include a cyano group, carboxyl group, sulfamoyl group, carbamoyl group, sulfonyl group, imide group and acyl group.

The heterocyclic group represented by R²¹, R²² and Z¹ is preferably a 5- or 6-membered ring which may be further fused. The heterocyclic group may be an aromatic or a non-aromatic heterocyclic ring.

Hereinafter, the heterocyclic group represented by R²¹, R²² and Z¹ is exemplified as a heterocyclic ring without mentioning the substituent position. However, the positions of the substituent are not limited. For example, pyridine may be substituted at a 2-, 3- or 4-position.

Examples of the heterocyclic group include pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazolidine, thiazoline, and the like. Among those listed above, an aromatic heterocyclic group is preferable, and representative examples thereof include pyridine, pyrazine, pyrimidine, pyridazine, triazine, pyrazole, imidazole, benzimidazole, triazole, thiazole, benzothiazole, isothiazole, benzisothiazole and thiadiazole. These may have a substituent.

Y¹, Y², Y³ and Y⁴ each independently represent a hydrogen atom, halogen atom, alkyl group, cycloalkyl group, alkenyl group, alkyl group, aryl group, heterocyclic group, cyano group, hydroxyl group, nitro group, amino group, alkylamino group, alkoxy group, aryloxy group, amide group, arylamino group, ureido group, sulfamoylamino group, alkylthiol group, arylthio group, alkoxycarbonylamino group, sulfonamide group, carbamoyl group, sulfamoyl group, sulfonyl group, alkoxycarbonyl group, heterocyclic oxy group, azo group, acyloxy group, carbamoyloxy group, silyloxy group, aryloxycarbonyl group, aryloxycarbonylamino group, imide group, heterocyclic thio group, phosphoryl group, acyl group, carboxyl group or sulfo group, and each of which may further have a substituent Y¹, Y², Y³ and Y⁴ each are more preferably a hydrogen atom, halogen atom, alkyl group, aryl group, cyano group, alkoxy group, amide group, ureido group, sulfonamide group, carbamoyl group, sulfamoyl group or alkoxycarbonyl group, still more preferably a hydrogen atom, halogen atom or cyano group, and most preferably a hydrogen atom.

When Z¹, R²¹, R²², Y¹, Y², Y³ or Y⁴ is a group which may have an additional substituent, it may further have substituents shown below.

Examples thereof include a halogen atom (e.g., a chlorine atom, bromine atom), a linear or branched alkyl group having 1 to 30 carbon atoms, an aralkyl group having 7 to 30 carbon atoms, an alkenyl group having 2 to 30 carbon atoms, a linear or branched alkynyl group having 2 to 30 carbon atoms, a linear or branched cycloalkyl group having 3 to 30 carbon atoms, a linear or branched cycloalkenyl group having 3 to 30 carbon atoms (e.g., methyl, ethyl, propyl, isopropyl, t-butyl, 2-methanesulfonylethyl, 3-phenoxypropyl, trifluoromethyl and cyclopentyl), an aryl group (e.g., phenyl, 4-t-butylphenyl, 2,4-t-amylphenyl), a heterocyclic group (e.g., imidazolyl, pyrazolyl, triazolyl, 2-furyl, 2-thienyl, 2-pyrimidinyl, 2-benzothiazolyl), a cyano group, hydroxyl group, nitro group, carboxy group, amino group, alkyloxy group (e.g., methoxy, ethoxy, 2-methoxyethoxy, 2-methanesulfonylethoxy), an aryloxy group (e.g., phenoxy, 2-methylphenoxy, 4-t-butylphenoxy, 3-nitrophenoxy, 3-t-butyloxycarbamoylphenoxy, 3-methoxycarbamoyl), an acylamino group (e.g., acetamide, benzamide, 4-(3-t-butyl-4-hydroxyphenoxy)butanamide), an alkylamino group (e.g., methylamino, butylamino, diethylamino, methylbutylamino), an anilino group (e.g., phenylamino, 2-chloroanilino), an ureido group (e.g., phenylureido, methylureido, N,N-dibutylureido), a sulfamoylamino group (e.g., N,N-dipropylsulfamoylamino), an alkylthio group (e.g., methylthio, octylthio, 2-phenoxyethylthio), an arylthio group (e.g., phenylthio, 2-butoxy-5-t-octylphenylthio, 2-carboxyphenylthio), an alkyloxycarbonylamino group (e.g., methoxycarbonylamino), a sulfonamide group (e.g., methanesulfonamide, benzenesulfonamide, p-toluenesulfonamide), a carbamoyl group (e.g., N-ethylcarbamoyl, N,N-dibutylcarbamoyl), a sulfamoyl group (e.g., N-ethylsulfamoyl, N,N-dipropylsulfamoyl, N-phenylsulfamoyl), a sulfonyl group (e.g., methanesulfonyl, octanesulfonyl, benzenesulfonyl, toluenesulfonyl), an alkyloxycarbonyl group (e.g., methoxycarbonyl, butyloxycarbonyl), a heterocyclic oxy group (e.g., 1-phenyltetrazol-5-oxy, 2-tetrahydropyranyloxy), an azo group (e.g., phenylazo, 4-methoxyphenylazo, 4 pivaloylaminophenylazo, 2-hydroxy-4-propanoylphenylazo), an acyloxy group (e.g., acetoxy), a carbamoyloxy group (e.g., N-methylcarbamoyloxy, N-phenylcarbamoyloxy), a silyloxy group (e.g., trimethylsilyloxy, dibutylmethylsilyloxy), an aryloxycarbonylamino group (e.g., phenoxycarbonylamino), an imide group (e.g., N-succinimide, N-phthalimide), a heterocyclic thio group (e.g., 2-benzothiazolylthio, 2,4-di-phenoxy-1,3,5-triazole-6-thio, 2-pyridylthio), a sulfinyl group (e.g., 3-phenoxypropylsulfinyl), a phosphonyl group (e.g., phenoxyphosphonyl, octyloxyphosphonyl, phenylphosphonyl), an aryloxycarbonyl group (e.g., phenoxycarbonyl), an acyl group (e.g., acetyl, 3-phenylpropanoyl, benzoyl), an ionic hydrophilic group (e.g., a carboxyl group, sulfo group and quaternary ammonium group), and the like.

a¹ to a⁴ and b¹ to b⁴ each independently represent the number of the substituents X¹ to X⁴ and Y¹ to Y⁴, a¹ to a⁴ each independently represent an integer of 0 to 4, and b¹ to b⁴ each independently represent an integer of 0 to 4, respectively. However, the sum of a¹ to a⁴ is 2 or greater. When a¹ to a⁴ and b¹ to b⁴ each represent an integer of 2 or greater, the respective X¹ to X⁴ and Y¹ to Y⁴ may be the same or different.

a¹ and b² each independently represent an integer of 0 to 4 satisfying an equation of a²+b²=4, wherein a particularly preferable combination is that a² is 1 or 2 and b² is 3 or 2, and the most preferable combination is that a¹ is 1 and b² is 3.

a³ and b³ each independently represent an integer of 0 to 4 satisfying an equation of a³+b³=4, wherein a particularly preferable combination is that a² is 1 or 2 and b² is 3 or 2, and the most preferable combination is that a⁴ is 1 and b² is 3.

a³ and b³ each independently represent an integer of 0 to 4 satisfying an equation of a³+b³=4, wherein a particularly preferable combination is that a³ is 1 or 2 and b³ is 3 or 2, and the most preferable combination is that a³ is 1 and b³ is 3.

a⁴ and b⁴ each independently represent an integer of 0 to 4 satisfying an equation of a⁴+b⁴=4, wherein a particularly preferable combination is that a⁴ is 1 or 2 and b⁴ is 3 or 2, and the most preferable combination is that a⁴ is 1 and b⁴ is 3.

M represents a hydrogen atom or a metal element, and the oxide, hydroxide or halide thereof.

Preferable examples of M include a hydrogen atom and metal atoms such as Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb and Bi. The oxide includes VO, GeO, etc. The hydroxide includes Si(OH)₂, Cr(OH)₂, Sn(OH)₂, etc. The halide includes AlCl, SiCl₂, VCl, VCl₂, VOCl, FeCl, GaCl, ZrCl, etc. Among these, Cu, Ni, Zn and Al are preferable, and Cu is most preferable.

Further, Pc (phthalocyanine ring) may form a dimer (e.g., Pc-M-L-M-Pc) or a trimer via L (divalent linking group), wherein M may be the same or different. The divalent linking group represented by L is preferably an oxy group (—O—), thio group (—S—), carbonyl group (—CO—), sulfonyl group (—SO₂—), imino group (—NH—) or methylene group (—CH₂—).

A particularly preferable combination in the compound represented by Formula (C-I) is as follows:

X¹ to X⁴ each independently are particularly preferably —SO₂-Z¹ or —SO₂NR²¹R²².

Z¹ is preferably a substituted or unsubstituted alkyl group, a substituted or unsubstituted aryl group or a substituted or unsubstituted heterocyclic group, and most preferably a substituted alkyl group, a substituted aryl group or a substituted heterocyclic group.

R²¹ and R²² each independently are preferably a hydrogen atom, a substituted or unsubstituted alkyl group, a substituted or unsubstituted aryl group or a substituted or unsubstituted heterocyclic group, most preferably a hydrogen atom, a substituted alkyl group, a substituted aryl group or a substituted heterocyclic group.

Y¹ to Y⁴ each preferably represent a hydrogen atom, halogen atom, alkyl group, aryl group, cyano group, alkoxy group, amide group, ureido group, sulfonamide group, carbamoyl group, sulfamoyl group, alkoxycarbonyl group, carboxyl group or sulfo group, more preferably represent a hydrogen atom, halogen atom, cyano group, carboxyl group or sulfo group, and specifically preferably represent a hydrogen atom.

a¹ to a⁴ each independently are preferably 1 or 2, and particularly preferably 1. b¹ to b⁴ each independently are preferably 3 or 2, and particularly preferably 3.

M represents a hydrogen atom, a metal element, or an oxide, hydroxide or halide of the metal element, preferably represents Cu. Ni, Zn or Al, and most preferably represents Cu.

The compound represented by Formula (C-I) is preferably a compound wherein at least one substituent, preferably two or more substituents, more preferably all substituents are the preferable groups described above.

The compound represented by Formula (C-I) is most preferably a compound represented by Formula (C-II):

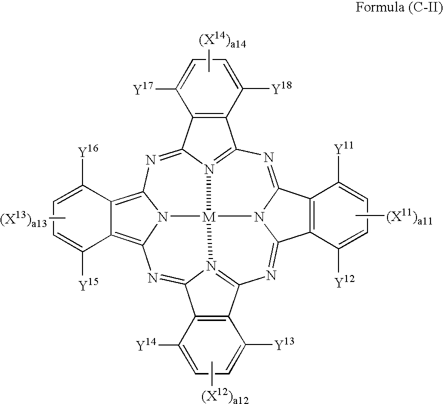

In Formula (C-II), X¹¹ to X¹⁴ and Y¹¹ to Y¹⁸ have the same meanings as those of X¹ to X⁴ and Y¹ to Y⁴ defined in Formula (C-I) above, respectively, and preferable examples of these groups are also the same as defined above. M¹ has the same meaning as that of M defined in Formula (C-I), and preferable examples thereof are also the same as defined above.

Specifically, X¹¹, X¹², X¹³ and X¹⁴ in Formula (C-II) each independently represent —SO-Z¹¹, —SO₂-Z¹¹ or —SO₂NR²³R²⁴.

Z¹¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group.

R²³ represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group; and R²⁴ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group.

Y¹¹, Y¹², Y¹³, Y¹⁴, Y¹⁵, Y¹⁶, Y¹⁷ and Y¹⁸ each independently represent a hydrogen atom, halogen atom, alkyl group, cycloalkyl group, alkenyl group, aralkyl group, aryl group, heterocyclic group, cyano group, hydroxyl group, nitro group, amino group, alkylamino group, alkoxy group, aryloxy group, amide group, arylamino group, ureido group, sulfamoylamino group, alkylthiol group, arylthio group, alkoxycarbonylamino group, sulfonamide group, carbamoyl group, alkoxycarbonyl group, heterocyclic oxy group, azo group, acyloxy group, carbamoyloxy group, silyloxy group, aryloxycarbonyl group, aryloxycarbonylamino group, imide group, heterocyclic thio group, phosphoryl group, acyl group, carboxyl group or sulfo group, each of which may further have a substituent.

a¹¹ to a¹⁴ each represent the number of the substituent X¹¹ to X¹⁴, respectively, and each represent an integer of 0 to 2, provided that a¹¹ to a¹⁴ are not simultaneously 0. When a¹¹ to a¹⁴ each represent 2, two of the substituents X¹¹ to X¹⁴ may be the same or different.

M¹ represents a hydrogen atom, a metal element, or an oxide thereof, a hydroxide of a metal element or a halide of a metal element.

In Formula (C-II), a¹¹ to a¹⁴ each independently represent an integer of 1 or 2 satisfying an equation of 4≦a¹¹+a¹²+a¹³+a¹⁴≦8, more preferably 4≦a¹¹+a¹²+a¹³+a¹⁴≦6, and still more preferably a¹¹=a¹²=a¹³=a¹⁴=1.

Preferable combinations of substituents in the compound represented by Formula (C-II) are described below:
X¹¹ to X¹⁴ each independently are particularly preferably —SO₂-Z¹¹ or —SO₂NR²³R²⁴.

Z¹¹ is preferably a substituted or unsubstituted alkyl group, a substituted or unsubstituted aryl group or a substituted or unsubstituted heterocyclic group, and more preferably a substituted alkyl group, a substituted aryl group or a substituted heterocyclic group.

R²³ is preferably a hydrogen atom, a substituted or unsubstituted alkyl group, a substituted or unsubstituted aryl group or a substituted or unsubstituted heterocyclic group, and more preferably a hydrogen atom, a substituted alkyl group, a substituted aryl group or a substituted heterocyclic group.

R²⁴ is preferably a substituted or unsubstituted alkyl group, a substituted or unsubstituted aryl group or a substituted or unsubstituted heterocyclic group, and more preferably a substituted alkyl group, a substituted aryl group or a substituted heterocyclic group.

Y¹¹ to Y¹⁸ each independently are preferably a hydrogen atom, halogen atom, alkyl group, aryl group, cyano group, alkoxy group, amide group, ureido group, sulfonamide group, carbamoyl group, sulfamoyl group or alkoxycarbonyl group, more preferably a hydrogen atom, halogen atom or cyano group, and most preferably a hydrogen atom.

a¹¹ to a¹⁴ each independently are preferably 1 or 2, and it is particularly preferable that all of a¹¹ to a¹⁴ are 1.

M¹ represents a hydrogen atom or a metal element, and the oxide, hydroxide or halide thereof, more preferably Cu, Ni, Zn and Al, and most preferably Cu.

The compound represented by Formula (C-II) is preferably a compound wherein at least one substituent, preferably two or more substituents, and more preferably all substituents are the preferable groups described above.

The compound represented by Formula (C-I) is generally a mixture of analogues which are inevitably different in the position of the substituents Rn (n=1 to 4) and Yq (q=1 to 4) and the number of the substituents depending on its synthesis method, and the mixture of these analogues is in most cases expressed as a statistically averaged mixture. In the invention, when the mixtures of these analogues are classified into the following three dye types, a specific mixture was found to be particularly preferable.

In the present invention, the mixtures of phthalocyanine dye analogues, that is, the compounds represented by Formula (C-I) or (C-II), are defined by dividing them into the following three types depending on the positions of substituents.
(1)β-position substituted dye: the phthalocyanine dye having a specific substituent at the 2- and/or 3-positions, 6- and/or 7-positions, 11- and/or 11-positions, and 14- and/or 15-positions.
(2) α-position substituted dye: the phthalocyanine dye having a specific substituent at the 1- and/or 4-positions, 5- and/or 8-positions, 9- and/or 12-positions, and 13- and/or 16-positions.
(3) α- and β-positions substituted dye: the phthalocyanine dye having a specific substituent randomly at the 1- to 16-positions.

As used herein, the phthalocyanine dye derivatives different in the structure (particularly with respect to the position of the substituent) are described by referring to the β-position substituted dye, the α-position substituted dye and the α- and β-positions substituted dye compounds.

The phthalocyanine derivatives used in the invention can be synthesized by a combination of or referring to the methods described in “Phthalocyanines—Chemistry and Functions”—(pp. 1-62) written by Shirai & Kobayashi and published by L.P.C and in “Phthalocyanines—Properties and Applications”—(pp. 1-54) written by C. C. Leznoff & A.B.P. Lever and published by VCH, or employing the similar methods.

The compounds represented by Formula (C-I) for use in the invention can be synthesized thorough sulfonation, sulfonyl chloridation or amidation reaction of unsubstituted phthalocyanine compounds according to the methods described, for example, in WO 00/17275, WO 00/08103, WO 00/08101, WO 98/41853 and JP-A No. 10-36471. In this case, sulfonation may take place in any positions of the phthalocyanine nucleus, and the number of sulfonidation to occur is difficult to control. Consequently, when sulfo groups are introduced under such reaction conditions, the positions and number of sulfo groups introduced into the product cannot be specified, thus inevitably giving a mixture of compounds different in the number and positions of the substituent Accordingly, when such a m is used as the staring material to synthesize the compound of the invention, the number and positions of the sulfamoyl substituent on the heterocyclic ring cannot be specified, and thus the compound of the invention is obtained as a mixture of compounds substituted at the α- and β-positions, containing several kinds of compounds different in the number and positions of the substituent.

As described above, when a larger number of electron-withdrawing groups such as a sulfamoyl group are introduced into the phthalocyanine nucleus, oxidation potential becomes higher, and ozone resistance is enchanced. When the above synthesis method is employed, the number of electron-withdrawing groups introduced is low, and hence, contamination with phthalocyanine dyes lower in oxidation potential is inevitable. Accordingly, synthesis methods capable of suppressing formation of compounds poorer in oxidation potential are employed more preferably in order to improve ozone resistance.

On the other hand, the compounds represented by Formula (C-II) for use in the invention may be derived from the compounds obtained by reacting, for example, at least one selected from the group consisting of a phthalonitrile derivative (compound P) represented by the following formula and a diiminoisoindoline derivative (compound Q) represented by the following formula with a metal derivative represented by Formula (C-III) shown below.

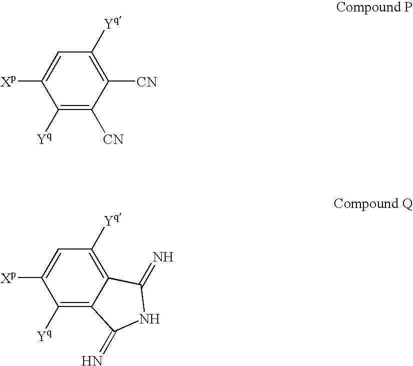

In the compounds P and Q, p represents 11 to 14, and q and q′ each independently represent 11 to 18.
M-(Y)_{d} Formula (C-III)

In the above Formula (C-III), M has the same meaning as that of M in the compounds represented by formulae (C-I) and (C-II), Y represents a monovalent or divalent ligand such as a halogen atom, acetate anion, acetyl acetonate or oxygen, and d is an integer of 1 to 4.

Thus, if the synthesis method described above is employed, a specified number of desired substituents may be introduced. In particular, when it is desired to introduce a large number of electron-withdrawing groups for increasing oxidation potential as conducted in the invention, the above synthesis method is superior to the method of synthesizing the compounds represented by Formula (C-I).

The thus obtained compounds represented by Formula (C-II) are usually a mixture of compounds represented by formulae (C-II-1) to (C-II-4) shown below, which are the isomers with respect to the positions of X^{p} groups, that is, the β-position substituted dye compounds (phthalocyanine dyes having specific substituents at the 2- and/or 3-positions, the 6- and/or 7-positions, the 10- and/or 11-positions, the 14- and/or 15-positions).

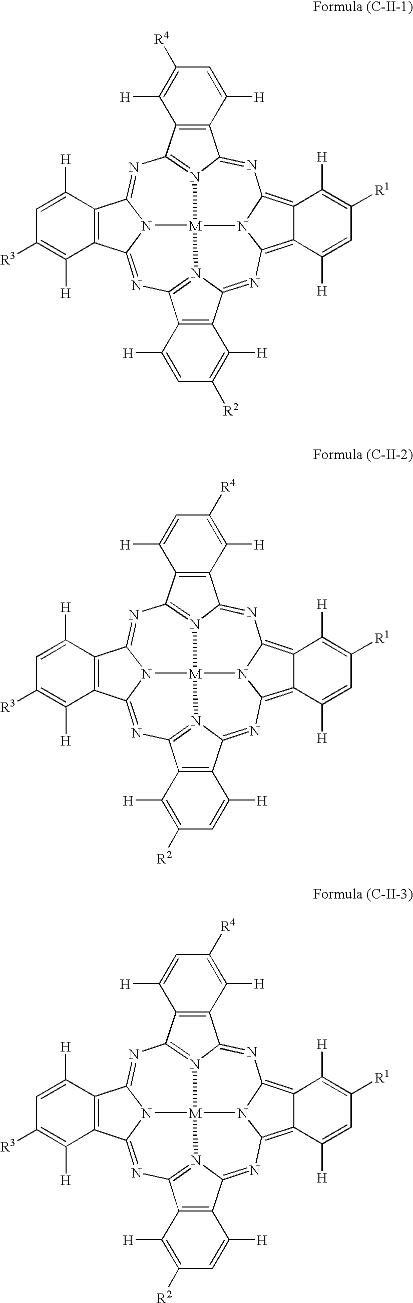

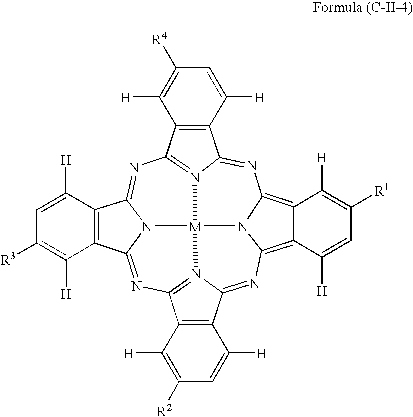

R¹ to R⁴ in formulae (C-II-1) to (C-II-4) have the same meanings as those of (X¹¹)a¹¹ to (X¹⁴)a¹⁴ in Formula (C-II).

In the invention, it is found that it is extremely important for a dye in any substitution form to have an oxidation potential higher than 1.0 V that with respect to a saturated calomel electrode (hereinafter referred to as “vs SCE”). Among many dyes, dyes in the β-substitution form are generally superior in hue, light fastness, ozone gas-resistance, and the like to those in the mixed α- and β-substitution form.

Examples of the compounds represented by Formula (C-I) or (C-II) are listed below as C-101 to c-120, but the invention is not limited to the following examples.

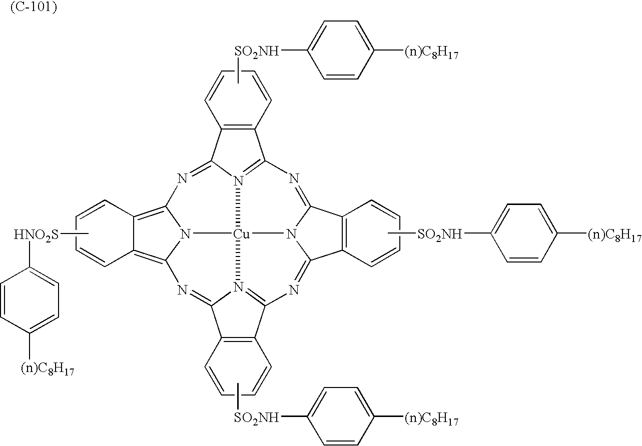

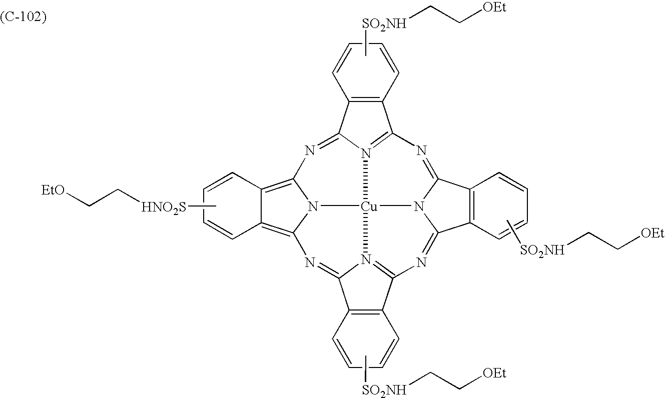

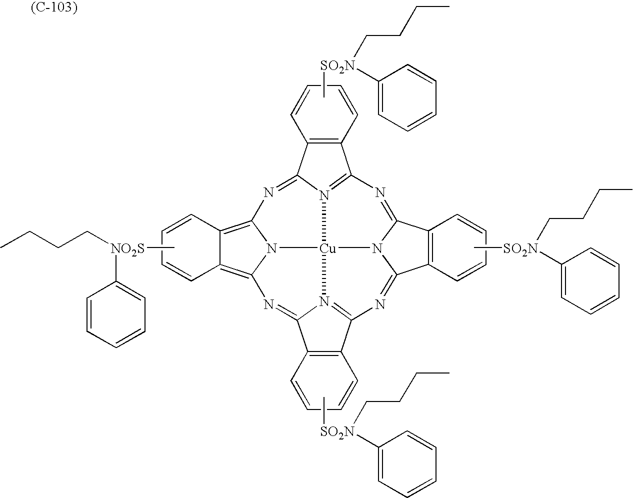

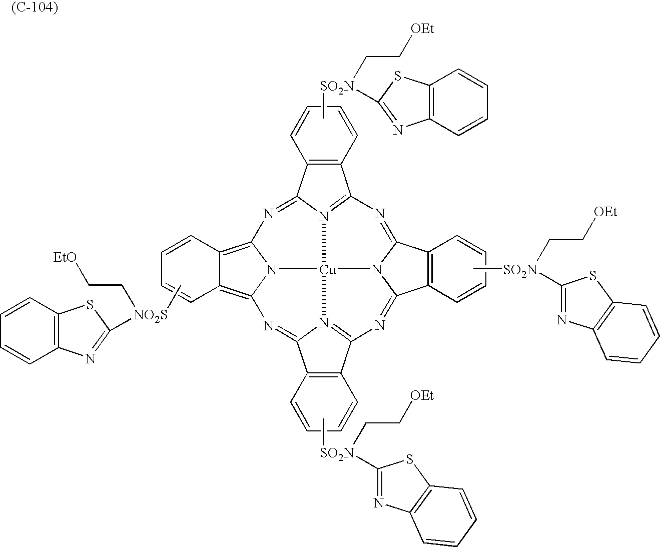

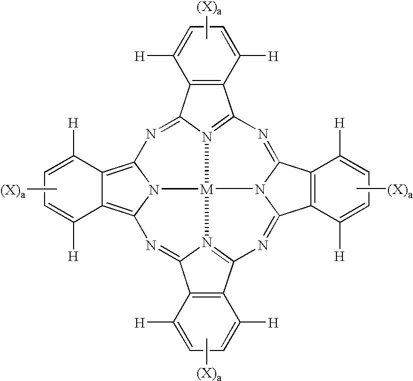

| | M | X | a |
|---|---|---|---|
| c-105 | Cu | —SO₂NHC₈H₁₇(t) | 1 |
| C-106 | Cu | 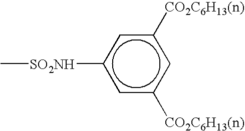 | 1 |
| C-107 | Cu | 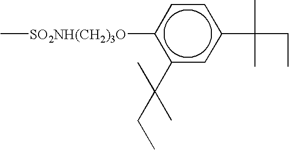 | 1 |
| C-108 | Cu | 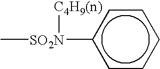 | 1 |
| C-109 | Cu | 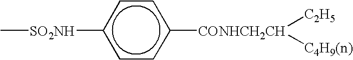 | 1 |
| C-110 | Cu | 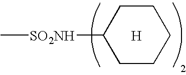 | 1 |
| C-111 | Cu | 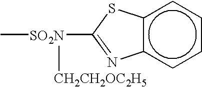 | 1 |
| C-112 | Cu | —SO₂N(CH₂CH₂OC₂H₅)₂ | 1 |
| C-113 | Cu | 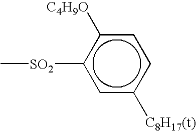 | 1 |
| C-114 | Cu | —SO₂(CH₂)₂SO₂NH(CH₂)₃OC₃H₇(i) | 1 |
| C-115 | Cu | —SO₂CH₂CO₂C₂H₅ | 1 |
| C-116 | Cu | 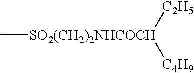 | 1 |
| C-117 | Cu | —SO₂(CH₂)₂CO₂C₆H₁₃(n) | 1 |
| C-118 | Cu | —SO₂C₄H₉(n) | 2 |
| C-119 | Cu | 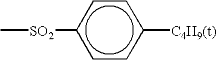 | 1 |
| C-120 | Cu | 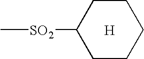 | 1 |

The compounds represented by Formula (C-I) may be synthesized according to the above-mentioned patent The compounds represented by Formula (C-II) may be synthesized by the methods described in Japanese Patent Application Nos. 2000-24352, 2000-47013, 2000-57063 and 200-96610. However, the starting materials, dye intermediates and a synthesizing route are not limited thereto.

In order to improve resistance to color deterioration (specifically a resistance to an oxidizing substance such as ozone) and hardening properties, the oil-soluble dye (oil-soluble compound) preferably has a higher oxidation potential. The oxidation potential of the oil-soluble dye is preferably 1.0 V (vs. SCE) or more, more preferably 1.1 V (vs. SCE) or more, and still more preferably 1.2 V (vs SCE) or more, and particularly preferably 1.3 V (vs. SCE) or more.

Detailes of the oxidation potential is described in paragraphs [0049] to [0051] of JP-A No. 2002-309118.

Hydrophobic Polymer

The hydrophobic polymers include oil-soluble polymers.

The oil-soluble polymer is not particularly limited and may be selected suitably according to applications, but vinyl polymers are preferable. The vinyl polymers include all known vinyl polymers either in the water-insoluble, water-dispersible (self-emulsifying), water-soluble form, but vinyl polymers in the water-soluble form are preferable from the viewpoints of productivity of colored microparticle, dispersion stability, and the like.

The vinyl polymers in the water-soluble form include those in the non-dissociative form, the nonionic dispersible group-containing form, or the mixture thereof. Examples of the vinyl polymers in the non-dissociative form include vinyl polymers containing a cationic dissociative group such as a tertiary amino group and vinyl polymers containing an anionic dissociative group such as carboxylic acid, sulfonic acid, or the like. Examples of the vinyl polymers in the nonionic dispersible group-containing form include vinyl polymers containing a nonionic dispersible group such as a polyethyleneoxy chain. Among them, vinyl polymers containing an anionic dissociative group in the ion-dissociative form, vinyl polymers in the nonionic dispersible group-containing form, and vinyl polymers in the mixture form are preferable, from the viewpoint of the dispersion stability of colored microparticles. Examples of the monomers forming the vinyl polymers include the followings:
Acrylic esters, more specifically methyl acrylate, ethyl acrylate, n-propyl acrylate, isopropyl acrylate, n-butyl acrylate, isobutyl acrylate, sec-butyl acrylate, tert-butyl acrylate, amyl acrylate, hexyl acrylate, 2-ethylhexyl acrylate, octyl acrylate, tert-octyl acrylate, 2-chloroethyl acrylate, 2-bromoethyl acrylate, 4-chlorobutyl acrylate, cyanoethyl acrylate, 2-acetoxyethyl acrylate, benzyl acrylate, methoxybenzyl acrylate, 2-chlorocyclohexyl acrylate, cyclohexyl acrylate, furfuryl acrylate, tetrahydrofurfuryl acrylate, phenyl acrylate, 5-hydroxypentyl acrylate, 2,2-dimethyl-3-hydroxypropyl acrylate, 2-methoxyethyl acrylate, 3-methoxybutyl acrylate, 2-ethoxyethyl acrylate, 2-butoxyethyl acrylate, 242-methoxyethoxy)ethyl acrylate, 242-butoxyethoxy)ethyl acrylate, glycidyl acrylate, 1-bromo-2-methoxyethyl acrylate, 1,1-dichloro-2-ethoxyethyl acrylate, 2,2,2-tetrafluoroethyl acrylate, 1H, 1H, 2H, 2H-perfluorodecyl acrylate, and the like;
Methacrylic esters, specifically, methyl methacrylate, ethyl methacrylate, n-propyl methacrylate, isopropyl methacrylate, n-butyl methacrylate, isobutyl methacrylate, sec-butyl methacrylate, tert-butyl methacrylate, amyl methacrylate, hexyl methacrylate, cyclohexyl methacrylate, benzyl methacrylate, chlorobenzyl methacrylate, octyl methacrylate, stearyl methacrylate, 2-(3-phenyl propyloxy)ethyl methacrylate, furfuryl methacrylate, tetrahydrofurfuryl methacrylate, phenyl methacrylate, cresyl methacrylate, naphthyl methacrylate, 2-hydroxyethyl methacrylate, 4-hydroxybutyl methacrylate, triethylene glycol monomethacrylate, dipropylene glycol monomethacrylate, 2-methoxyethyl methacrylate, 3-methoxybutyl methacrylate, 2-ethoxyethyl methacrylate, 2-iso-propoxyethyl methacrylate, 2-butoxyethyl methacrylate, 2-(2-methoxyethoxy)ethyl methacrylate, 2-(2-ethoxyethoxy)ethyl methacrylate, 2-(2-butoxyethoxy)ethyl methacrylate, 2-acetoxyethyl methacrylate, 2-acetoacetoxyethyl methacrylate, allyl methacrylate, glycidyl methacrylate, 2,2,2-tetrafluoroethyl methacrylate, 1H,1H,2R,2H-perfluorodecyl methacrylate, and the like;
Vinyl esters, specifically, vinyl acetate, vinyl propionate, vinyl butyrate, vinyl isobutyrate, vinyl caproate, vinyl chloroacetate, vinyl methoxyacetate, vinyl phenylacetate, vinyl benzoate, vinyl salicylate, and the like;
Acrylamides, specifically, acrylamide, methyl acrylamide, ethyl acrylamide, propyl acrylamide, butyl acrylamide, tert-butyl acrylamide, tert-octyl acrylamide, cyclohexyl acrylamide, benzyl acrylamide, hydroxymethyl acrylamide, methoxymethyl acrylamide, butoxymethyl acrylamide, methoxyethyl acrylamide, phenyl acrylamide, dimethyl acrylamide, diethyl acrylamide, β-cyanoethyl acrylamide, N-(2-acetoacetoxyethyl)acrylamide, diacetone acrylamide, and the like;
Methacrylamides, specifically, methacrylamide, methyl methacrylamide, ethyl methacrylamide, propyl methacrylamide, butyl methacrylamide, tert-butyl methacrylamide, cyclohexyl methacrylamide, benzyl methacrylamide, hydroxymethyl methacrylamide, methoxyethyl methacrylamide, phenyl methacrylamide, dimethyl methacrylamide, β-cyanoethyl methacrylamide, N-(2-acetoacetoxyethyl)methacrylamide, and the like;
Olefins, specifically, dicyclopentadiene, ethylene, propylene, 1-butene, 1-pentene, vinyl chloride, vinylidene chloride, isoprene, chloroprene, butadiene, 2,3-dimethylbutadiene, and the like;
styrenes, for example, styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, vinylbenzoic acid methylester, and the like;
Vinylethers, specifically, methylvinylether, butylvinylether, hexylvinylether, methoxyethylvinylether, and the like; and

Other monomers including butyl crotonate, hexyl crotonate, dimethyl itaconate, dibutyl itaconate, diethyl maleate, dimethyl maleate, dibutyl maleate, diethyl fumarate, dimethyl fumarate, dibutyl fumarate, methylvinylketone, phenylvinylketone, methoxyethylvinylketone, N-vinyloxazolidone, N-vinylpyrrolidone, vinylidene chloride, methylene malononitrile, vinylidene, diphenyl-2-acrlyloyloxyethyl phosphate, diphenyl-2-methacryloyloxyethyl phosphate, dibutyl-2-acrlyloyloxyethyl phosphate, dioctyl-2-methacryloyloxyethyl phosphate; and the like.

Examples of the monomer having a dissociative group include monomers having an anionic dissociative group and monomers having a cationic dissociative group.

The anionic monomers having a dissociative group include, for example, carboxylic acid monomers, sulfonic acid monomers, phosphoric acid monomers, and the like.

Examples of the carboxylic acid monomers include acrylic acid, methacrylic acid, itaconic acid, maleic acid, fumaric acid, citraconic acid, crotonic acid, itaconic acid monoalkyl ester (e.g., monomethyl itaconate, monoethyl itaconate, monobutyl itaconate, etc.), maleic acid monoalkyl ester (e.g., monomethyl maleate, monoethyl maleate, monobutyl maleate, etc.), and the like.

Examples of the sulfonic acid monomers include styrenesulfonic acid, vinylsulfonic acid, acrlyloyloxyalkylsulfuric acid (e.g., acrlyloyloxymethylsulfonic acid, acrlyloyloxyethylsulfonic acid, acrlyloyloxypropylsulfonic acid, etc.), methacryloyloxyalkylsulfuric acid (e.g., methacryloyloxymethylsulfonic acid, methacryloyloxyethylsulfonic acid, methacryloyloxypropylsulfonic acid, etc.), acrylamide alkylsulfuric acid (e.g., 2-acrylamido-2-methylethanesulfonic acid, 2-acrylamido-2-methylpropanesulfonic acid, 2-acrylamido-2-methylbutanesulfonic acid, etc.), methacrylamide alkylsulfuric acid (e.g., 2-methacrylamido-2-methylethanesulfonic acid, 2-methacrylamido-2-methylpropanesulfonic acid, 2-methacrylamido-2-methylbutanesulfonic acid, etc.) and the like.

The phosphoric acid monomers include, for example, vinylphosphonic acid, methacryloyloxyethylphosphonic acid, and the like.

Among them, acrylic acid, methacrylic acid, styrenesulfonic acid, vinylsulfonic acid, acrylamide alkylsulfuric acid, and methacrylamide alkylsulfuric acid are preferable; acrylic acid, methacrylic acid, styrenesulfonic acid, 2-acrylamido-2-methylpropanesulfonic acid, 2-acrylamido-2-methylbutanesulfonic acid are more preferable.

The cationic monomers having a dissociative group include, for example, monomers having a tertiary amino group such as dialkylaminoethyl methacrylate and dialkylaminoethyl acrylate.

In addition, examples of the monomers having a nonionic dispersible group include esters between a polyethylene glycol monoalkylether and a carboxylic acid monomer, esters between a polyethylene glycol monoalkylether and a sulfonic acid monomer, esters between a polyethylene glycol monoalkylether and a phosphoric acid monomer, vinyl group-containing urethanes from a polyethylene glycol monoalkylether and a monomer having a isocyanate group; macromonomers having a polyvinyl alcohol structure; and the like. The repeating number of the ethyleneoxy units in the polyethylene glycol monoalkylether is preferably 8 to 50 and more preferably 10 to 30. The carbon atom number of the alkyl group in the polyethylene glycol monoalkylether is preferably 1 to 20 and more preferably 1 to 12.

These monomers may be used alone or in combination of two or more monomers for a vinyl polymer, and are selected suitably according to the purpose of the vinyl polymer (adjustment of Tg, improvement in solubility, dispersion stability, etc,).

In the invention, among the vinyl polymers above, polymers having the dissociative group described above are preferable, those having at leas one of carboxyl and sulfate groups as the dissociative group are more preferably; and those having a carboxyl group as the dissociative group are particularly preferable.

The content of the dissociative group in the vinyl polymer is preferably 0.1 to 3.0 mmol/g and more preferably 0.2 to 2.0 mmol/g. When the content of the dissociative group is smaller, the vinyl polymer becomes less self-emulsifiable, and when the content is larger, the vinyl polymer becomes more water-soluble and thus less suitable for dispersion of dye. The anionic dissociation group above may further contain an alkali metal (e.g. Na, K, and the like) or an ammonium ion forming a salt, and the cationic dissociation group an organic acid (e.g., acetic acid, propionic acid, mehanesulfonic acid) or an inorganic acid (hydrochloric acid, sulfuric acid, and the like) forming a salt.

Specific examples of the vinyl polymers (P-1 to P-105) are listed below: The numbers in parenthesis indicate the mass ratio of co-monomers. The invention is not particularly limited to these specific examples.
P-1) Methyl methacrylate-ethyl acrylate copolymer (50:50)
P-2) Methyl methacrylate-methyl acrylate copolymer (65:35)
P-3) Butyl acrylate-styrene copolymer (50:50)
P-4) Polyethyl methacrylate
P-5) Poly-n-butyl methacrylate
P-6) Polyisobutyl methacrylate
P-7) Polyisopropyl methacrylate
P-8) Polymethyl chloroacrylate
P-9) Poly(2-tert-butylphenyl acrylate)
P-10) Poly(4-tert-butylphenyl acrylate)
P-11) n-Butyl methacrylate-N-vinyl-2-pyrrolidone copolymer (90:10)
P-12) Methyl methacrylate-vinyl chloride copolymer (70:30)
P-13) Methyl methacrylate-styrene copolymer (50:50)
P-14) Isobutyl methacrylate-butyl acrylate copolymer (55:45)
P-15), n-Butyl methacrylate-methyl methacrylate-styrene copolymer (50:30:20)
P-16) Vinyl acetate-acrylamide copolymer (85:15)
P-17) Vinyl chloride-vinyl acetate copolymer (65:35)
P-18) n-Butyl acrylate-methyl methacrylate-n-butyl methacrylate copolymer (35:35:30)
P-19) Diacetone acrylamide-methyl methacrylate copolymer (50:50)
P-20) Ethyl methacrylate-n-butyl acrylate copolymer (70:30)
P-21) Methyl methacrylate-cyclohexyl acrylate copolymer (50:50)
P-22) Tert-butyl methacrylamide-methyl methacrylate-acrylic acid copolymer (60:30:10)
P-23) n-Butyl acrylate-acrylic acid copolymer (80:20)
P-24) Methyl methacrylate-isobutyl methacrylate-acrylic acid copolymer (52:28:20)
P-25) Sec-butyl acrylate-acrylic acid copolymer (85:15)
P-26) n-Butyl methacrylate-pentyl methacrylate-methacrylic acid copolymer (38:38:24)
P-27) Ethyl acrylate-acrylic acid (95:5)
P-28) Isopropyl acrylate-acrylic acid copolymer (90:10)
P-29) Butyl methacrylate-2-hydroxyethyl methacrylate-acrylic acid copolymer (85:5:10)
P-30) Cyanoethyl acrylate-benzyl methacrylate-acrylic acid copolymer (60:30:10)
P-31) Isobutyl methacrylate-tetrahydrofurfuryl acrylate-acrylic acid copolymer (60:30:10)
P-32) n-Butyl methacrylate-tert-butyl acrylamide-acrylic acid copolymer (55:37:8)
P-33) n-Butyl methacrylate-1H,1H,2H,2H-perfluorodecyl acrylate-acrylic acid copolymer (75:20:5)
P-34) Methyl methacrylate-n-butyl acrylate-acrylic acid copolymer (50:45:5)
P-35) 2-Ethylhexyl methacrylate-methyl acrylate-acrylic acid copolymer (40:55:5)
P-36) 3-Methoxybutyl metacrylate-styrene-acrylic acid copolymer (35:50:15)
P-37) Cyclohexyl methacrylate-allyl methacrylate-acrylic acid copolymer (35:50:15)
P-38) Isopropyl methacrylate-furfuryl metacrylate-acrylic acid copolymer (80:10:10)
P-39) Isopropyl methacrylate-2-butoxyethyl methacrylate-acrylic acid copolymer (75:15:10)
P-40) Ethyl acrylate-phenyl methacrylate-acrylic acid copolymer (72:15:13)
P-41) Isobutyl methacrylate-2-(2-ethoxyethoxy)ethyl methacrylate-acrylic acid copolymer (80:10:10)
P-42) Isobutyl methacrylate-methacrylic ester of polyethylene glycol monomethylether (number of repeating ethyleneoxy units: 23)-acrylic acid copolymer (70:20:10)
P-43) Isobutyl methacrylate-dipropylene glycol monomethacrylate-acrylic acid copolymer (85:5:10),
P-44) Isobutyl methacrylate-methacrylic ester of polyethylene glycol monomethylether (number of repeating ethyleneoxy units: 9)-acrylic acid copolymer (80:10:10)
P-45) Isobutyl acrylate-glycidyl methacrylate-acrylic acid copolymer (75:15:10)
P-46) Isobutyl acrylate-methoxystyrene-acrylic acid copolymer (75:15:10)
P-47) Isobutyl acrylate-N-vinylpyrrolidone-acrylic acid copolymer (60:30:10)
P-48) Tert-butyl acrylate-methacrylic acid copolymer (88:12)
P-49) Hexyl acrylate-styrene-methacrylic acid copolymer (80:5:15)
P-50) 2,2,2-Tetrafluoroethyl methacrylate-methyl methacrylate copolymer-methacrylic acid copolymer (25:60:15)
P-51) Ethyl methacrylate-2-methoxyethyl methacrylate-methacrylic acid copolymer (70:15:15)
P-52) Ethyl methacrylate-2-ethoxyethyl methacrylate-methacrylic acid copolymer (70:15:15)
P-53) Vinyl acetate-methacrylic acid copolymer (85:15)
P-54) n-Butyl methacrylate-acrylamide-methacrylic acid copolymer (70:15:15)
P-55) Tert-octyl acrylamide-propyl methacrylate-methacrylic acid copolymer (20:65:15)

P-56) n-Butyl methacrylate-butoxymethyl acrylamide-methacrylic acid copolymer (80:5:15)
P-57) n-Butyl methacrylate-diphenyl-2-methacryloyloxyethyl phosphate-methacrylic acid copolymer (80:5:15)
P-58) Isobutyl methacrylate-dimethyl acrylamide-methacrylic acid copolymer (70:15:15)
P-59) n-Butyl methacrylate-butyl acrylamide-methacrylic acid copolymer (70:15:15)
P-60) n-Butyl methacrylate-phenyl acrylamide-methacrylic acid copolymer (70:15:15)
P-61) n-Butyl methacrylate-methacrylamide-methacrylic acid copolymer (70:15:15)
P-62) n-Butyl methacrylate-methoxyethyl methacrylamide-methacrylic acid copolymer (70:15:15)
P-63) n-Butyl methacrylate-N-vinylpyrrolidone-methacrylic acid copolymer (70:15:15)
P-64) Isobutyl methacrylate-1H,1H,2H,2H-perfluorodecyl acrylate-methacrylic acid copolymer (55:30:15)
P-65) Isobutyl methacrylate-2-(2-methoxyethoxy)ethyl methacrylate-methacrylic acid copolymer (50:35:15)
P-66) n-Butyl methacrylate-styrenesulfonic acid copolymer (90:10)
P-67) Ethyl methacrylate-styrenesulfonic acid copolymer (90:10)
P-68) n-Butyl acrylate-styrene-styrenesulfonic acid copolymer (80:10:10)
P-69) Isobutyl methacrylate-styrenesulfonic acid copolymer (90:10)
P-70) Isobutyl acrylate-triethylene glycol monomethacrylate-styrenesulfonic acid copolymer (80:10:10)
P-71) n-Butyl acrylate-1H,1H,2H,2H-perfluorodecyl methacrylate-styrenesulfonic acid copolymer (80:10:10)
P-72) n-Butyl acrylate-2-butoxyethyl methacrylate-styrenesulfonic acid copolymer (70:20:10)
P-73) n-Butyl methacrylate-2-acrylamido-2-methylethanesulfonic acid copolymer (90:10)
P-74) n-Butyl acrylate-2-butoxyethyl methacrylate-2-acrylamido-2-methylethanesulfonic acid copolymer (70:20:10)
P-75) Isobutyl methacrylate-2-acrylamido-2-methylethanesulfonic acid copolymer (90:10)
P-76) Isobutyl acrylate-n-butyl methacrylate-2-acrylamido-2-methylethanesulfonic acid copolymer (70:20:10)
P-77) Ethyl acrylate-tert-butyl methacrylate-2-acrylamido-2-methylethanesulfonic acid copolymer (60:30:10)
P-78) n-Butyl methacrylate-2-acrylamido-2-methylpropanesulfonic acid copolymer (90:10)
P-79) Ethyl methacrylate-2-acrylamido-2-methylpropanesulfonic acid copolymer (90:10)
P-80) Ethyl acrylate-tert-butyl methacrylate-2-acrylamido-2-methylpropanesulfonic acid copolymer (60:30:10)
P-81) n-Butyl acrylate-tert-butyl methacrylate-2-acrylamido-2-methylpropanesulfonic acid copolymer (60:30:10)
P-82) Tert-butyl acrylate-tetrahydrofurfuryl acrylate-2-methylpropanesulfonic acid copolymer (50:40:10)
P-83) Tert-butyl acrylate-1H,1H,2H,2H-perfluorodecyl methacrylate-2-acrylamido-2-methylpropanesulfonic acid copolymer (50:30:10)
P-84) Tert-butyl acrylate-methacrylic ester of polyethylene glycol monomethylether (number of repeating ethyleneoxy units: 2-(3)-2-acrylamido-2-methylpropanesulfonic acid copolymer (60:30:10)
P-85) Isobutyl acrylate-N-vinylpyrrolidone-2-acrylamido-2-methylpropanesulfonic acid copolymer (60:30:10)
P-86) Ethyl methacrylate-sodium 2-acrylamido-2-methylpropanesulfonate copolymerization (90.4:9.6)
P-87) n-Butyl methacrylate-sodium 2-acrylamido-2-methylpropanesulfonate copolymer (98:12)
P-88) Isobutyl methacrylate-sodium 2-acrylamido-2-methylpropanesulfonate copolymer (90.4:9.6)
P-89) n-Butyl methacrylate-tert-butyl methacrylate-sodium 2-acrylamido-2-methylpropanesulfonate copolymer (50:35:15)
P-90) Vinylpyrrolidone-isobutyl methacrylate-sodium 2-acrylamido-2-methylpropanesulfonate copolymer (50:35:15)
P-91) n-Butyl methacrylate-2-methacrylamide-2-methylpropanesulfonic acid copolymer (90:10)
P-92) n-Butyl acrylate-tert-butyl methacrylate-2-methacrylamido-2-methylpropanesulfonic acid copolymer (60:30:10)
P-93) Isobutyl acrylate-hydroxymethyl acrylamide-2-methacrylamido-2-methylpropanesulfonic acid copolymer (80:10:10)
P-94) n-Butyl acrylate-tert-butyl methacrylate-vinylsulfonic acid copolymer (60:30:10)
P-95) Hexyl methacrylate-methyl methacrylate-vinylsulfonic acid copolymer (40:45:15)
P-96) Ethyl acrylate-tert-butyl methacrylate-vinylsulfonic acid copolymer (60:30:10)
P-97) n-Butyl methacrylate-2-acrylamido-2-methylbutanesulfonic acid copolymer (90:10)
P-98) Ethyl methacrylate-2-acrylamido-2-methylbutanesulfonic acid copolymer (90:10)
P-99) Ethyl acrylate-tert-butyl methacrylate-2-acrylamido-2-methylbutanesulfonic acid copolymer (60:30:10)
P-100) n-Butyl acrylate-tert-butyl methacrylate-2-acrylamido-2-methylbutanesulfonic acid copolymer (60:30:10)
P-101) Ethyl methacrylate-sodium 2-acrylamido-2-methylbutanesulfonate copolymer (90.4:9.6)
P-102) n-Butyl methacrylate-sodium 2-acrylamido-2-methylbutanesulfonate copolymer (98:12)
P-103) Isobutyl methacrylate-sodium 2-acrylamido-2-methylbutanesulfonate copolymer (90.4:9.6)
P-104) n-Butyl methacrylate-tert-butyl methacrylate-sodium 2-acrylamido-2-methylbutanesulfonate copolymer (50:35:15)
P-105) n-Butyl methacrylate-2-methacrylamido-2-methylbutanesulfonic acid copolymer (90:10)

The molecular weight (Mw) of the vinyl polymer is normally 1,000 to 100,000 and preferably 3,000 to 50,000. When the molecular weight is in the range of 1,000 to 100,000, the vinyl polymer provides a stable dispersion of colored microparticles and is more soluble in an organic solvent, providing it with a suitable viscosity and making the microparticles more dispersible.

Production of Microparticle Dispersion

The microparticle dispersion according to the invention is produced by dispersing the oil-soluble compound and the hydrophobic polymer described above in an aqueous medium (solution at least containing water) in the colored microparticle form. Specifically, the methods include, for example, a method of preparing a latex of the hydrophobic polymer and then impregnating the oil-soluble compound therein, a coemulsifying dispersion method, and the like.

Among them, the coemulsifying dispersion method is preferable. A favorable example of the coemulsifying dispersion method is to add water to an organic solvent containing one of the dispersible polymers and one of the oil-soluble compounds described above or to add the organic solvent into water, thus emulsifying the organic solvent into microparticles.

The latex refers to a dispersion in which the oil-soluble polymer insoluble in an aqueous medium is dispersed as fine particles in an aqueous medium. The oil-soluble polymer may be any state in the dispersion, such as a state emulsified in the aqueous medium, an emulsion-polymerized state or a micell-dispersed state, or alternatively a molecule chain dispersed state in which the oil-soluble polymer having a partially hydrophilic structure in its molecule is in the aqueous medium.

Organic Solvent

The organic solvents used for producing the colored fine particle dispersion are not particularly limited, and can suitably be selected depending on the solubility of the oil-soluble dye and the oil-soluble polymer. Examples thereof include ketone solvents such as acetone, methyl ethyl ketone or diethyl ketone, alcohol solvents such as methanol, ethanol, 2-propanol, 1-propanol, 1-butanol or tert-butanol, chlorined solvents such as chloroform or methylene chloride, aromatic solvents such as benzene or toluene, ester solvents such as ethyl acetate, butyl acetate or isopropyl acetate, ether solvents such as diethyl ether, tetrahydrofuran or dioxane, and glycol ether solvents such as ethylene glycol monomethyl ether or ethylene glycol dimethyl ether.

The organic solvents may be used singly, or in combination of two or more thereof. Depending on the solubility of the oil-soluble dye or polymer, the solvent may be a mixture with water.

The amount of the organic solvent used is not particularly limited if it is in the range that does not impair the advantage effects of the invention, but preferably 10 to 2,000 parts by weight and more preferably 100 to 1,000 parts by weight with respect to 100 parts by weight of the dispersible polymer.

Adjustment of the amount of the organic solvent used in the range of 10 to 2,000 part by weight allows production of ultrafine colored particles stably dispersed therein and makes the solvent removal and concentration steps for removal of the organic solvent simpler, providing more freedom in designing the ink composition according to the invention.

When a vapor pressure of the organic solvent is higher than that of water, it is preferable to remove the organic solvent from the standpoints of stability of the colored fine particle dispersion, safety and health. The method of removing the organic solvent may be conducted by any known methods depending on the kinds of solvents, and examples of the methods include evaporation, vacuum evaporation, ultrafiltration and the like. The step of removing the organic solvent is preferably carried out as soon as possible after emulsifying operation. Viscosity adjuster (additive for increasing viscosity).

The viscosity of the microparticle dispersion according to the invention is preferably in the range of 5 to 70 mPa·s. It is more preferable to adjust the viscosity in the range of 10 to 50 mPa·s, and accordingly a viscosity adjuster is used for adjusting the viscosity into a desirable range. Examples of the viscosity adjusters include polyvalent alcohols such as glycerin, ethylene glycol, propylene glycol, diethylene glycol, polyethylene glycol, thiodiglycol, dithiodiglycol, 2-methyl-1,3-propanediol, 1,2,6-hexanetriol, glycerin, trimethylolpropane, or diethanolamine; substituted or unsubstituted aliphatic monovalent alcohols such as amyl alcohol, furfuryl alcohol, diacetone alcohol, ethylene glycol monoethylether, diethylene glycol monomethylether, or triethylene glycol monoethylether, and water-soluble polymers such as celluloses or polyvinyl alcohol; and the like.

Among these, polyvalent alcohols and substituted or unsubstituted aliphatic monovalent alcohols are preferable, and polyvalent alcohols such as glycerin and diethylene glycol are more preferable. The water-soluble organic solvents may be used alone or in combination of two or more.

The content of the water-soluble organic solvent in the ink is preferably 5 to 60%, more preferably 7 to 50%, and particularly preferably 10 to 40% by weight.

Additives

The ink composition of the invention may further contain additives suitably selected depending on the purposes such that the effect of the invention is not adversely affected.

Examples of the additive include a neutralizing agent, a hydrophobic organic solvent having a high-boiling point, a dispersant and a dispersion stabilizer.

When the oil-soluble polymer has a non-neutralized dissociable group, the neutralizing agent may preferably be used for adjusting the pH of the colored fine particle dispersion, for regulating self-emulsifiability and for conferring dispersion stability.

Examples of the neutralizing agent include an organic base, an inorganic alkali, and the like.

Representative examples of the organic base include triethanolamine, diethanolamine, N-methyldiethanolamine and dimethylethanolamine.

Specific examples of the inorganic alkali include alkali metal hydroxides (e.g., sodium hydroxide, lithium hydroxide, potassium hydroxide), carbonates (e.g., sodium carbonate, sodium bicarbonate) and ammonia.

From the standpoint of improving the stability of the colored fine particle dispersion, the neutralizing agent is added preferably for adjusting the pH value to 4.5 to 10.0, and more preferably 6.0 to 10.0.

The hydrophobic high-boiling point organic solvent is used for controlling the viscosity, specific gravity and printing performance of the colored fine particle dispersion The hydrophobic high-boiling point organic solvent is a hydrophobic solvent having a boiling point of preferably 150° C. or more, and more preferably 170° C. or more. The term “hydrophobic” as used herein means that solubility in distilled water at 25° C. is 3% or less. The dielectric constant of the hydrophobic high-boiling point organic solvent preferably ranges from 3 to 12, and more preferably from 4 to 10. The dielectric constant means a relative dielectric constant measured at 25° C. relative to vacuum. The hydrophobic high-boiling point organic solvent may be the compounds described in U.S. Pat. No. 2,322,027 and Japanese Patent Application No. 2000-78531. Specific examples thereof include triester phosphates, diester phthalates, alkyl naphthalenes and aromatic acid esters. The hydrophobic high-boiling point organic solvent for use in the invention may have any form of a liquid and solids at ordinary temperatures, depending on the purposes.

The amount of the high-boiling solvent used is not particularly limited insofar as the effect of the invention is not adversely affected. Usually, the amount thereof is preferably 0 to 1,000 parts by mass, and more preferably 0 to 300 parts by mass, relative to 100 parts by mass of the oil-soluble polymer.

The dispersant and/or the dispersion stabilizer may be added to the polymer latex, the oil-soluble dye-containing solution, the mixture of polymer and oil-soluble dye, the fine dye particle dispersion, the polymer solution or the liquid containing at least water, but is preferably added to the oil-soluble dye-containing solution or the liquid containing at least water prior to the step of preparing the polymer latex and/or the fine dye particle.

Examples of the dispersant and the dispersion stabilizer include a wide variety of cationic, anionic or nonionic surfactants, water-soluble or water-dispersible low-molecular compounds, oligomers, and the like. The amount of the dispersant and dispersion stabilizer to be added is 0 to 100% by mass, and more preferably 0 to 20% by mass, relative to the total amount of the oil-soluble compound and the hydrophobic polymer.

Ink Composition

Besides the microparticle dispersion, the ink composition according to the invention may contain other additives suitably selected as needed. Examples of the other additives include known additives such as water-soluble organic solvent, anti-drying agent, penetration-accelerating agent, antioxidant, fungicide, pH adjuster, surface tension adjuster, antiform agent, viscosity adjuster, dispersant, dispersion stabilize, antirust agent, chelating agent, ultraviolet absorbent, as well as those described in paragraph numbers (0217) to (0226) of JP-A No. 2001-279141 and in JP-A No. 2001-181549.

The water-soluble organic solvent is used for adjustment of the viscosity of ink composition, or as an anti-drying agent or a penetration-accelerating agent A water-soluble organic solvent having a vapor pressure lower than water is preferable as the water-soluble organic solvent Specific examples thereof include polyvalent alcohols represented by ethylene glycol, propylene glycol, diethylene glycol, polyethylene glycol, thiodiglycol, dithiodiglycol, 2-methyl-1,3-propanediol, 1,2,6-hexanetriol, glycerin, trimethylolpropane, and diethanolamine; substituted or unsubstituted aliphatic monovalent alcohols represented by amyl alcohol, furfuryl alcohol, diacetone alcohol, ethylene glycol monoethylether, diethylene glycol monomethylether, and triethylene glycol monoethylether, heterocyclic compounds such as 2-pyrrolidone, N-methyl-2-pyrrolidone, 1,3-6-methyl-2-imidazolidinone, and N-ethylmorpholine; containing compounds such as sulfolane, dimethylsulfoxide, and 3-sulfolene; and the like.

The water-soluble organic solvent is preferably added to the ink composition in an amount of 5 to 60%, more preferably 7 to 50%, and still more preferably 10 to 40% by weight, and the final addition amount is determined according to the desired viscosity.

The surface tension adjusters include nonionic, cationic, and anionic surfactants. Examples of the anionic surfactants include fatty acid salts, alkylsulfuric acid ester salts, alkylaryl sulfonate salts (e.g., alkylbenzenesulfonic acid salt, petroleum sulfonate salt, etc.), dialkyl sulfosuccinic acid salts, alkylphosphoric acid ester salts, naphthalenesulfonic acid formaline condensate, polyoxyethylene alkylsulfuric acid ester salts, and the like; and examples of the nonionic surfactants include acetylene-based diols (e.g., 2,4,7,9-tetramethyl-5-decyn-4,7-diol and others), polyoxyethylene alkylether (e.g., polyoxyethylene decyl ether, ethylene oxide adducts of acetylene-based diols, etc.), polyoxyethylene fatty esters, sorbitan fatty esters, polyoxyethylene sorbitan fatty esters, polyoxyethylene alkylamines, glycerin fatty esters, oxyethylene oxypropylene block copolymers, and the like.

In addition, amine oxide-based amphoteric surfactants such as N,N-dimethyl-N-alkylamine oxide are also preferable. Further, the surfactants described on pages (37) to (38) of JP-A No. 59-157636 and in Research Disclosure No. 308119 (1989) may also be favorably used.

From the viewpoints of precipitation and separation as well as bubble generation of the resulting ink, anionic surfactants having a double-chain-shaped hydrophobic region or a branched hydrophobic region, anionic surfactant having a hydrophilic group almost in the center of the hydrophobic region, nonionic surfactants having a double-chain-shaped hydrophobic region or a branched hydrophobic region (e.g., terminal 2-butyloctanoic acid half ester of polyethylene oxide, polyethylene oxide adduct of undecanol, etc.), and nonionic surfactants having a hydrophilic group almost in the center of the hydrophobic region (e.g., ethylene oxide adducts of acetylene-based diols (SURFYNOL®) series products (Air Products & Chemicals), etc.) are preferable; and among them, the surfactants having a molecular weight of 200 or more and 1,000 or less are preferable; those having a molecular weight of 300 or more and 900 or less still more preferable; and those having a molecular weight of 400 or more and 900 or less particularly preferable.

The surface tension of the ink composition according to the invention is preferably 20 to 60 mN/m, whether it contains a surfactant or not It is more preferably 25 to 45 mN/m. The dynamic surface tension thereof is preferably 20 to 40 mN/m, whether it contains a surfactant or not It is more preferably 25 to 35 mN/m.

Recording Medium

Hereinafter, the recording medium according to the invention will be described in detail.

The recording medium according to the invention has a support and an ink-receiving layer, with a porous structure and containing at least polymer microparticles, formed on the support, and in addition other layers selected appropriately as required such as a back layer, protective layer, intermediate layer, undercoat layer, cushion layer, antistatic layer, reflection layer, color tone-adjusting layer, storability-improving layer, anti-adhesive layer, anti-curl layer, and a smoothing layer. Any of these layers may be included as single- or multi-layer structures.

In the invention, the ink-receiving layer in the recording medium has a porous structure wherein there are numerous micropores. It is preferable that the porous structure of the ink-receiving layer is formed by secondary particles of the polymer microparticle, for expansion of the void percentage and an increase in the amount of ink absorption.

The distribution curve of the micropores in the adsorption surface of the ink-receiving layer can be determined, for example, by measurement using the nitrogen gas adsorption method and calculating according to the BJH method.

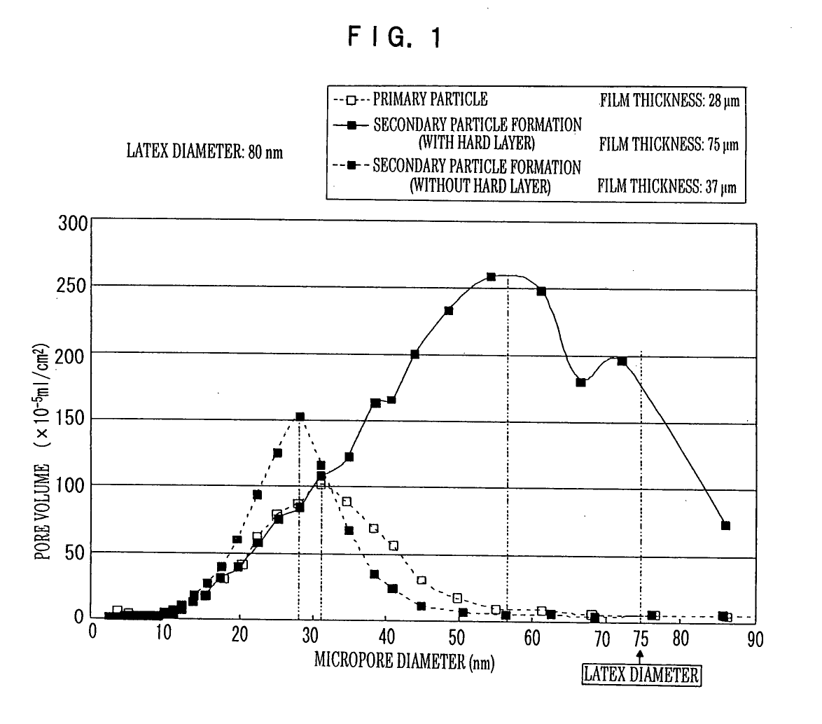

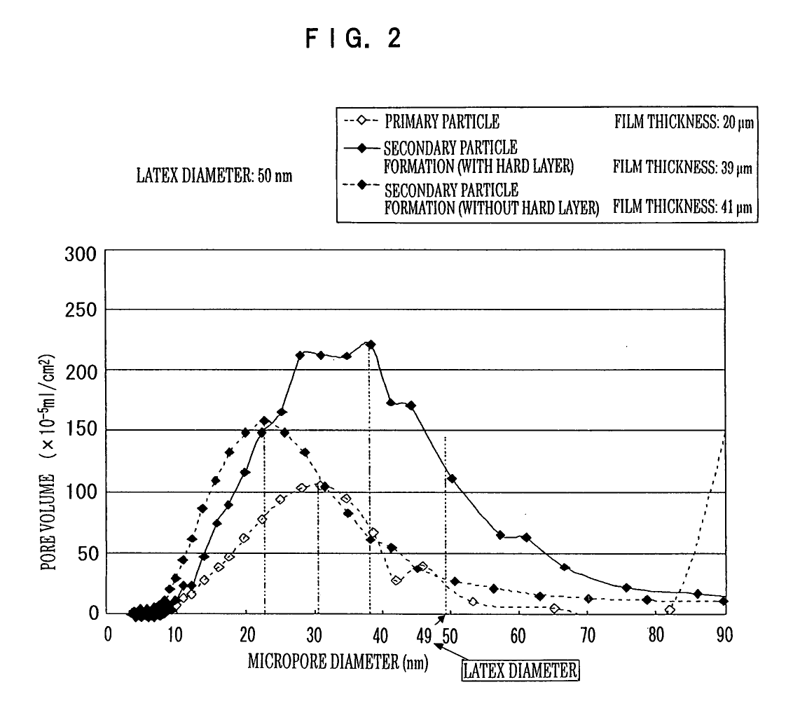

Specifically, as shown in FIG. 1 (primary diameter of polymer microparticles: 75 nm) and FIG. 2 (primary diameter of polymer microparticles: 49 nm), the maximum peak of the pore volume in the micropore distribution curve for an ink-receiving layer contain secondary particles of the polymer microparticle formed with a hard layer is grater than that in the micropore distribution curve of an ink-receiving layer containing secondary particles of the polymer microparticle formed without a hard layer thereof or in the micropore distribution curve of an ink-receiving layer containing only primary particles, and the micropore diameter corresponding to the peak is also g in the former case. In addition, optimization of the micropore distribution curve for an ink-receiving layer with a porous structure is also apparent from the results of the Examples described below.

Therefore, in the invention, the pore volume per unit thickness (A/B) of the ink receiving layer, which is calculated by dividing the pore volume A (×10⁻⁵ ml/cm²) of the ink-receiving layer at a micropore diameter not less than the diameter of the polymer microparticles as determined from the micropore distribution curve obtained by the nitrogen gas adsorption method, by the dry film thickness B (μm) of the ink-receiving layer, is preferably 2.0 (×10⁻⁵ ml/cm²/μm) or more; and the ratio (A/B) is more preferably 3.0 (×10⁻⁵ ml/cm² or more, and still more preferably 3.0 to 5.0 (×10⁻⁵ ml/cm²/μm).

When the pore volume per unit thickness (A/B) of the ink-receiving layer is 2.0 (×10⁻⁵ ml/cm²/μm) or more, the void percentage of the ink-receiving layer per unit thickness is large enough to allow favorable ink absorption.

The pore volume A of the ink-receiving layer at a micropore diameter equal to or greater than the diameter of polymer microparticles may vary according to the dry film thickness of the ink-receiving layer, but is preferably, for example, 50 (×10⁻⁵ ml/cm²) or more, more preferably 100 (×10⁻⁵ ml/cm²) or more, and particularly preferably 130 (×10⁻⁵ ml/cm²) or more.

The pore volume A at a micropore diameter identical to the diameter of the polymer microparticles contained in the ink-receiving layer can be determined from the micropore distribution curve obtained by measuring by the nitrogen gas adsorption method and calculating according to the BJH method.

The ratio ((Y/X)×100) of the micropore diameter Y(nm) corresponding to the maximum peak of the pore volume of the ink-receiving layer as determined from the micropore distribution curve obtained by the nitrogen gas adsorption method with respect to the diameter of polymer microparticle X(nm) is 65% or more and more preferably 70% or more. A ratio ((Y/X)×100) of less than 65% may lead to deterioration of the ink absorption property of the recording medium, occasionally causing bleeding of images. While the dry film thickness of the ink-receiving layer is not particularly limited, it is preferably 10 to 100 μm, more preferably 15 to 70 μm, and still more preferably 20 to 50 μm.

In addition, the micropore diameter Y corresponding to the maximum peak in pore volume of the secondary particles of the polymer microparticle in the ink-receiving layer as determined from the micropore distribution curve obtained by the nitrogen gas adsorption method is 33 nm or more, preferably 35 nm or more, and particularly preferably 40 nm or more. If the micropore distribution curve for the ink-receiving layer has a maximum peak at a micropore diameter Y of smaller than 33 nm, the ink-receiving medium may not have a sufficiently high ink absorption property. Here, the maximum peak means the highest peak in the micropore distribution curve of an ink-receiving layer.

The maximum peak in pore volume may vary according to the dry film thickness of the ink-receiving layer or other factors, but is preferably, for example, 200 ml/cm² or more and more preferably 220 ml/cm² or more. Further, the micropore distribution curve preferably has the maximum peak in pore volume within the micropore diameter range of 30 to 80 nm.

Ink-Receiving Layer

Micropores in the ink-receiving layer of the recording medium according to the invention that satisfy the properties described above can be formed only by appropriately adjusting the kind, particle diameter, shape, and the like of the polymer microparticle that is a constituent material of the ink-receiving layer, the kind of water-soluble resin used in combination with the polymer microparticle, the mixing ratio of the water-soluble resin to the polymer microparticle, and the like; as well as the kind and addition amount of the cross-lining agent, mordant, and the like added to the ink-receiving layer, and the relationship between, for example, drying conditions and film thickness when forming the ink-receiving layer. Hereinafter, respective constituent components of the ink-receiving layer will be described in detail.

Polymer Microparticle

The ink-receiving layer obtains a porous structure by containing polymer microparticles, thus increasing the ink-absorbing capacity thereof. In particular, it is preferable for the solid matter content of the polymer microparticles in the ink-receiving layer to be 50% by weight or more, and more preferably 60% by weight or more, because it is then possible to form a more favorable porous structure, and a recording medium sufficiently improved in ink absorptive property can be obtained. The upper limit value of the solid matter content of polymer microparticles in the ink-receiving layer is not particularly limited, but is preferably 90% by weight or less. The solid matter content of polymer microparticles in the ink-receiving layer is a content calculated with resect to all components in the ink-receiving layer except water.

The polymer microparticle (latex) may be used in the form of a dispersion of various polymers in a hydrophilic solvent. Specifically, aqueous dispersions of (co)polymers of a vinyl monomer, ester polymers, urethane polymers, amide polymers, epoxy polymers, the modified polymers and copolymers thereof, and the like may be used. Among them, use of (co)polymers of a vinyl monomer and urethane polymers is preferable, and use of the (co)polymers of a vinyl monomer is particularly preferable from the viewpoints of ink absorption property and the strength of the coated layer.

Favorable examples of the vinyl monomers include aromatic vinyl compounds (e.g., styrene, α-methylstyrene, p-hydroxystyrene, chloromethylstyrene and vinyltoluene), vinyl cyanides (e.g., (meth)acrylonitrile and α-chloroacrylonitrile), carboxylic acid vinyl esters (e.g., vinyl acetate, vinyl benzoate, and vinyl formate) aliphatic conjugated dienes (e.g., 1,3-butadiene and isoprene), alkyl(meth)acrylate esters (e.g., methyl (meth)acrylate, ethyl(meth)acrylate, n-butyl(meth)acrylate, i-butyl(meth)acrylate, and 2-ethylhexyl(meth)acrylate), alkylaryl(meth)acrylate esters (e.g., benzyl(meth)acrylate), substituted alkyl(meth)acrylate esters (e.g., glycidyl(meth)acrylate, 2-hydroxyethyl(meth)acrylate, dimethylaminoethyl(meth)acrylate, and dimethylaminopropyl(meth)acrylate), alkyl(meth)acrylamides (e.g., (meth)acrylamide, dimethyl(meth)acrylamide, N-isopropyl(meth)acrylamide, n-butyl(meth)acrylamide, tert-butyl(meth)acrylamide, and tert-octyl(meth)acrylamide), substituted alkyl(meth)acrylamides (e.g., dimethylaminoethyl(meth)acrylamide, and dimethylaminopropyl(meth)acrylamide), polymerizable oligomers (e.g., terminal half methacryloylated polymethyl methacrylate oligomers, terminal half methacryloylated polystyrene oligomers, and terminal half methacryloylated polyethylene glycol), and the like.

The polymers in the polymer microparticle are preferably crosslinked by a multifuctional monomer. Examples of the multifunctional monomers include aromatic divinyl compounds (e.g., divinylbenzene, divinylnaphthalene, or the derivatives thereof), esters and amides of diethylenecarboxylic acids (e.g., ethylene glycol di(meth)acrylate, trimethylolpropane tri(meth)acrylate, and dipentaerythritol hexa(meth)acrylate), and other divinyl compounds (e.g., divinyl sulfide compounds and divinylsulfone compounds), and the like.

The content of the multifunctional monomer in the polymer microparticle is preferably 2 mol % or more and more preferably 5 mol % or more. Addition of the multifunctional monomer in this manner prevents deformation of the particles during application and drying and increases the amount of voids in the ink-receiving layer.

These polymer microparticles are commonly obtained by an emulsion polymerization method. The surfactant, polymerization initiator, and others used therein may be selected suitably from those used in common methods. The preparative methods for the polymer microparticle are described in detail in U.S. Pat. Nos. 2,852,368, 2,853,457, 3,411,911, 3,411,912, and 4,197,127; Belgium Patent Nos. 688,882, 691,360, and 712,823; JP-B No. 45-5331; JP-A Nos. 60-18540, 51-130217, 58-137831, and 55-50240; and others.

The average particle diameter of the polymer microparticles is preferably 10 to 100 nm and more preferably 15 to 80 nm. The glass transition temperature (Tg) of the polymer microparticle is not particularly limited; generally, harder polymer microparticles having a higher glass transition temperature are preferable, for prevention of deformation of the particles during application and drying; and thus the polymer microparticle may be selected properly considering the kind of the binder used, the ratio thereof to the binder, the relationship with the desirable ink absorptive property, and the like.

The polymer microparticles forming secondary particles are preferable, because generation of the secondary particles expands the void percentage of ink-receiving layer.

Water-Soluble Resin

The ink-receiving layer in the recording medium according to the invention preferably contains a water-soluble resin in addition to the polymer microparticle described above.

Examples of the water-soluble resins include resins having a hydroxy group as the hydrophilic structural unit such as polyvinyl alcohol resins (polyvinyl alcohol (PVA), acetoacetyl-modified polyvinyl alcohols, cationic modified polyvinyl alcohols, anionic modified polyvinyl alcohols, silanol-modified polyvinyl alcohols, polyvinylacetal, etc.), cellulosic resins (methylcellulose (MC), ethylcellulose (EC), hydroxyethylcellulose (HEC), carboxymethylcellulose (CMC), hydroxypropyl cellulose (HPC), hydroxyethyl methylcellulose, hydroxypropyl methylcellulose, etc.), chitins, chitosans, starch, resins having an ether bond (polyethylene oxide (PEO), polypropylene oxide (PPO), polyethylene glycol (PEG), polyvinylether (PVE), etc.), resins having a carbamoyl group (polyacrylamide (PAAM), polyvinylpyrrolidone (PVP), polyacrylic acid hydrazide, etc.), and the like.

In addition, polyacrylic acid salts, maleic acid resins, alginate salts, gelatins and others having a carboxyl group as the dissociable group are also included.

Among the compounds above, polyvinyl alcohol resins are particularly preferable. Examples of the polyvinyl alcohol resins include those described in JP-B Nos. 4-52786, 5-67432, and 7-29479; Japanese Patent No. 2537827; JP-B No. 7-57553; Japanese Patent Nos. 2502998 and 3053231; JP-A No. 63-176173; Japanese Patent No. 2604367; JP-A Nos. 7-276787, 9-207425, 11-58941, 2000-135858, 2001-205924, 2001-287444, 62-278080, and 9-39373; Japanese Patent No. 2750433; JP-A Nos. 2000-158801, 2001-213045, 2001-328345, 8-324105, and 11-348417; and others.

Further, examples of the water-soluble resins other than the polyvinyl alcohol resins include the compounds described in paragraphs [0011] to [0014] of JP-A No. 11-165461. These water-soluble resins may be used alone or in combination of two or more. The content of the water-soluble resin is preferably 4 to 25% and more preferably 5 to 16% by weight with respect to the total solid matters in the ink-receiving layer.

In ink-jet recording, the porous ink-receiving layer obtained as described above absorbs rapidly ink in the capillary phenomenon, providing favorable dots completely circular in shape without generating ink bleeding. Weight ratio of polymer microparticle to water-soluble resin.

The weight ratio (PB ratio (x/y)) of polymer microparticle (x) to water-soluble resin (y) exerts a great influence on the film structure and the layer strength of ink-receiving layer. That is, incase of the weight ratio (PB ratio) generally leads to increase in void percentage, pore volume, and surface area (per unit weight) but also to decrease in density and strength.

The weight ratio (PB ratio (x/y)) of the ink-receiving layer is preferably 4/1 to 20/1 and more preferably 6/1 to 20/1, for prevention of the deterioration of layer strength and the cracking during drying caused by an excessively large PB ratio and for prevention of the decrease in void percentage and the resulting decrease in ink absorptive properties due to the tendency of the voids being filled with resins caused by a too smaller PB ratio.

Because a recording medium suffers an external stress when it is traveling on the conveyer system of inkjet printer, the ink-receiving layer should have a sufficiently high layer strength. It is also preferable for the ink-receiving layer to have a sufficiently high layer strength for prevention of the cracking and exfoliation of ink-receiving layer during the cutting process into the sheet-like form.

Cross-Linking Agent

A favorable embodiment of the ink-receiving layer in the recording medium according to the invention preferably is a coated film containing the water-soluble resin above which further contain a cross-linking agent capable of crosslinking the water-soluble resin, and an yet favorable embodiment thereof is a porous layer containing a polymer microparticle and a water-soluble resin that are hardened by the crosslinking reaction between the cross-linking agent and the water-soluble resin.

Boron compounds are preferable for crosslinking the water-soluble resin, in particular polyvinyl alcohol.

Examples of the boron compounds include borax, boric acid, boric acid salts (e.g., orthoboric acid salt, InBO₃, ScBO₃, YBO₃, LaBO₃, Mg₃(BO₃), CO₃(BO₃)₂, diboric acid salts (e.g., Mg₂B₂O₅, CO₂B₂O₅), metaboric acid salts (e.g., LiBO₂, Ca(BO₂, NaBO₂, KBO₂), tetraboric acid salts (e.g., Na₂B₄O₇-10H₂O), pentaboric acids (e.g., KB₅O₈-4H₂O, Ca₂B₆O₁₁-7H₂O, CsB₅O₅), and the like. Among them, borax, boric acid, and borate salts are preferable and boric acid is particularly preferable from the viewpoint of the speed of crosslinking reaction.

In addition to the boron compounds above, the following cross-linking agents may also be used for crosslinking the water-soluble resins.

Examples thereof include aldehyde compounds such as formaldehyde, glyoxal, and glutaric aldehyde; ketone compounds such as diacetyl and cyclopentanedione; activated halogen compounds such as bis(2-chloroethylurea)-2-hydroxy-4,6-dichloro-1,3,5-triazine and 2,4-dichloro-6-triazine sodium salt; activated vinyl compound such as divinylsulfonic acid, 1,3-vinyl sulfonyl-2-propanol, N,N′-ethylene-bis(vinylsulfonylacetamide), and 1,3,5-triacryloyl-hexahydro-5-triazine; N-methylol compounds such as dimethylol urea and methylol dimethyl hydantoin; melamine resins (e.g., methylol melamine, alkylated methylol melamine); epoxy resins;
isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; epoxy compounds such as glycerol triglycidylether, ethylene imino compounds such as 1,6-hexamethylene-N,N′-bisethylene urea; halogenated carboxy aldehyde compounds such as mucochloric acid and mucophenoxychloric acid; dioxane compounds such as 2,3-dihydroxy dioxane; metal-containing compounds such as titanium lactate, aluminum sulfate, chrome alum, potash alum, zirconyl acetate, and chromium acetate;
polyamine compounds such as tetraethylene pentamine; hydrazide compounds such as adipic acid dihydrazide; low-molecular weight or polymers having two or more oxazoline groups; and the like.

The cross-linking agents may be used alone or in combination of two or more.

In the invention, the crosslinking is carried out by adding a cross-linking agent to a coating solution containing a polymer microparticle and a water-soluble resin (hereinafter, refereed to as “coating solution A”) and/or the basic solution described below, forming a coated film by applying the coating solution, and adding the basic solution at a pH of 8 or more (hereinafter, refereed to as “coating solution B”) to the coated film either (1) as soon as the coated film is formed or (2) before the coated film shows a falling drying rate during the course of drying.

For example, in the case of a boron compound, the cross-linking agent is added in the manner as follows: Namely, when the ink-receiving layer is a layer formed by crosslinking a coated film obtained by applying a coating solution containing a polymer microparticle and a water-soluble resin including polyvinyl alcohol (coating solution A), the crosslinking and hardening is carried out by forming a coated film by applying the coating solution, and adding a basic solution at a pH of 8 or more (hereinafter, referred to as “coating solution B”) to the coated film either (1) as soon as the coated film is formed or (2) before the coated film shows a falling drying rate during the course of drying. The boron compound used as the cross-linking agent may be contained in any one or both of the coating solutions A and B.

The amount of the cross-linking agent used is preferably 1 to 50 wt % and more preferably 5 to 40 wt % with respect to the weight of the water-soluble resin.

Mordant

In the invention, it is preferable to add a mordant into the ink-receiving layer for improvement in the water resistance of formed images and in the efficiency of preventing ink bleeding over time. An organic mordant such as a cationic polymer (cationic mordant) or an inorganic mordant is preferable as the mordant, and presence of the mordant in ink-receiving layer leads to interaction between the mordant and the anionic dye present as colorant in the liquid ink, thus stabilizing the colorant, increasing water resistance, and suppressing ink breeding over time. Organic mordants and inorganic mordants may be used alone or in combination of an organic mordant and an inorganic mordant.

The mordant may be added into the coating solution A containing a polymer microparticle and a water-soluble resin or to the coating solution B if there is concern over the coagulation thereof with polymer microparticles.

Polymeric mordants having a primary to tertiary amino group or a quaternary ammonium salt group as the cationic group are favorably used as the cationic mordant, and cationic non-polymeric mordants may also be used. Compounds having a weight-average molecular weight of 500 to 100,000 are preferable as the mordant for improving the ink absorptive property of ink-receiving layer.

Homopolymers of a monomer having a primary to tertiary amino group or the salt thereof or a quaternary ammonium salt group (mordant monomer) and copolymers or condensation polymers of the mordant monomer with another monomer (hereinafter, referred to as “non-mordant monomer”) are favorable as the polymer mordant In addition, these polymer mordant may be used in the form of water-soluble polymer or water-dispersible latex particle, or the like.

Examples of the monomers (mordant monomers) include trimethyl-p-vinylbenzylammonium chloride, timethyl-m-vinylbenzylammonium chloride, triethyl-p-vinylbenzlammonium chloride, triethyl-m-vinylbenzylammonium chloride, N,N-dimethyl-N-ethyl-N-p-vinylbenzylammonium chloride, N,N-ethyl-N-methyl-N-p-vinylbenzylammonium chloride-N,N-dimethyl-N-n-propyl-N-p-vinylbenzylammonium chloride, N,N-diethyl-N-n-octyl-N-p-vinyl benzylammonium chloride, N,N-dimethyl-N-benzyl-N-p-vinyl benzylammonium chloride, N,N-diethyl-N-benzyl-N-p-vinyl benzylammonium chloride, N,N-dimethyl-N-(4-methyl)benzyl-N-p-vinylbenzylammonium chloride, N,N-dimethyl-N-phenyl-N-p-vinylbenzylammonium chloride, trimethyl-p-vinylbenzylammonium bromide, trimethyl-m-vinylbenzylammonium bromide; trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinyl phenyl)ethylammonium chloride, N,N-diethyl-N-methyl-N-2-(4-vinylphenyl)ethylammonium chloride, N,N-ethyl-N-methyl-N-2-(4-vinylphenyl)ethylammonium acetate;
quaternary ammonium salts prepared in the reaction of methyl chloride, ethyl chloride, methyl bromide, ethyl bromide, methyl iodide or ethyl iodide with
N,N,-dimethylaminoethyl(meth)acrylate, N,N-ethylaminoethyl(meth)acrylate, N,N-dimethylaminopropyl (meth)acrylate, N,N-diethylaminopropyl(meth)acrylate, N,N-dimethylaminoethyl(meth)acrylamide, N,N-diethylaminoethyl(meth)acrylamide, N,N-dimethylaminopropyl(methacrylamide, or N,N-dimethylaminopropyl(meth)acrylamide, or the anion-exchanged salts thereof such as sulfonate salt, alkylsulfuric acid salt, acetate salt or alkylcarboxylate salt; and the like.

Specific examples thereof include monomethyldiallylammonium chloride, trimethyl-2-(methacryloyloxy)ethylammonium chloride, triethyl-2-(methacryloyloxy)ethylammonium chloride, trimethyl-2-(acrlyloyloxy)ethylammonium chloride, triethyl-2-(acrlyloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acrlyloylamino)ethylammonium chloride, triethyl-2-(acrlyloylamino)ethylammonium chloride, trimethyl-3-(methacryloylamino)propylammonium chloride, triethyl-3-(methacryloylamino)propylammonium chloride, trimethyl-3-acrlyloylamino)propylammonium chloride, triethyl-3-(acrlyloylamino)propylammonium chloride, N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acrlyloylamino)propylammonium chloride, trimethyl-2-(methacryloyloxy)ethylammonium bromide, trimethyl-3-(acrlyloylamino)propylammonium bromide, trimethyl-2-(methacryloyloxy)ethylammonium sulfonate, trimethyl-3-(acrlyloylamino)propylammonium acetate, and the like. In addition, N-vinylimidazole, N-vinyl-2-methylimidazole, and the like may be used as the copolymerizable monomer.

Further, allylamine, diallylamine, and the derivatives and salts thereof may also used. Examples of these compounds include allylamine, allylamine hydrochloride salt, allylamine acetate salt, allylamine sulfate salt, diallylamine, diallylamine hydrochloride salt, diallylamine acetate salt, diallylamine sulfate salt, diallyl methylamine and the salts thereof (including, for example, hydrochloride salt, acetate salt, sulfate salt, etc.), diallylethylamine and the salts thereof (including, for example, hydrochloride salt, acetate salt, sulfate salt, etc.), diallyldimethylammonium salt (the counter anion thereof including chloride, acetate ion, sulfate ion, etc.), and the like. These allylamines and diallylamine derivatives are less polymerizable in the amine form, and thus generally polymerized in the salt form and the counter ion is removed after polymerization as needed. Also usable are polymers obtained by polymerizing a compound containing a unit such as N-vinylacetamide, N-vinylformamide, or the like and converting the resulting polymer into polyamine by hydrolysis and further into the salt.

The non-mordant monomer described above is a monomer having no basic or cationic group such as a primary to tertiary amino group or the salt thereof, or a quaternary ammonium salt group that has no or practically smaller interaction with the dye in ink-jet ink. Examples of the non-mordant monomers include alkyl(meth)acrylate esters; cycloalkyl(meth)acrylate esters such as cyclohexyl (meth)acrylate; (meth)acrylic acid arylesters such as phenyl(meth)acrylate; aralkyl esters such as benzyl(meth)acrylate; aromatic vinyl compounds such as styrene, vinyltoluene, and α-methylstyrene; vinyl esters such as vinyl acetate, vinyl propionate, and vinyl versatate; allyl esters such as allyl acetate; halogen-containing monomers such as vinylidene chloride and vinyl chloride; vinyl cyanides such as (meth)acrylonitrile; olefins such as ethylene and propylene; and the like.

The alkyl(meth)acrylate ester described above preferably has an alkyl group having 1 to 18 carbons, and specific examples thereof include methyl(meth)acrylate, ethyl(meth)acrylate, propyl(meth)acrylate, isopropyl(meth)acrylate, n-butyl(meth)acrylate, isobutyl(meth)acrylate, t-butyl(meth)acrylate, hexyl(meth)acrylate, octyl(meth)acrylate, 2-ethylhexyl(meth)acrylate, lauryl(meth)acrylate, stearyl(meth)acrylate, and the like. Among them, methyl acrylate, ethyl acrylate, methyl methacrylate, ethyl methacrylate, and hydroxyethyl methacrylate are preferable.

The non-mordant monomers may also be used alone or in combination of two or more.

Favorable examples of the polymer mordants include polydiallyldimethylammonium chloride, polymethacryloyloxyethyl-β-hydroxyethyldimethylammonium chloride, polyethyleneimine, polyallylamine and the derivatives thereof, polyamide-polyamine resins, cationic starch, dicyandiamide formaline condensates, dimethyl-2-hydroxypropylammonium salt polymers, polyamidine, polyvinylamine, dicyandiamide-formaline polycondensates represented by dicyan-based cationic resins, dicyanamide-ethylenetriamine polycondensates represented by polyamine-based cationic resins, epichlorohydrin-dimethylamine addition polymers, dimethyldiallylammonium chloride-SO₂ copolymers, diallylamine salt-SO₂ copolymers, (meth)acrylate-containing polymers having a quaternary ammonium salt group-substituted alkyl group in the ester portion, styryl polymers having a quaternary ammonium salt group-substituted alkyl group, and the like.

Specific examples of the polymer mordants include those described in JP-A Nos. 48-28325, 54-74430, 54-124726, 55-22766, 55-142339, 60-23850, 60-23851, 60-23852, 60-23853, 60-57836, 6060643, 60-118834, 60-122940, 60-122941, 60-122942, 60-235134, and 1-161236; U.S. Pat. Nos. 2,484,430, 2,548,564, 3,148,061, 3,309,690, 4,115,124, 4,124,386, 4,193,800, 4,273,853, 4,282,305, and 4,450,224; JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314; JP-B Nos. 5-35162, 5-35163, 5-35164, and 5-88846; JP-A Nos. 7-118333 and 2000-344990; Japanese Patent Nos. 2648847 and 2661677; and others. Among them, polyallylamines and the derivatives thereof are particularly preferable.

Polyallylamine having a weight-average molecular weight of 100,000 or less and the derivatives thereof are preferable as the organic mordant in the invention, particularly for prevention of ink bleeding over time.

Any one of various known allylamine polymers and the derivatives thereof may be used as the polyallylamine or the derivatives thereof according to the invention Examples of the derivatives include salts of polyallylamine with an acid (acids including inorganic acids such as hydrochloric acid, sulfuric acid, phosphoric acid, and nitric acid; and organic acids such as methanesulfonic acid, toluenesulfonic acid, acetic acid, propionic acid, cinnamic acid, and (meth)acrylic acid); or the mixed salts and partial salts thereof); derivatives of polyallylamines formed in polymerization reaction; copolymers from a polyallylamine and another copolymerizable monomer (specific examples of the copolymerizable monomers including (meth)acrylic esters, styrenes, (meth)acrylamides, acrylonitrile, vinyl esters, and the like).

Specific examples of the polyallylamines and the derivatives thereof include those described in JP-B Nos. 62-31722, 2-14364, 6343402, 6343403, 6345721, 63-29881, 1-26362, 2-56365, 2-57084, 441686, 6-2780, 6-45649, 6-15592, and 4-68622; Japanese Patent Nos. 3199227 and 3008369; JP-A Nos. 10-330427, 11-21321, 2000-281728, 2001-106736, 62-256801, 7-173286, 7-213897, 9-235318, 9-302026, and 11-21321; WO Nos. 99/21901 and 99/19372; JP-A No. 5-140213; Japanese Patent Application National Publication (Laid-Open) No. 11-506488; and others.

An inorganic mordant may be used as the mordant described above, and examples thereof include polyvalent water-soluble metal salts, hydrophobic metal salt compounds, and the like.

Specific examples of the inorganic mordants include salts and complexes of a metal selected from magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten, and bismuth Specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, ammonium copper (II) chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminum sulfate, aluminum alum, basic polyaluminum hydroxide, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, zirconium ammonium carbonate, zirconyl stearate, zirconyl octanoate, zirconyl nitrate, zirconium oxychloride, zirconium oxychloride, chromium acetate, chromium sulfate, magnesium sulfate, magnesium chloride hexahydrate, magnesium citrate nonahydrate, sodium phosphotungstate, sodium tungsten citrate, undecatungstophosphoric acid n-hydrate, undecagstosilicic acid 26-hydrate, molybdenum chloride, undecamolybdophosphoric acid n hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium 2-ethylhexanoate, praseodymium nitrate, neodymium nitrate, samarium nitrate, europium nitrate, gadolinium nitrate, dysprosium nitrate, erbium nitrate, ytterbium nitrate, hafnium chloride, bismuth nitrate, and the like.

Among the inorganic mordants, aluminum-containing compounds, titanium-containing compounds, zirconium-containing compounds, and metal compounds (salts or complexes) of the metals in group IIIB of the periodic table are preferable.

In the invention, the amount of the mordant added in the ink-receiving layer is preferably 0.01 to 5 g/m² and more preferably 0.1 to 3 g/m².

Other Component

The recording medium according to the invention may additionally contain, as needed, various additives known in the art such as acid, ultraviolet-absorbent, antioxidant, fluorescent whitening agent, monomer, polymerization initiator, polymerization inhibitor, anti-bleeding agent, antiseptic, viscosity stabilization agent, antifoamer, surfactant, antistatic agent, matting agent, anti-curl agent, water-resistance imparting agent, and the like.

The ink-receiving layer according to the invention may contain an acid. The surface pH of ink-receiving layer is adjusted to 3 to 8, preferably 5 to 7.5 by addition of an acid, which allows improvement in the yellowing resistance of the white portion of the resulting recording media The surface pH may be determined according to the method for measurement of surface pH that is commonly-known by the Japanese Technical Association of the Pulp and Paper Industry (J. TAPPI) as the “method A (coating method)”, by using, for example, a pH-measuring set for determining the pH of paper surface “MODEL MPC” (trade name, manufactured by KYORITSU CHEMICAL-CHECK Lab., Corp.), which complies with the A method.

Specific examples of the acids include formic acid, acetic acid, glycol acid, oxalic acid, propionic acid, malonic acid, succinic acid, adipic acid, maleic acid, malic acid, tartaric acid, citric acid, benzoic acid, phthalic acid, isophthalic acid, glutaric acid, gluconic acid, lactic acid, aspartic acid, glutamic acid, salicyclic acid, methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfinic acid, benzenesulfinic acid, sulfanilic acid, sulfamic acid, α-resorcinic acid, β-resorcinic acid, γ-resorcinic acid, gallic acid, fluoroglycine, sulfosalicyclic acid, ascorbic acid, erythorbic acid, bisphenolic acid, hydrochloric acid, nitric acid, sulfuric acid, phosphoric acid, polyphosphoric acid, boric acid, boronic acid and the like. The amount of the acid added is suitably selected so that the surface pH of the ink-receiving layer becomes 3 to 8. The acid above may be used as a metal salt (e.g., a salt of sodium, potassium, calcium, cesium, zinc, copper, iron, aluminum, zirconium, lanthanum-4 yttrium, magnesium, strontium, cerium, or the like), or as an amine salt (e.g., a salt of ammonia, triethylamine, tributylamine, piperazine, 2-methylpiperazine, polyallylamine, or the like).

The ink-receiving layer according to the invention preferably contains an additive for improving storage stability such as ultraviolet absorbent, antioxidant, anti-bleeding agent, or the like.

The ultraviolet absorbents, antioxidants, and anti-bleeding agents that may be added include alkylated phenolic compounds (including hindered phenolic compounds), alkylthiomethylphenol compounds, hydroquinone compounds, alkylated hydroquinone compounds, tocopherol compounds, thiodiphenylether compounds, compounds having two or more thioether bonds, bisphenol compounds, O-, N- and S-benzyl compounds, hydroxybenzyl compounds, triazine compounds, phosphonate compounds, acylaminophenol compounds, ester compounds, amide compounds, ascorbic acid, amine-based antioxidants, 2-(2-hydroxyphenyl)benzotriazole compounds, 2-hydroxy benzophenone compounds, acrylates, water-soluble or hydrophobic metal salts, organic metal compounds, metal complexes, hindered amine compounds (including TEMPO compounds), 2-(2-hydroxyphenyl)1,3,5-triazine compounds, metal deactivators, phosphite compounds, phosphonite compounds, hydroxyamine compounds, nitrone compounds, peroxide scavengers, polyamide stabilize, polyether compounds, basic auxiliary stabilizers, nucleating agents, benzofuranone compounds, indolinone compounds, phosphine compounds, polyamine compounds, thiourea compounds, urea compounds, hydrazide compounds, amidine compounds, saccharide compounds, hydroxybenzoic acid compounds, dihydroxybenzoic acid compounds, trihydroxybenzoic acid compounds, and the like.

Among them, alkylated phenol compounds, compound having two or more thioether bonds, bisphenol compounds, ascorbic acid, amine-based antioxidants, water-soluble or hydrophobic metal salts, organic metal compounds, metal complexes, hindered amine compounds, hydroxyamine compounds, polyamine compounds, thiourea compounds, hydrazide compounds, hydroxybenzoic acid compounds, dihydroxybenzoic acid compounds, trihydroxybenzoic acid compounds and the like are preferable.

Specific examples of the compounds include those described in JP-A Nos. 2002-307822, 10-182621, and 2001-260519; JP-B Nos. 4-34953 and 4-34513; JP-A No. 11-170686; JP-B No. 4-34512; EP No. 1138509; JP-A Nos. 60-67190, 7-276808, 2001-94829, 47-10537, 58-111942, 58-212844, 59-19945, 5946646, 59-109055, and 63-53544; JP-B Nos. 36-10466, 42-26187, 48-30492, 48-31255, 4841572, 48-54965, and 50-10726; U.S. Pat. Nos. 2,719,086, 3,707,375, 3,754,919, and 4,220,711; JP-B Nos. 45-4699 and 54-5324; European Patent Application laid-Open Nos. 223739, 309461, 309402, 310551, 310552, and 459416; German Patent Application Laid-Open No. 3435443; JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437, and 5-170361; JP-B Nos. 4843295 and 48-33212; U.S. Pat. Nos. 4,814,262 and 4,980,275; and the like.

The other components above may be used alone or in combination of two or more. The other component may be added after solubilized or dispersed in water, dispersed in polymer, emulsified, converted into oil droplets, or contained in microcapsules. In the recording medium according to the invention, the amount of the other components added is preferably 0.01 to 10 g/².

In the invention, the coating solution for the ink-receiving layer preferably contains a surfactant. Any one of cationic, anionic, nonionic, ampholytic, fluorine-based, and silicone surfactants may be used as the surfactant.

Examples of the nonionic surfactants include polyoxyalkylene alkyl ethers and polyoxyalkylenealkyl phenyl ethers (e.g., diethylene glycol monoethylether, diethylene glycol diethylether, polyoxyethylene laurylether, polyoxyethylene stearyl ether, polyoxyethylenenonyl phenyl ether, and the like); oxyethylene-oxypropylene block copolymers; sorbitan fatty esters (e.g., sorbitan monolaurate, sorbitan monooleate, sorbitan trioleate, and the like); polyoxyethylene sorbitan fatty esters (e.g., polyoxyethylene sorbitan monolaurate, polyoxyethylene sorbitan monooleate, polyoxyethylene sorbitan trioleate, and the like); polyoxyethylene sorbitol fatty esters (e.g., tetraoleic acid polyoxyethylene sorbit and the like); glycerin fatty esters (e.g., glycerol monooleate and the like), polyoxyethylene glycerin fatty esters (e.g., monostearic acid polyoxyethylene glycerin, monooleic acid polyoxyethylene glycerin, and the like); polyoxyethylene fatty esters (e.g., polyethylene glycol monolaurate, polyethylene glycol monooleate, and the like); polyoxyethylene alkylamines; acetylene glycols (e.g., 2,4,7,9-tetramethyl-5-decyne-4,7-ol, ethylene oxide and propylene oxide adducts of the diol, and the like); and the like, and polyoxyalkylene alkyl ethers are preferable. The nonionic surfactants may be used either in the first coating solution or second coating solution. In addition, the nonionic surfactants may be used alone or in combination of two or more.

The amphoteric surfactants include amino acid surfactants, carboxy ammonium betaine surfactants, sulfone ammonium betaine surfactants, ammonium sulfate ester betaine surfactants, imidazolium betaine surfactants, and other surfactants, and favorable examples thereof include those described in U.S. Pat. No. 3,843,368; JP-A Nos. 5949535, 63-236546, 5-303205, 8-262742, and 10-282619; Japanese Patent Nos. 2514194 and 2759795; JP-A No. 2000-351269; and others. Among the amphoteric surfactants above, amino acid surfactants, carboxy ammonium surfactants and sulfone ammonium betaine surfactants are preferable. The amphoteric surfactants may be used alone or in combination of two or more.

Examples of the anionic surfactants include fatty acid salts (e.g., sodium stearate and potassium oleate), alkylsulfuric acid ester salts (e.g., sodium laurylsulfate and laurylsulfuric acid triethanolamine), sulfonate salts (e.g., sodium dodecylbenzenesulfonate), alkyl sulfosuccinate salts (e.g., sodium dioctylsulfosuccinate), alkyldiphenylether disulfonic acid salts, alkylphosphoric acid salts, and the like.

Examples of the cationic surfactants above include alkylamine salts, quaternary ammonium salts, pyridinium salts, imidazolium salts, and the like.

The fluorochemical surfactants above include compounds p via an intermediate having a perfluoroalkyl group by means of electrolytic fluorination, telomerization, oligomerization or the like. Example of these compounds include perfluoroalkyl sulfonate salts, perfluoroalkyl carboxylate salts, perfluoroalkyl ethylene oxide adducts, perfluoroalkyltrialkylammonium salt, perfluoroalkyl group-containing oligomers, perfluoroalkyl phosphate esters, and the like.

Silicone oils modified with organic groups are preferable as the silicone surfactant above, and the silicone surfactants may have a siloxane structural unit having the side-chain modified with an organic group, or one or both ends of the surfactant modified therewith. The organic group modification includes amino modification, polyether modification, epoxy modification, carboxyl modification, carbinol modification, alkyl modification, aralkyl modification, phenol modification, fluorine modification, and the like.

The content of the surfactant is preferably 0.001 to 2.0% and more preferably 0.01 to 1.0% in the coating solution for the ink-receiving layer. If two or more coating solutions for the ink-receiving layers are used for coating, each of the coating solutions preferably contains a surfactant.

In the invention, the ink-receiving layer preferably contains a high-boiling point organic solvent for prevention of curling. The high-boiling point organic solvent is a water-soluble or hydrophobic organic compound having a boiling point of 150° C. or more under atmospheric pressure. The organic solvent may be liquid or solid at room temperature, and may be a low-molecular weight compound or a polymer.

Specific examples thereof include aromatic carboxylic acid esters (e.g., dibutyl phthalate, diphenyl phthalate, phenyl benzoate, and the like), aliphatic carboxylic acid esters (e.g., dioctyl adipate, dibutyl sebacate, methyl stearate, dibutyl maleate, dibutyl fumalate, triethyl acetylcitrate, and the like), phosphoric acid esters (e.g., trioctyl phosphate, tricresyl phosphate, and the like), epoxy compounds (e.g., epoxidized soya bean oil, epoxidized fatty acid methyl esters, and the like), alcohols (e.g., stearyl alcohol, ethylene glycol, propylene glycol, diethylene glycol, triethylene glycol, glycerol, diethylene glycol monobutylether (DEGMBE), triethylene glycol monobutylether, glycerin monomethyether, 1,2,3-butanetriol, 1,2,4-butanetriol, 1,2,6-pentanetriol, 1,2,6-hexanetriol, thiodiglycol, triethanolamine, polyethylene glycol, and the like), vegetable oils (e.g., soya bean oil, sunflower seed oil, and the like), higher aliphatic carboxylic acids (e.g., linoleic acid, oleic acid, and the like), and the like.

Support

Both a transparent support made of a transparent material such as plastic and an opaque support made of an opaque material such as paper may be used as the support for the recording medium according to the invention. Use of a transparent support or a high-glossiness opaque support is preferable for making the most of the transparency of ink-receiving layer. It is also possible to form an ink-receiving layer on the label surface of an optical disk, for example, by using a read-only optical disk such as CD-ROM or DVD-ROM, a write-once-read-many optical disk such as CD-R or DVD-R, or a rewritable optical disk.

A transparent material resistant to the radiant heat, which is applied when the medium is used on OHP or back light display, is preferable as the material for the transparent support Examples of the materials include polyesters such as polyethylene terephthalate (PET), polysulfone, polyphenylene oxide, polyimide, polycarbonate, polyamide, and the like. Among them, polyesters are preferable, and polyethylene terephthalate is particularly preferable. The thickness of the transparent support is not particularly limited, but is preferably 50 to 200 μm from the viewpoint of easiness in handling.

The high-glossiness opaque support preferably has a glossiness of 40% or more on the surface where the ink-receiving layer formed. The glossiness is a value determined by the known method, i.e., 75-degree mirror surface glossiness test procedure for paper and cardboard. Specific examples of the supports include the followings:

High-glossiness paper supports such as art paper, coated paper, cast-coated paper, baryta paper commonly used as silver salt photographic support and the like; high-glossiness films opacified by adding a white pigment or the like to any one of plastic films including polyesters such as polyethylene terephthalate (PET), nitrocelllulose, cellulose acetate, cellulose esters such as cellulose acetate butylate, polysulfone, polyphenylene oxide, polyimide, polycarbonate, polyamide and the like (which may be additionally surface calendered); supports having a polyolefin coated layer containing or not containing a white pigment formed on the surface of the various paper supports, the transparent supports or the high-glossiness films containing a white pigment or the like; and the like. Expanded polyester films containing a white pigment (e.g., expanded PET prepared by stretching a polyolefin microparticle-containing PET film and thus forming voids therein) are favorable and also included. In addition, resin coated papers commonly used as photographic papers for silver photograph are also favorable.

The thickness of the opaque support is also not particularly limited, but preferably 50 to 300 μm from the viewpoint of easiness in handling.

The surface of support may be subjected to a corona discharge treatment, glow discharge treatment, flame treatment, ultraviolet ray irradiation treatment, or the like for improvement in ink compatibility and adhesiveness.

Hereinafter, base paper for the resin-coated paper will be described in detail.

The base papers are prepared by sheeting a primary raw material of wood pulp and additionally a synthetic pulp such as polypropylene, or a synthetic fiber such as nylon or polyester as needed. The wood pulp may be any one of LBKP, LBSP, NBKP, NBSP, LDP, NDP, LUKP, and NUKP; but LBKP, NBSP, LBSP, NDP, and LDP, which contain a greater amount of short fibers, are preferable. However, the ratio of LBSP and/or LDP is 10% or more and 70% or less by weight.

Chemical pulps (sulfate salt pulp and sulfite pulp) containing a smaller amount of impurities are favorably used, and bleached pulps higher in whiteness are also useful.

Various additives including higher fatty acid, sizing agent such as alkylketene dimer, white pigment such as calcium carbonate, talc and titanium oxide, paper-strength additive such as starch, polyacrylamide, and polyvinyl alcohol, fluorescent whitening agent, moisturizing agent such as polyethylene glycols, dispersant, softener such as quaternary ammonium, and the like may be added to the base paper as needed.

The freeness of the pulp for use in sheeting is preferably 200 to 500 ml as Canadian Standard Freeness (CSF), and in regard to the fiber length after beating, the pulps remaining on 24- and 42-mesh screens is preferably 30 to 70% by weight, as determined by the known method of screening test of paper pulp. Further, the pulp remaining on 4-mesh screen is preferably 20% by weight or less.

The basis weight of the base paper is preferably 30 to 250 g and more preferably 50 to 200 g. The thickness of the base paper is preferably 40 to 250 μm. The base paper may be calendered for improvement in surface smoothness during or after the sheeting step. The density of the base paper is generally 0.7 to 1.2 g/m² as determined by the known test procedure for determination the thickness and density of paper.

In addition, the stiffness of the base paper is preferably 20 to 200 g as determined by the known test procedure for determining the stiffness of paper by using a Clark stiffness tester.

A surface-sizing agent may be applied onto the surface of the base paper and sizing agents similar to those that may be added to the base paper can be used as the surface sizing agent The pH of the base paper is preferably 5 to 9, as determined by the known hot-water extraction method specified in the test for determining the tensile properties of paper.

The polyethylene covering the front and rear surfaces of the base paper is mainly a low-density polyethylene (LDPE) and/or a high-density polyethylene (HDPE), but other LLDPE, polypropylene, or the like may also be used partially.

In particular, the polyethylene layer on the ink-receiving layer side is preferably one of the polyethylenes containing rutile or anatase titanium oxide, a fluorescent whitening agent, or ultramarine that are improved in opacity, whiteness and hue, which are commonly used in photographic papers. The content of the titanium oxide is preferably about 3 to 20% and more preferably 4 to 13% by weight with respect to polyethylene. The thickness of the polyethylene layer, either front or rear, is not particularly limited, but is favorably 10 to 50 μm. In addition, an undercoat layer may be formed on the polyethylene layer for increasing the adhesiveness thereof to an ink-receiving layer. Hydrophilic polyester, gelatin, and PVA are preferable for the undercoat layer. The thickness of the undercoat layer is preferably 0.01 to 5 μm.

The polyethylene-coated paper may be used as a glazed paper, and the polyethylene layer coated on the surface of base paper by melt-extrusion may be further subjected to a surface modification treatment such as embossing so that it has a mat or silky surface similar to that of common photographic printing papers.

Additionally, a backcoat layer may also be formed on the support, and components such as white pigment, aqueous binder, and other components may be added to the backcoat layer.

Examples of the white pigments contained in the backcoat layer include white inorganic pigments such as light calcium carbonate, heavy calcium carbonate, kaolin, talc, calcium sulfate, barium sulfate, titanium dioxide, zinc oxide, zinc sulfide, zinc arbonate, satin white, aluminum silicate, diatomaceous soil, calcium silicate, magnesium silicate, synthetic amorphous silica, colloidal silica, colloidal alumina, pseudoboehmite, aluminum hydroxide, alumina, lithopone, zeolite, hydrated hallosite, magnesium carbonate, and magnesium hydroxide; organic pigments such as styrene-based plastic pigment, acrylic plastic pigment, polyethylene, microcapsule, urea resin, and melamine resin; and the like.

Examples of the aqueous binders for use in the backcoat layer include water-soluble polymers such as styrene/maleic acid salt copolymers, styrene/acrylate salt copolymers, polyvinyl alcohol, silanol-modified polyvinyl alcohols, starch, cationic starch, casein, gelatin, carboxymethylcellulose, hydroxyethylcellulose, and polyvinylpyrrolidone; water-dispersible polymers such as styrene butadiene latexes and acryl emulsions; and the like. The other components contained in the backcoat layer include antiform agent, antifoaming agent, dye, fluorescent whitening agent, antiseptic, water-resistance imparting agent, and the like.

Preparation of Recording Medium

The ink-receiving layer in the recording medium according to the invention is favorably prepared, for example, by a method (Wet-on-Wet method) of applying the first coating solution at least containing a polymer microparticle and a water-soluble resin (hereinafter, referred to as “coating solution (A)”) on a support surface; applying the second coating solution containing at least a mordant at a pH of 8 or more (hereinafter, referred to as “coating solution (B)”) thereon either (1) simultaneously with the application or (2) before the film coated by application shows a falling drying rate while drying; and crosslinking and hardening the coated layer that is applied with the second coating solution (Wet-on-Wet method). The polymer microparticle according to the invention is favorably contained in at least one of the coating solution (A) and coating solution (B). In addition, the cross-Linking agent capable of crosslinking the water-soluble resin is also preferably contained in at least one of the coating solution (A) and coating solution (B). Formation of the thus crosslinked and hardened ink-receiving layer is advantageous for improvement in ink absorptive property and prevention of layer cracking.

The mordant is present in a greater amount in the ink-receiving layer closer to the surface when the layer is prepared by the method above, advantageously leading to more brilliant coloration of the ink-jet ink (ink composition) and increase in the water resistance of the characters and images after printing. Part of the mordants may be added to the coating solution (A), and in such a case, the mordant in the coating solution (A) may be the same as or different from that in the coating solution (B).

The coating solution for the ink-receiving layer can be applied by any one of know applications methods, for example, by using extrusion die coater, air doctor coater, blade coater, rod coater, knife coater, squeeze coater, reverse roll coater, bar coater, and the like.

The coating solution (B) is applied on the coated film simultaneously with or after application of the coating solution for the ink-receiving layer (coating solution (A)), but the coating solution (B) may be added before the coated film after application shows a falling drying rate. Thus, the recording medium according to the invention is favorably produced by introducing a mordant while the coated film is showing a constant drying rate after application of the coating solution for the ink-receiving layer (coating solution (A)).

The phrase “before the coated film shows a falling drying rate” normally indicates a period of few minutes immediately after application of the coating solution for the ink-receiving layer, during which the coated film shows a phenomenon of “constant drying rate” wherein the content of the solvent (dispersion medium) therein linearly decreases with time. The period of this “constant drying rate” is described, for example, in “Chemical Engineering Handbook” (pp. 707 to 712, published by Maruzen Co., Ltd., Oct. 25, 1980).

As described above, the first coating solution is dried after application commonly at 50 to 180° C. for 0.5 to 10 minutes (preferably, 0.5 to 5 minutes) until the coated film shows a falling drying rate. The drying period, of course, varies according to the amount coated, but is favorably in the above range.

The methods of applying the coating solution (B) before the first coated film shows a falling drying rate include methods of (1) applying the coating solution (B) additionally over the coated film, (2) spraying thereon for example by using a sprayer, (3) immersing the coated film-formed support in the coating solution (3), and the like.

Any one of known application methods, for example, by using a curtain flow coater, extrusion die coater, air doctor coater, blade coater, rod coater, knife coater, squeeze coater, reverse roll coater, bar coater, and the like, may be used for applying the coating solution (B) in the method (1). However, a coating method whereby the coater does not brought into direct contact with the first coated layer, such as that using an extrusion die coater, curtain flow coater, bar coater or the like, is preferably used.

The layer after application of the mordant solution (coating solution (B)) is heated usually at 40 to 180° C. for 0.5 to 30 minutes for drying and hardening. The layer is preferably heated at 40 to 150° C. for 1 to 20 minutes.

When the mordant solution (coating solution (B)) and ink-receiving layer coating solution (coating solution (A)) are applied at the same time, the ink-receiving layer can be formed by applying the ink-receiving layer coating solution (coating solution (A)) directly on the support and the mordant solution (coating solution (B)) over there (multi-layer application) and then drying and hardening the resulting layer.

The simultaneous application (multi-layer application) can be carried out, for example, by using an extrusion die coater or a curtain flow coater. After simultaneous application, the coated film formed is heated normally at 40 to 150° C. for 0.5 to 10 minutes and preferably at 40 to 100° C. for 0.5 to 5 minutes.

When the simultaneous application (multi-layer application) is performed, for example, by using an extrusion die coater, two kinds of liquids simultaneously extruded are laminated in the neighborhood of the outlet of the extrusion die coater; i.e., before the liquids are applied onto the support, and applied onto the support as it is. The two layers of coating solutions laminated before application tend to make a crosslinking reaction at the interface of the two solutions before they are applied onto the support, often causing increase in viscosity due to mixing of the two solutions at the neighborhood of the extrusion die coater and sometimes causing troubles in the application operation. Therefore, during the simultaneous application above, it is preferable to add a barrier-layer solution (intermediate-layer solution) between the ink-receiving layer coating solution (coating solution (A)) and the mordant solution (coating solution (B)) (simultaneous three-layer application).

The barrier-layer solution is not particularly limited, and examples thereof include an aqueous solution containing a trace amount of water-soluble resins, water, and the like. The water-soluble resins are used considering the coating properties of the solution, for example, for increasing the viscosity of the solution, and examples thereof are polymers including cellulosic resins (e.g., hydroxypropylmethylcellulose, methylcellulose, hydroxyethylmethylcellulose, and the like), polyvinylpyrrolidone, gelatin, and the like. The barrier-layer solution may contain the mordant above.

After formed on the support, the ink-receiving layer may be subjected to calendering, i.e., passage through roll nips under heat and pressure, for example, by using a super calendering or gloss calendering machine, or the like, for improvement in the surface smoothness, glossiness, transparency, and strength of the coated film. However, because the calendering sometimes causes decrease in void percentage (i.e., decrease in ink absorptive property), it is necessary to establish an appropriate condition smaller m the decrease in void percentage before calendering.

The roll temperature during calendering is preferably 30 to 150° C. more preferably 40 to 100° C., and the linear pressure between rolls during calendering is preferably 50 to 400 kg/cm and more preferably 100 to 200 kg/cm.

In the case of ink-jet recording, the thickness of the ink-receiving layer after drying should be decided according to the desirable void percentage of the layer, as the layer should have a sufficient absorption capacity allowing absorption of all droplets. For example, if the ink quantity is 8 nL/mm² and the void percentage is 60%, a film having a thickness of about 15 μm or more is required.

Considering the above, ink-receiving layers for ink-jet recording preferably have a thickness of 10 to 100 μm.

The ink-receiving layer is preferably more transparent; and the haze value, an indicator of transparency of the ink-receiving layer formed on a transparent film support is preferably 30% or less and more preferably 20% or less. The haze value may be determined by using a haze meter (trade name: HGM-2DP, manufactured by Suga Test Instrument Co., Ltd.).

The recording medium according to the invention can be produced by the methods described in JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, and 8-2093.

Recording Method

The recording method according to the invention records images on the recording medium described above by using an ink composition containing a microparticle dispersion that contains the oil-soluble compound, the hydrophobic polymer, and the like (hereinafter, referred to simply as “ink”), and, for example, by ejecting the ink composition on the recording medium. The methods for recording images on the recording medium by using the ink composition include ink-jet recording method, printing method, photolithographic method, transfer method, and the like, and among them, ink-jet recording and photolithographic methods are preferable.

In the recording method according to the invention, after the image formation above, the microparticles in the ink are then fused as the microparticles and the ink-receiving layer are heated and pressed as needed.

Hereinafter, the recording method according to the invention will be described, taking the ink-jet recording method of effectively ejecting ink through a nozzle onto a recording medium, which is particularly preferable in the invention, as an example.

The ink-jet recording method is not particularly limited, and may be any one of known methods including the charge-control method of ejecting ink by using electrostatic attraction, the drop-on-demand method (pressure pulse method) of ejecting ink by using the vibrational pressure of a piezoelectric element, the acoustic ink jet process of converting an electrical signal into a sound beam, and ejecting ink by the radiational pressure caused by irradiation of the beam thereon, and the thermal ink-jet method (bubble-jet (registered trade name)) of ejecting ink by using the pressure caused by air bubble generated and grown at high temperature, and the like.

In particular, the ink-jet recording method described in JP-A No. 54-59936, which ejects ink through a nozzle by the force due to the rapid change in volume of ink by application of thermal energy, is preferable as the ink-jet recording method.

The ink-jet recording methods includes methods of ejecting a great number of droplets of called photo ink, which is lower in concentration and smaller in volume, of improving image quality by using multiple kinds of inks having the same hue but different in concentration, and of using a clear colorless ink.

In addition, the ink jet head used in the ink-jet recording method may be that of on-demand method or of continuous method. Specific examples of the ejection methods include electromechanical conversion methods (e.g., single cavity type, double cavity type, vendor type, piston type, share mode type, shared wall type, and the like), electrothermal conversion methods (e.g., thermal inkjet type, bubble jet (registered trade name) type, and the like), electrostatic attraction methods (e.g., electric field-controlled type, slit jet type, and the like), discharge method (e.g., spark jet type and the like), and the like, and any method is usable.

The ink nozzle and others that are used in the recording by the ink-jet recording method are not particularly limited, and may be selected properly according to applications.

Heating Treatment

In the invention, the image recorded on the recording medium by using the ink composition is subjected to a heating treatment Specifically, a film layer is preferably formed on the recording medium after image formation by the heating treatment. The film layer is generated by heat fusion of the polymer microparticles in the ink-receiving layer. The film layer, which covers the ink-receiving layer surface, leads to increase in the water resistance, abrasion resistance, light fastness, and ozone resistance of the medium. The ink-receiving layer in the invention is particularly superior in abrasion resistance, as the ink composition does not contain any pigment.

The heating treatment is preferably carried out at a temperature of the glass transition temperature (Tg) of polymer microparticles or more, and more preferably about 10° C. higher than the Tg. The heating means are not particularly limited, and examples thereof include heated air, heated plate or roller, infrared ray, and the like. The period between completion of application and heating is not particularly limited but perferably shorter. It is preferably 1 second to 3 minutes and more preferably 1 second to 1 minute.

### EXAMPLES

Hereinafter, the invention will be described with reference to Examples, but the invention is not restricted to the Examples below. In the following Examples, “part” means “part by weight” and “%”, “% by weight” unless otherwise indicated.

### Example 1

Preparation of Microparticle Dispersion (D1)

A mixture solution containing 20 parts of ethyl acetate, 1.0 parts of the oil-soluble compound (a) represented by the following formula, and 3.0 parts of a hydrophobic polymer (t-butyl acrylamide/n-butyl acrylate 50/50 copolymer) was prepared. Separately, a mixture solution containing 25 parts of water and 0.5 parts of sodium (2-ethylhexyl)sulfosuccinate was prepared. The two mixture solutions were combined, emulsified and dispersed in a homogenizer, and ethyl acetate was removed therefrom, to give a microparticle dispersion containing 15% solid matter. The particle diameter of the colored microparticles in the microparticle dispersion, as determined by using a particle diameter distribution-measuring device “LB-500” manufactured by Horiba, Ltd., was 80 nm as volume average particle diameter. Hereafter, the microparticle dispersion is designated as microparticle dispersion (D1). 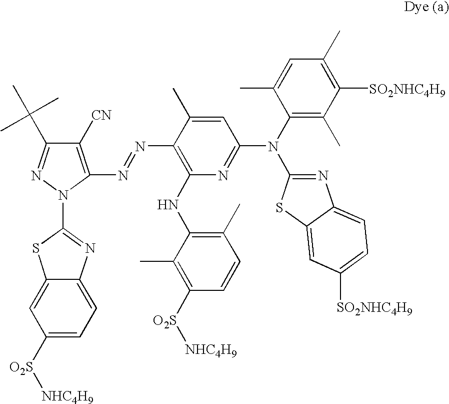
Preparation of Ink Composition 01

The following components were blended, and screened through a 0.45 μm filter, to give a desired ink composition (01) for ink-jet recording.

| | | |
|---|---|---|
| Microparticle dispersion (D1) above | 50 | parts |
| Diethylene glycol | 5 | parts |
| Glycerin | 15 | parts |
| Surfactant (trade name: OLFINE E1010, | 1 | part |
| manufactured by Nisshin Chemicals Co., Ltd.) | | |
| Water balance | to the total of 100 | parts |

Preparation of Polymer Microparticle Suspension

0.6 parts of sodium dodecylsulfate, 27 parts of methyl methacrylate, and 3 parts of divinylbenzene were added into 160 parts of ion-exchange water, and the mixture was stirred and heated to a temperature of 70° C. under a nitrogen stream. Then, an initiator solution containing 0.40 parts of potassium peroxobisulfite in 10 parts of ion-exchange water was added thereto. The mixture was allowed to react at a temperature of 70° C. additionally for 2 hours under a nitrogen stream while stirred, to give a suspension containing 15.0% polymer microparticles (1). The average particle diameter of the polymer microparticles (1) obtained was 49 nm.

Preparation of Support

A wood pulp containing 100 parts of LBKP was beaten in a double-disc refiner to a Canadian Standard Freeness of 300 ml, and was added with 0.5 parts (dry mass ratio with respect to the pulp) of epoxidized behenic amide, 1.0 parts of anionic polyacrylamide, 0.1 parts of polyamide polyamine epichlorohydrin, and 0.5 parts of cationic polyacrylamide, and the resulting mixture was sheeted into a base paper having a basis weight of 170 g/m in a Fourdrinier machine.

For adjustment of the surface size of the base paper, a fluorescent whitening agent (trade name: WHITEX BB, manufactured by Sumitomo Chemical Co., Ltd.) was added to an aqueous 4% polyvinyl alcohol solution at a concentration of 0.04%; the solution was impregnated into the base paper in such a manner that the polyvinyl alcohol is impregnated to a content of 0.5 g/m² as absolute dry mass; and the resulting sheet was dried and further calendered, to give a base material adjusted to a density of 1.05 g/ml.

The wire face (back side surface) of the base material obtained was subjected to a corona discharge treatment, and then coated with a high-density polyethylene film having a thickness of 19 μm by using a melt extruder, to give a mat-surfaced resin layer (hereinafter, the resin layer face is referred to as the “back side surface”). The resin layer on the back side surface is further subjected to a corona discharge treatment, and then, an aqueous dispersion containing antistatic agents, i.e., a mixture of aluminum oxide (trade name: ALUMINA SOL 100, manufactured by Nissan Chemical Industries, Ltd.) and silicon dioxide (SNOWTEX®O, manufactured by Nissan Chemical Industries, Ltd.) at a mass ratio of 1:2, was applied to a dry mass amount of 0.2 g/m².

Further, the felt face (front side surface), whereon no resin layer is formed, was subjected to a corona discharge treatment, and a high-gloss thermoplastic resin layer was formed on the paper front side surface by extruding a low-density polyethylene containing 10% anatase titanium dioxide, a trace amount of ultramarine, and a 0.01% (with respect to polyethylene) fluorescent whitening agent and having a MFR (melt flow rate) of 3.8, to a thickness of 29 μm, by using a melt extruder (hereinafter, the high-gloss surface will be referred to as the “front side surface”), to give a desired support.

Preparation of the Coating Solution for the Ink-Receiving Layer A

A polymer microparticle suspension, a surfactant solution, a polyvinyl alcohol solution, and ion-exchange water were mixed while stirred in the order shown in the following composition to give a coating solution for the ink-receiving layer (A).

Composition of the Coating Solution for the Ink-Receiving Layer A

| | | |
|---|---|---|
| Polymer microparticle suspension (1) | 10.0 | parts |
| Surfactant (aqueous 10% polyoxyethylene | 0.14 | parts |
| laurylether solution, HLB: 13.6) (trade name: Emulgen | | |
| 109P, manufactured by Kao Corporation) | | |
| Aqueous 7% polyvinyl alcohol (water-soluble resin) | 2.40 | parts |
| solution (saponification value: 78%, and | | |
| polymerization degree: 2,000) (trade name: PVA420, | | |
| manufactured by Kuraray Co. Ltd.) | | |
| Ion-exchange water | 7.76 | parts |

Preparation of Ink-Jet Recording Sheet (Recording Medium)

The front side surface of the above support was subjected to a corona discharge treatment, and then the coating solution for the ink-receiving layer (A) obtained above was applied onto the front side surface of the support at a coating amount of 180 ml/m² by using an extrusion die coater (coating step), and the resulting layer was heated in a heated air dryer at a temperature of 80° C. (flow rate 3 to 8 m/sec) until the solid concentration of the coated film reached 20%. The coated film showed a constant drying rate during the period. Immediately after drying, the film was immersed in the cross-linking agent coating solution (B) having the following composition for 30 seconds, allowing it to adhere to the coated film at an amount of 20 g/m² (cross-linking agent solution provision step), and further dried at 80° C. for 10 minutes (drying step), providing an ink-jet recording sheet (1) whereon an ink-receiving layer having a dry film thickness of 39 μm is formed.

Composition of the Cross-Linking Agent Coating Solution (B)

| | | |
|---|---|---|
| Boric acid (cross-linking agent) | 6.6 | parts |
| Mordant (aqueous 10% polyallylamine solution) | 66 | parts |
| (trade name: PAA-10C, manufactured by Nitto | | |
| Boseki Co. Ltd.) | | |
| Ion-exchange water | 157 | parts |
| Ammonium chloride (surface pH adjusting agent) | 2.6 | parts |
| Surfactant (aqueous 2% polyoxyethylene laurylether | 26.4 | parts |
| solution, HLB: 13.6) (trade name: Emulgen 109P, | | |
| manufactured by Kao Corporation) | | |
| Fluorochemical surfactant (trade name: | 5.3 | parts |
| MEGAFAC F1405, manufactured by Dainippon Ink and | | |
| Chemicals, Inc., 10% aqueous solution) | | |

The ink-jet recording sheet (1) obtained above was printed on using the ink composition (01) prepared above in an ink-jet printer (trade name: PM-890C, manufactured by Seiko Epson Corporation), to give a sample (A) for test and evaluation.

Recording and Heating Treatment

Subsequently, prepared ink compositions (01, and 02 and 03 which will be described below) were placed in the cartridge of an ink-jet printer (trade name: PM890C, manufactured by EPSON), and an image was printed (recorded) on the ink-jet recording sheet (1) by the printer. After printing, the sheet was brought into contact with a roller preheated to 130° C. and heated, to give a sample (A).

### Example 2

Sample (B) was obtained in a similar manner to Example 1 (preparation of ink composition 01), except that the recording and heating treatment were carried out by using an ink composition (02) that was prepared with the following microparticle dispersion (D2), replacing the microparticle dispersion (D1).

Preparation of Microparticle Dispersion (D2)

Microparticle dispersion (D2) was prepared in a similar manner to the preparation of microparticle dispersion (D1), except that the oil-soluble compound (a) was replaced with the oil-soluble compound (dye (b)) represented by the following formula A volume-average particle size of the resulting microparticles was 85 nm.

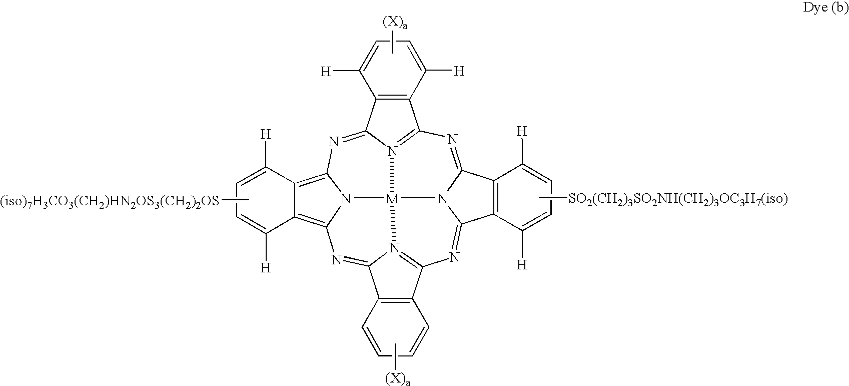

### Example 3

Sample (C) was obtained in a similar manner to Example 1 (preparation of ink composition 01), except that the recording and heating treatment was carried out by using an ink composition (03) that was prepared with the following microparticle dispersion (D3), replacing the microparticle dispersion (D1). Preparation of microparticle dispersion (D3).

Microparticle dispersion (D3) was prepared in a similar manner to the preparation of microparticle dispersion (D1), except that the oil-soluble compound (a) was replaced with the oil-soluble compound (dye (c)) represented by the following formula The volume-average particle size of the resulting microparticles was 78 nm. 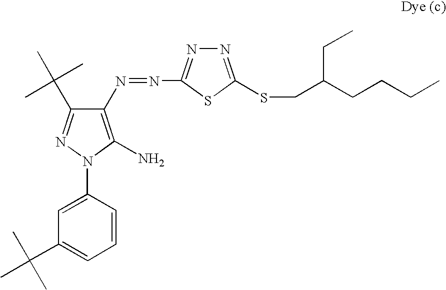
Preparation of Ink Composition (03)

Aqueous ink composition for ink-jet recording (03) was prepared in a similar manner to the preparation of ink composition (01), except that the microparticle dispersion (D1) in the preparation of the ink composition (01) was replaced with the microparticle dispersion (D3).

### Comparative Example 1

Sample (D) was obtained by conducting the recording and heating treatment in a similar manner to Example 1, except that the ink composition 01 in Example 1 was substituted with a pigment ink (trade name: PM4000PX, manufactured by Seiko Epson Corporation).

Evaluation

The samples (A) to (D) obtained in Examples 1 to 3 and Comparative Example 1 were subjected to the following evaluations.

Water Resistance

After drying at room temperature for 1 hour, samples (A) to (D) were immersed in water for 30 seconds and allowed to dry naturally at room temperature, and the resulting ink bleeding was observed. Samples were classified into three groups: samples A without bleeding, B with slight bleeding, and C with significant bleeding. Evaluation results are summarized in Table 1.

Abrasion Resistance

The images on samples (A) to (D) were rubbed to and fro with a eraser 10 times 30 minutes after image printing, and the resulting change was observed. Samples were classified into three groups: samples A without deterioration in density, B with slight deterioration in density, and C with significant deterioration in density. Evaluation results are summarized in Table 1.

Light Fastness

Samples (A) to (D) were irradiated with a xenon ray (850001×) for 4 days by using a weather meter (trade name: Atlas C.I65, manufactured by Atlas, U.S.), and the image densities before and after the xenon irradiation were determined by using a reflection densitometer (trade name: X-Rite310TR, manufactured by X-Rite) and evaluated as residual dye rates. The reflection density was determined at three points: 1, 1.5 and 2.0. Samples were classified into three groups: samples A having a remaining dye rate of 80% or more at any of the densities, samples B having a rate of less than 80% at 1 or 2 points, and samples C having a rate of less than 80% at all densities. Evaluation results are summarized in Table 1.

Ozone Resistance

As regards ozone resistance, residual dye rate was evaluated by placing the samples under the condition of an ozone concentration of 1.0 ppm for three days and determining the residual dye rate by using a reflection densitometer (trade name: X-Rite310, manufactured by X-Right). Samples were classified into five groups: samples A having a remaining dye rate of 90% or more, B of 89 to 80%, C of less than 79 to 70%, D of 69 to 50%, and E of less than 49%. Evaluation results are G in Table 1.

TABLE 1

| | Heating | | Ink | Abrasion | Light | Ozone |
|---|---|---|---|---|---|---|
| | treatment | Water resistance | bleeding | resistance | fastness | resistance |
| Example 1 | Yes | A | A | A | A | A |
| Example 2 | Yes | A | A | A | A | A |
| Example 3 | Yes | A | A | A | A | A |
| Comparative | Yes | B | C | B | A | A |
| Example 1 | | | | | | |

As is apparent from the results in Table 1, images on the ink-jet recording sheet recorded by the recording method in Examples 1 to 3 showed less ink bleeding and were superior in water resistance, abrasion resistance, light fastness, and ozone resistance. In contrast, the images recorded in Comparative Example 1, wherein an ink-jet recording sheet and a pigment ink were used, were inferior in water resistance, ink bleeding, and abrasion resistance.

1. A recording method comprising recording an image on a recording medium having formed thereon an ink-receiving layer containing a polymer microparticle and subjecting the recording medium to a heating treatment, wherein an ink composition having a microparticle dispersion which contains an oil-soluble compound is used.

2. The method according to claim 1, wherein the microparticle dispersion contains a hydrophobic polymer and the ink-receiving layer has a porous structure.

3. The method according to claim 1, wherein the oil-soluble compound is an oil-soluble dye.

4. The method according to claim 2, wherein the oil-soluble compound is an oil-soluble dye.

5. The method according to claim 1, wherein an oxidation potential of the oil-soluble compound is larger than 1.0 V (vs. SCE).

6. The method according to claim 2, wherein an oxidation potential of the oil-soluble compound is larger than 1.0 V (vs. SCE).

7. The method according to claim 3, wherein an oxidation potential of the oil-soluble compound is larger than 1.0 V (vs. SCE).

8. The method according to claim 1, wherein the oil-soluble compound is an azo dye having at least one heterocyclic ring or a phthalocyanine dye having at least one connecting group of —SO— or —SO₂— in the molecule.

9. The method according to claim 2, wherein the oil-soluble compound is an azo dye having at least one heterocyclic ring or a phthalocyanine dye having at least one connecting group of —SO— or —SO₂— in the molecule.

10. The method according to claim 3, wherein the oil-soluble compound is an azo dye having at least one heterocyclic ring or a phthalocyanine dye having at least one connecting group of —SO— or —SO₂— in the molecule.

11. The method according to claim 1, wherein the polymer microparticle is at least one selected from the group consisting of polymers and copolymers of a vinyl monomer, ester polymer, urethane polymer, amide polymer, epoxy polymer, and modified polymers or copolymers thereof.

12. The method according to claim 2, wherein the polymer microparticle is at least one selected from the group consisting of polymers and copolymers of a vinyl monomer, ester polymer, urethane polymer, amide polymer, epoxy polymer, and modified polymers or copolymers thereof.

13. The method according to claim 3, wherein the polymer microparticle is at least one selected from the group consisting of polymers and copolymers of a vinyl monomer, ester polymer, urethane polymer, amide polymer, epoxy polymer, and modified polymers or copolymers thereof.

14. The method according to claim 1, wherein a pore volume per unit thickness (A/B) of the ink receiving layer, obtained by dividing a micropore volume A (×10⁻⁵ ml/cm²) of the ink-receiving layer at a micropore diameter not less than the diameter of the polymer microparticle as determined from a micropore distribution curve obtained by a nitrogen gas adsorption method, by a dry film thickness B (m) of the ink-receiving layer, is 2.0 (×10⁻⁵ ml/cm²/μm) or more.

15. The method according to claim 2, wherein a pore volume per unit thickness (A/B) of the ink receiving layer, obtained by dividing a micropore volume A (×10⁻⁵ ml/cm²) of the ink-receiving layer at a micropore diameter not less than the diameter of the polymer microparticle as determined from a micropore distribution curve obtained by a nitrogen gas adsorption method, by a dry film thickness B (μm) of the ink-receiving layer, is 2.0 (×10⁻⁵ ml/cm²/μm) or more.

16. The method according to claim 3, wherein a pore volume per unit thickness (A/B) of the ink receiving layer, obtained by dividing a micropore volume A (×10⁻⁵ ml/cm²) of the ink-receiving layer at a micropore diameter not less than the diameter of the polymer microparticle as determined from a micropore distribution curve obtained by a nitrogen gas adsorption method, by a dry film thickness B (μm) of the ink-receiving layer, is 2.0 (×10⁻⁵ ml/cm²/μm) or more.

17. The method according to claim 1, wherein a film layer is formed by the heating treatment.

18. The method according to claim 2, wherein a film layer is formed by the heating treatment.

19. The method according to claim 1, wherein an ink-jet recording method is used.

20. The method according to claim 2, wherein an ink-jet recording method is used.
